(19) United States
(12) Patent Application Publication
(10) Pub. No.: US 2019/0120639 A1
(43) Pub. Date: Apr. 25, 2019

(54) SYSTEMS AND METHODS FOR ROUTE PLANNING

(71) Applicant: BEIJING DIDI INFINITY TECHNOLOGY AND DEVELOPMENT CO., LTD., Beijing (CN)

(72) Inventors: Wanqiu SONG, Beijing (CN); Xiangyi ZHONG, Beijing (CN); Rongquan SU, Beijing (CN)

(73) Assignee: BEIJING DIDI INFINITY TECHNOLOGY AND DEVELOPMENT CO., LTD., Beijing (CN)

(21) Appl. No.: 16/221,440

(22) Filed: Dec. 14, 2018

Related U.S. Application Data
(63) Continuation of application No. PCT/CN2018/092154, filed on Jun. 21, 2018.

(30) Foreign Application Priority Data
Jun. 21, 2017 (CN) 201710477223.0
Jun. 30, 2017 (CN) 201710525454.4
Aug. 31, 2017 (CN) 201710773418.X
Nov. 3, 2017 (CN) 201711071415.8
Nov. 3, 2017 (CN) 201711071425.1

(51) Int. Cl. G01C 21/34; G06Q 10/02; G06Q 50/30; G01C 21/36

(52) U.S. Cl. CPC G01C 21/3423; G06Q 10/025; G01C 21/3676; G01C 21/3484; G06Q 50/30

(57) ABSTRACT

The present disclosure relates to systems and methods for route planning. The systems may perform the methods to receive information of a first travel from the client terminal via a network. The systems may also perform the methods to generate at least one route planning record based on the information of the first travel. The at least one route planning record may include at least one public transportation travel route. The systems may also perform the methods to receive a request of a user for obtaining one of the at least one public transportation travel route, and transmit one of the at least one route planning record in response to the received request to the client terminal via the network.

### CROSS-REFERENCE TO RELATED APPLICATIONS

This application is a continuation of International Application No. PCT/CN2018/092154, filed on Jun. 21, 2018, which claims priority of Chinese Application No. 201710477223.0, filed on Jun. 21, 2017, Chinese Application No. 201710525454.4, filed on Jun. 30, 2017, Chinese Application No. 201710773418.X, filed on Aug. 31, 2017, Chinese Application No. 201711071425.1, filed on Nov. 3, 2017, and Chinese Application No. 201711071415.8, filed on Nov. 3, 2017. Each of the above-referenced applications is expressly incorporated herein by reference in their entirety.

### TECHNICAL FIELD

The present disclosure generally relates to systems and methods for electrical route planning, and in particular, to systems and methods for electrical route planning involving public transportations.

### BACKGROUND

Public transportations play an important place in people's daily life. Nowadays, with the development of the Internet, a user can obtain public transportation routes, for example, bus schedules, using an application installed in his or her smartphone. For example, the user can enter a start location and a destination, and the application may return a public transportation route based on the information entered. However, the user cannot obtain operating conditions (e.g., operating periods, operating sections) of the public transportation corresponding to the public transportation route. Also, the user may not be able to know the real-time arrival location of the public transportations; nor can the user predict the time of the public transportations arriving at the start location. Thus, it is desirable to develop systems and methods for determining route planning involving public transportation and information relating to public transportation, such as operating conditions, real-time information of the public transportation.

### SUMMARY

In one aspect of the present disclosure, a method for route planning is provided. The method may be implemented on a server. The method may include in response to a first travel sent by a client terminal, generating at least one route planning record based on the first travel, the at least one route planning record including at least one public transportation travel route. The method may also include in response to a request of the client terminal for obtaining one of the at least one public transportation travel route, transmitting one of the at least one route planning record corresponding to the request to the client terminal.

In another aspect of the present disclosure, a method for route planning is provided. The method may be implemented on a client terminal. The method may include transmitting a first travel of a service request to a server. The method may also include, in response to a determination that a request for obtaining at least one public transportation travel route is detected, obtaining and displaying at least one route planning record including the at least one public transportation travel route generated by the server. Start coordinates associated with the at least one route planning record may be determined based on the first travel.

In yet another aspect of the present disclosure, a device for route planning is provided. The device may be implemented on a server. The device may include a response unit. The response unit may be configured to, in response to a first travel sent by a client terminal, generate at least one route planning record based on the first travel. The at least one route planning record may include at least one public transportation travel route. The response unit may be further configured to, in response to a request of the client terminal for obtaining one of the at least one public transportation travel route, transmit one of the at least one route planning record corresponding to the request to the client terminal.

In yet another aspect of the present disclosure, a device for route planning is provided. The device may be implemented on a client terminal. The device may include a display unit. The display unit may be configured to transmit a first travel of a service request to a server. The display unit may, in response to a determination that a request for obtaining at least one public transportation travel route is detected, obtain and display at least one route planning record including the at least one public transportation travel route generated by the server. Start coordinates associated with the at least one route planning record may be determined based on the first travel.

In yet another aspect of the present disclosure, a server is provided. The server may include at least one storage device and at least one processor in communication with the at least one storage device. The at least one storage device may store a set of instructions. When executing the set of instructions, the at least one processor may be configured to, in response to a first travel sent by a client terminal, generate at least one route planning record based on the first travel. The at least one route planning record may include at least one public transportation travel route. The at least one processor may be further configured to, in response to a request of the client terminal for obtaining one of the at least one public transportation travel route, transmit one of the at least one route planning record corresponding to the request to the client terminal.

In yet another aspect of the present disclosure, a client terminal is provided. The client terminal may include at least one storage device, and at least one processor in communication with the at least one storage device. The at least one storage device may store a set of instructions. When executing the set of instructions, the at least one processor may be configured to transmit a first travel of a service request to a server. The at least one processor may, in response to a determination that a request for obtaining at least one public transportation travel route is detected, obtain and display at least one route planning record including the at least one public transportation travel route generated by the server. Start coordinates associated with the at least one route planning record may be determined based on the first travel.

In yet another aspect of the present disclosure, a non-transitory computer-readable medium is provided. The non-transitory computer-readable medium may include at least one set of instructions. When executed by at least one processor, the at least one set of instructions may direct the at least one processor to perform the above method.

In yet another aspect of the present disclosure, a method for public transportation travel route pushing is provided. The method may be implemented on an online car-hailing application. The method may include receiving a start location and a destination entered by a client terminal. The method may also include determining a plurality of candidate public transportation travel routes based on the start location and the destination. The method may also include obtaining a real-time arrival signal of a public transportation corresponding to each of the plurality of candidate public transportation travel routes, and determining information relating to an arrival time of the public transportation arriving at a target station based on the real-time arrival signal. The target station may be a nearest station to the start location for the public transportation. The method may further include transmitting at least one target public transportation travel route to the client terminal based on the information relating to the arrival time of the public transportation corresponding to the each of the plurality of candidate public transportation travel routes.

In yet another aspect of the present disclosure, a device for public transportation travel route pushing is provided. The device may be implemented on an online car-hailing application. The device may include a receiving module, a screening module, an acquisition module, a determination module, and a transmitting module. The receiving module may be configured to receive a start location and a destination entered by a client terminal. The screening module may be configured to determine a plurality of candidate public transportation travel routes based on the start location and the destination. The acquisition module may be configured to obtain a real-time arrival signal of a public transportation corresponding to each of the plurality of candidate public transportation travel routes. The determination module may be configured to determine information relating to an arrival time of the public transportation arriving at a target station based on the real-time arrival signal. The target station may be a nearest station to the start location for the public transportation. The transmitting module may be configured to transmit at least one target public transportation travel route to the client terminal based on the information relating to the arrival time of the public transportation corresponding to the each of the plurality of candidate public transportation travel routes.

In yet another aspect of the present disclosure, a computing device is provided. The computing device may include at least one storage device, and at least one processor in communication with the at least one storage device. The at least one storage device may store a set of instructions. When executing the set of instructions, the at least one processor may be configured to receive a start location and a destination entered by a client terminal. The at least one processor may also be configured to determine a plurality of candidate public transportation travel routes based on the start location and the destination. The at least one processor may also be configured to obtain a real-time arrival signal of a public transportation corresponding to each of the plurality of candidate public transportation travel routes. The at least one processor may also be configured to determine information relating to an arrival time of the public transportation arriving at a target station based on the real-time arrival signal. The target station may be a nearest station to the start location for the public transportation. The at least one processor may be further configured to transmit at least one target public transportation travel route to the client terminal based on the information relating to the arrival time of the public transportation corresponding to the each of the plurality of candidate public transportation travel routes.

In yet another aspect of the present disclosure, a non-transitory computer-readable medium is provided. The non-transitory computer-readable medium may include at least one set of instructions. When executed by at least one processor, the at least one set of instructions may direct the at least one processor to receive a start location and a destination entered by a client terminal. The at least one set of instructions may direct the at least one processor to determine a plurality of candidate public transportation travel routes based on the start location and the destination. The at least one set of instructions may direct the at least one processor to obtain a real-time arrival signal of a public transportation corresponding to each of the plurality of candidate public transportation travel routes. The at least one set of instructions may direct the at least one processor to determine information relating to an arrival time of the public transportation arriving at a target station based on the real-time arrival signal. The target station may be a nearest station to the start location for the public transportation. The at least one set of instructions may direct the at least one processor to transmit at least one target public transportation travel route to the client terminal based on the information relating to the arrival time of the public transportation corresponding to the each of the plurality of candidate public transportation travel routes.

In yet another aspect of the present disclosure, a method for public transportation travel route pushing is provided. The method may include obtaining a location of a user. The method may also include determining a nearest station to the location of the user as a first station based on the location of the user from preset station locations. The method may further include pushing one or more public transportation travel routes passing through the first station to the user.

In yet another aspect of the present disclosure, a device for public transportation travel route pushing is provided. The device may include a positioning module, a processing module, and a pushing module. The positioning module may be configured to obtain a location of a user. The processing module may be configured to determine a nearest station to the location of the user as a first station based on the location of the user from preset station locations. The pushing module may be configured to push one or more public transportation travel routes passing through the first station to the user.

In yet another aspect of the present disclosure, a method for information transmission is provided. The method may include receiving a prompting signal indicating a public transportation approaching a station. The method may also include obtaining a real-time arrival signal associated with the public transportation based on the prompting signal. The method may further include transmitting the real-time arrival signal to an online car-hailing platform for reference by a user associated with the online car-hailing platform.

In yet another aspect of the present disclosure, a device for information transmission is provided. The device may include a receiving module, an obtaining module, and a transmitting module. The receiving module may be configured to receive a prompting signal indicating a public transportation approaching a station. The obtaining module may be configured to obtain a real-time arrival signal associated with the public transportation based on the prompting signal. The transmitting module may be configured to transmit the real-time arrival signal to an online car-hailing platform for reference by a user associated with the online car-hailing platform.

In yet another aspect of the present disclosure, a device for information transmission is provided. The device may include at least one storage device, and at least one processor in communication with the at least one storage device. The at least one storage device may store a set of instructions. When executing the set of instructions, the at least one processor may be configured to receive a prompting signal indicating a public transportation approaching a station. The at least one processor may be configured to obtain a real-time arrival signal associated with the public transportation based on the prompting signal. The at least one processor may be configured to transmit the real-time arrival signal to an online car-hailing platform for reference by a user associated with the online car-hailing platform.

In yet another aspect of the present disclosure, a non-transitory computer-readable medium is provided. The non-transitory computer-readable medium may include at least one set of instructions. When executed by at least one processor, the at least one set of instructions may direct the at least one processor to receive a prompting signal indicating a public transportation approaching a station. The at least one set of instructions may direct the at least one processor to obtain a real-time arrival signal associated with the public transportation based on the prompting signal. The at least one set of instructions may direct the at least one processor to transmit the real-time arrival signal to an online car-hailing platform for reference by a user associated with the online car-hailing platform.

In yet another aspect of the present disclosure, a public transportation is provided. The public transportation may include the device for information transmission.

In yet another aspect of the present disclosure, a method for display is provided. The method may include receiving a start location and a destination. The method may also include obtaining at least two public transportation travel routes based on the start location and the destination. The method may further include generating a recommended page. The recommended page may include a map display area and a text display area. The text display area may be configured to display first data relating to a first number of public transportation travel routes. The method may further include displaying the recommended page.

In yet another aspect of the present disclosure, a system for display is provided. The system may include an obtaining unit, a generation unit, and a first display unit. The obtaining unit may be configured to receive a start location and a destination, and obtain at least two public transportation travel routes based on the start location and the destination. The generation unit may be configured to generate a recommended page. The recommended page may include a map display area and a text display area. The text display area may be configured to display first data relating to a first number of public transportation travel routes. The first display unit may be configured to display the recommended page.

In yet another aspect of the present disclosure, a computing device is provided. The computing device may include at least one storage device, and at least one processor in communication with the at least one storage device. The at least one storage device may store a set of instructions. When executing the set of instructions, the at least one processor may be configured to receive a start location and a destination, and obtain at least two public transportation travel routes based on the start location and the destination. The at least one processor may be configured to generate a recommended page. The recommended page may include a map display area and a text display area. The text display area may be configured to display first data relating to a first number of public transportation travel routes. The at least one processor may be configured to display the recommended page.

In yet another aspect of the present disclosure, a non-transitory computer-readable medium is provided. The non-transitory computer-readable medium may include at least one set of instructions. When executed by at least one processor, the at least one set of instructions may direct the at least one processor to receive a start location and a destination, and obtain at least two public transportation travel routes based on the start location and the destination. The at least one set of instructions may direct the at least one processor to generate a recommended page. The recommended page may include a map display area and a text display area. The text display area may be configured to display first data relating to a first number of public transportation travel routes. The at least one set of instructions may direct the at least one processor to display the recommended page.

In yet another aspect of the present disclosure, a computing device for interacting with a service system is provided. The computing device may include a data exchange port, at least one storage device, and at least one processor. The data exchange port of the computing device may be connected to the service system for providing an online-to-offline service implemented on a client terminal. The at least one storage device may store a set of instructions for route planning. The at least one processor may be configured to communicate with the at least one storage device. When executing the set of instructions, the at least one processor may be configured to cause the computing device to receive information of a first travel from the client terminal via a network. The at least one processor may be configured to cause the computing device to generate at least one route planning record based on the information of the first travel. The at least one route planning record may include at least one public transportation travel route. The at least one processor may also be configured to cause the computing device to receive a request of a user for obtaining one of the at least one public transportation travel route, and transmit one of the at least one route planning record in response to the received request to the client terminal via the network.

In some embodiments, to generate at least one route planning record based on the information of the first travel, the at least one processor may be configured to cause the computing device to determine a first start location and a destination based on the information of the first travel. The at least one processor may also be configured to cause the computing device to determine the at least one public transportation travel route based on the first start location and the destination. The at least one processor may be further configured to cause the computing device to determine one or more operating conditions of one or more public transportations corresponding to the at least one public transportation travel route based on a departure time of the first travel and a road condition associated with the at least one public transportation travel route. The one or more operating conditions may include operating periods and operating sections corresponding to a first portion of the one or more public transportations having fixed sites, and a distribution of a second portion of the one or more public transportations having non-fixed sites. The at least one processor may be further configured to cause the computing device to generate the at least one route planning record based on the one or more operating conditions of the one or more public transportations. Each of the at least one route planning record may include one or more identifiers of the one or more public transportations and an interface identifier configured to be displayed on the client terminal. The interface identifier may correspond to the each of the at least one route planning record.

In some embodiments, to determine a first start location based on the information of the first travel, the at least one processor may be configured to cause the computing device to analyze a location of the user and a second start location corresponding to the first travel. The location of the user may be a geographic location of the user when the first travel is generated. The geographic location of the user may be determined by a positioning chipset of the client terminal. The at least one processor may be configured to cause the computing device to determine a distance between the location of the user and the second start location. The at least one processor may be further configured to cause the computing device to determine whether the distance is greater than or equal to a distance threshold. The at least one processor may be further configured to cause the computing device to designate the second start location as the first start location based on a result of the determination that the distance is greater than or equal to a distance threshold, and designate the location of the user as the first start location based on a result of the determination that the distance is less than the distance threshold.

In some embodiments, to determine the at least one public transportation travel route based on the first start location and the destination, the at least one processor may be configured to cause the computing device to determine a plurality of candidate public transportation travel routes based on the first start location and the destination. The at least one processor may also be configured to cause the computing device to obtain a real-time arrival signal of a public transportation corresponding to each of the plurality of candidate public transportation travel routes. The at least one processor may also be configured to cause the computing device to determine information relating to an arrival time of the public transportation arriving at a target station based on the real-time arrival signal. The target station may be a nearest station to the first start location for the public transportation. The at least one processor may also be configured to cause the computing device to determine the at least one public transportation travel route based on the information relating to the arrival time of the public transportation corresponding to the each of the plurality of candidate public transportation travel routes.

In some embodiments, the real-time arrival signal of the public transportation may include at least one of an arrival station, a vehicle number, a license plate, a driving direction, a current location of the public transportation, or an area the public transportation located.

In some embodiments, to determine information relating to an arrival time of the public transportation arriving at a target station based on the real-time arrival signal, the at least one processor may be configured to cause the computing device to determine driving vehicles that match the real-time arrival signal. The driving vehicles may be contracted vehicles of the service system, and driving directions of the driving vehicles may match the driving direction of the public transportation. The at least one processor may be further configured to cause the computing device to determine one or more of the driving vehicles having an overlapping driving route with the public transportation as one or more reference vehicles. The at least one processor may be further configured to cause the computing device to obtain one or more reference travels associated with each of the one or more reference vehicles. The at least one processor may be further configured to cause the computing device to determine the information relating to the arrival time based on the one or more reference travels associated with each of the one or more reference vehicles.

In some embodiments, each of the one or more reference travels may include a driving speed and a distance from the arrival station to the target station. Alternatively, each of the one or more reference travels may include a driving duration from the arrival station to the target station.

In some embodiments, the information relating to the arrival time may include an arrival time point of the public transportation arriving at the target station and a first travel duration of the public transportation from the arrival station to the target station. To determine at least one public transportation travel route based on the information relating to the arrival time of the public transportation, the at least one processor may be configured to cause the computing device to determine a second travel duration of the client terminal from the first start location to the target station. The at least one processor may be further configured to cause the computing device to determine at least one of the plurality of candidate public transportation travel routes as the at least one public transportation travel route. The first travel duration of the determined at least one of the plurality of candidate public transportation travel routes may be greater than the second travel duration of the client terminal from the first start location to the target station.

In some embodiments, to determine a plurality of candidate public transportation travel routes based on the first start location and the destination, the at least one processor may be configured to cause the computing device to determine a nearest station to the first start location as a first station from preset station locations, and determine one or more first public transportation travel routes passing the first station. The at least one processor may also be configured to cause the computing device to determine one or more second public transportation travel routes passing the destination from the one or more first public transportation travel routes, and determine the plurality of candidate public transportation travel routes based on the one or more second public transportation travel routes.

In some embodiments, to determine one or more first public transportation travel routes passing the first station, the at least one processor may be configured to cause the computing device to determine a second nearest station to the location of the user as a second station from the preset station locations, and determine the one or more first public transportation travel routes passing the first station or the second station.

In some embodiments, to determine the plurality of candidate public transportation travel routes based on the one or more second public transportation travel routes, the at least one processor may be configured to cause the computing device to, for each of the one or more second public transportation travel routes, obtain a current location of a public transportation corresponding to the each of the one or more second public transportation travel routes. The at least one processor may also be configured to cause the computing device to determine a distance from the current location of the public transportation to the first station. The at least one processor may also be configured to cause the computing device to rank the one or more second public transportation travel routes based on a first rule associated with the distance from closest to farthest. The at least one processor may also be configured to cause the computing device to determine the plurality of candidate public transportation travel routes based on the ranked one or more second public transportation travel routes.

In some embodiments, the at least one processor may be configured to cause the computing device to receive an input of a keyword entered by the client terminal, and further determine whether the keyword includes a digit. The at least one processor may be configured to cause the computing device to designate at least one of the one or more second public transportation travel routes as the plurality of candidate public transportation travel routes based on a result of the determination that the keyword includes a digit. A vehicle number of a public transportation corresponding to one of the plurality of candidate public transportation travel routes may include the digit as an initial number.

In some embodiments, to obtain a real-time arrival signal of a public transportation corresponding to each of the plurality of candidate public transportation travel routes, the at least one processor may be configured to cause the computing device to receive a prompting signal indicating that the public transportation is approaching a station, and obtain the real-time arrival signal associated with the public transportation based on the prompting signal.

In some embodiments, the prompting signal may be generated when a door-open button of the public transportation is triggered. Alternatively, the prompting signal may be generated when an arrival prompting button of the public transportation is triggered.

In some embodiments, the at least one processor may be further configured to cause the computing device to obtain a request for planning at least one public transportation travel route. The at least one processor may be further configured to cause the computing device to transmit to the client terminal a first interface identifier corresponding to a specific route planning record and/or one or more second interface identifiers corresponding to one or more unspecific route planning record of the at least one route planning record based on a predetermined strategy. The at least one processor may be also configured to instruct the client terminal to display the specific route planning record in a form of a map interface. The map interface may display the one or more identifiers of the one or more public transportations and a second travel associated with the at least one public transportation travel route of the specific route planning record. The at least one processor may be further configured to cause the computing device to instruct the client terminal to display the one or more unspecific route planning record in a form of the one or more second interface identifiers. The second travel may include at least one of travel parameters including at least one of a total travel duration of the at least one public transportation travel route, a travel trajectory of the at least one public transportation travel route, a total walking distance, or a transportation cost.

In some embodiments, the at least one processor may be further configured to cause the computing device to receive a request for obtaining one of the one or more second interface identifiers. The at least one processor may be further configured to cause the computing device to transmit one of the one or more unspecific route planning record corresponding to the one of the one or more second interface identifier to the client terminal. The at least one processor may be further configured to cause the computing device to instruct the client terminal to display the one of the one or more unspecific route planning record corresponding to the interface identifier in the form of the map interface.

In some embodiments, the at least one processor may be further configured to cause the computing device to transmit instructions to the client terminal. The instructions may be configured to cause the client terminal to generate a recommended page. The recommended page may include a map display area and a text display area. The map display area may be configured to display the map interface, and the text display area may be configured to display first data relating to a first number of the one or more second interface identifiers. The instructions may also be configured to cause the client terminal to display the recommended page by a display of the client terminal.

In some embodiments, the first data relating to the first number of the one or more second interface identifiers may include a vehicle number of a public transportation corresponding to an unspecific route planning records and an estimate duration associated with a public transportation travel route corresponding to an unspecific route planning record.

In some embodiments, the text display area may be configured to display the first data relating to the first number of the one or more second interface identifiers in a form of list.

In some embodiments, the text display area may share an edge with an outline of the recommended page.

In some embodiments, to display the recommended page by the display of the client terminal, the at least one processor may be configured to cause the computing device to, in response to a slide operation of the user performing on the text display area, cause the client terminal to expand the text display area to display second data relating to a second number of the one or more second interface identifiers. The slide operation may be directed from the text display area to a center of the recommended page.

In some embodiments, the at least one processor may be further configured to cause the computing device to, in response to a click operation of the user performing on the text display area, cause the client terminal to display third data relating to a second identifier corresponding to a location of the click operation on the text display area.

In yet another aspect of the present disclosure, a method is provided. The method may be implemented on a computing device having a processor, a storage device and a communication platform connected to a network. The method may include receiving information of a first travel from the client terminal via a network. The method may also include generating at least one route planning record based on the information of the first travel. The at least one route planning record may include at least one public transportation travel route. The method may further include receiving a request of a user for obtaining one of the at least one public transportation travel route, and transmitting one of the at least one route planning record in response to the received request to the client terminal via the network.

In yet another aspect of the present disclosure, a non-transitory computer-readable medium is provided. The non-transitory computer-readable medium may store at least one set of instructions. When executed by at least one processor, the at least one set of instructions may direct the at least one processor to perform acts of receiving information of a first travel from the client terminal via a network. The at least one set of instructions may also direct the at least one processor to perform acts of generating at least one route planning record based on the information of the first travel. The at least one route planning record may include at least one public transportation travel route. The at least one set of instructions may also direct the at least one processor to perform acts of receiving a request of a user for obtaining one of the at least one public transportation travel route, and transmitting one of the at least one route planning record in response to the received request to the client terminal via the network.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary online to offline (O2O) service system according to some embodiments of the present disclosure;

FIG. 2 is a schematic diagram illustrating exemplary hardware and software components of a computing device according to some embodiments of the present disclosure;

FIG. 3 is a schematic diagram illustrating exemplary hardware and/or software components of a mobile device on which a terminal may be implemented according to some embodiments of the present disclosure;

FIG. 4 is a flowchart illustrating an exemplary process for route planning according to some embodiments of the present disclosure;

FIG. 5 is a flowchart illustrating an exemplary process for route planning according to some embodiments of the present disclosure;

FIG. 6 is a block diagram illustrating an exemplary route planning device according to some embodiments of the present disclosure;

FIG. 7 is a block diagram illustrating an exemplary route planning device according to some embodiments of the present disclosure;

FIG. 8 is a flowchart illustrating an exemplary process for route planning according to some embodiments of the present disclosure;

FIG. 9 is a schematic diagram illustrating an exemplary express interface on an online taxi-hailing application according to some embodiments of the present disclosure;

FIG. 10 is a schematic diagram illustrating an exemplary public transportation interface on an online taxi-hailing application according to some embodiments of the present disclosure;

FIG. 11 is a flowchart illustrating an exemplary process for determining one or more public transportation travel routes according to some embodiments of the present disclosure;

FIG. 12 is a flowchart illustrating an exemplary process for determining information relating to an arrival time of a public transportation according to some embodiments of the present disclosure;

FIG. 13 is a flowchart illustrating an exemplary process for transmitting a public transportation travel route according to some embodiments of the present disclosure;

FIG. 14 is a block diagram illustrating an exemplary device for public transportation travel route transmitting according to some embodiments of the present disclosure;

FIG. 15 is a block diagram illustrating a determination module according to some embodiments of the present disclosure;

FIG. 16 is a block diagram illustrating a transmitting module according to some embodiments of the present disclosure;

FIG. 17 is a flowchart illustrating an exemplary process for pushing a public transportation travel route according to some embodiments of the present disclosure;

FIG. 18 is a flowchart illustrating an exemplary process for public transportation travel route pushing according to some embodiments of the present disclosure;

FIG. 19 is a flowchart illustrating an exemplary process for pushing public transportation travel route according to some embodiments of the present disclosure;

FIG. 20 is a flowchart illustrating an exemplary process for pushing a public transportation travel route according to some embodiments of the present disclosure;

FIG. 21 is a flowchart illustrating an exemplary process for public transportation travel route pushing according to some embodiments of the present disclosure;

FIG. 22 is a block diagram illustrating an exemplary device for public transportation travel route pushing based on the location of a user according to some embodiments of the present disclosure;

FIG. 23 is a block diagram illustrating an exemplary device for public transportation travel route pushing based on the location of a user according to some embodiments of the present disclosure;

FIG. 24 is a block diagram illustrating an exemplary device for public transportation travel route pushing based on the location of a user according to some embodiments of the present disclosure;

FIG. 25 is a block diagram illustrating an exemplary device for public transportation travel route pushing based on the location of a user according to some embodiments of the present disclosure;

FIG. 26 is a flowchart illustrating an exemplary process for transmitting information according to some embodiments of the present disclosure;

FIG. 27 is a schematic diagram illustrating an exemplary device for transmitting information according to an embodiment of the present disclosure;

FIG. 28 is a flowchart illustrating an exemplary process for display according to some embodiments of the present disclosure;

FIG. 29 is a flowchart illustrating an exemplary process for display a recommended page according to some embodiments of the present disclosure;

FIG. 30 is a flowchart illustrating an exemplary process for display a recommended page according to a third embodiment of the present disclosure;

FIG. 31 is a flowchart illustrating an exemplary process for display according to some embodiments of the present disclosure;

FIG. 32 is a flowchart illustrating an exemplary process for display according to some embodiments of the present disclosure;

FIGS. 33-36 are schematic diagrams illustrating an online taxi-hailing application according to some embodiments of the present disclosure;

FIG. 37 is a schematic diagram illustrating an exemplary device for display according to some embodiments of the present disclosure;

FIG. 38 is a schematic diagram illustrating an exemplary device for display according to some embodiments of the present disclosure;

FIG. 39 is a schematic diagram illustrating an exemplary device for display according to some embodiments of the present disclosure;

FIG. 40 is a schematic diagram illustrating an exemplary device for display according to some embodiments of the present disclosure;

FIG. 41 is schematic diagram illustrating an exemplary processing device according to some embodiments of the present disclosure;

FIG. 42 is a flowchart illustrating an exemplary process for route planning according to some embodiments of the present disclosure;

FIG. 43 is a flowchart illustrating an exemplary process for generating at least one route planning record according to some embodiments of the present disclosure;

FIG. 44 is a flowchart illustrating an exemplary process for generating at least one route planning record according to some embodiments of the present disclosure; and

FIG. 45 is a flowchart illustrating an exemplary process for generating at least one route planning record according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, section or assembly of different level in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an erasable programmable read-only memory (EPROM). It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Embodiments of the present disclosure may be applied to different transportation systems including but not limited to land transportation, sea transportation, air transportation, space transportation, or the like, or any combination thereof. A vehicle of the transportation systems may include a rickshaw, travel tool, taxi, chauffeured car, hitch, bus, rail transportation (e.g., a train, a bullet train, high-speed rail, and subway), ship, airplane, spaceship, hot-air balloon, driverless vehicle, or the like, or any combination thereof. The transportation system may also include any transportation system that applies management and/or distribution, for example, a system for sending and/or receiving an express.

The application scenarios of different embodiments of the present disclosure may include but not limited to one or more web pages, browser plugins and/or extensions, client terminals, custom systems, intracompany analysis systems, artificial intelligence robots, or the like, or any combination thereof. It should be understood that application scenarios of the system and method disclosed herein are only some examples or embodiments. Those having ordinary skills in the art, without further creative efforts, may apply these drawings to other application scenarios.

The term “passenger,” “requester,” “requestor,” “service requester,” “service requestor” and “customer” in the present disclosure are used interchangeably to refer to an individual, an entity or a tool that may request or order a service. Also, the term “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. For example, the user may be a requester, a passenger, a driver, an operator, or the like, or any combination thereof. In the present disclosure, “requester” and “requester terminal” may be used interchangeably, and “provider” and “provider terminal” may be used interchangeably.

The term “request,” “service,” “service request,” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

The present disclosure relates to systems and methods for generating a route planning record, which may include at least one public transportation travel route. The systems and methods may receive information of a first travel from a service system of a client terminal via a network and generate at least one route planning record based on the information of the first travel. Specifically, the systems and methods may determine a first start location and the destination based on the information of the first travel. The systems and methods may determine the at least one public transportation travel route based on the first start location and the destination. The systems and methods may determine one or more operating conditions of one or more public transportations corresponding to the at least one public transportation travel route based on the departure time of the first travel and the road condition associated with the at least one public transportation travel route. The systems and methods may generate the at least one route planning record based on the one or more operating conditions of the one or more public transportations. The systems and methods may also receive a request of a user for obtaining one of the at least one public transportation travel route and further transmit one of the at least one route planning record to the user in response to the received request.

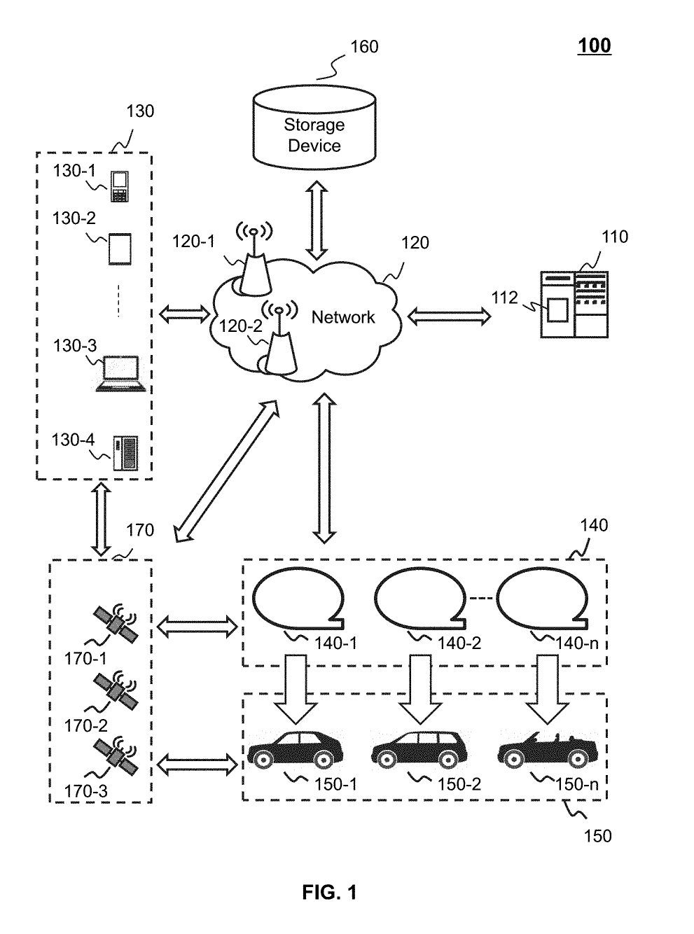

FIG. 1 is a block diagram illustrating an exemplary route planning system 100 according to some embodiments of the present disclosure. The route planning system 100 may be an online platform including a server 110, a network 120, a requester terminal 130, a provider terminal 140, a vehicle 150, a storage device 160, and a navigation system 170.

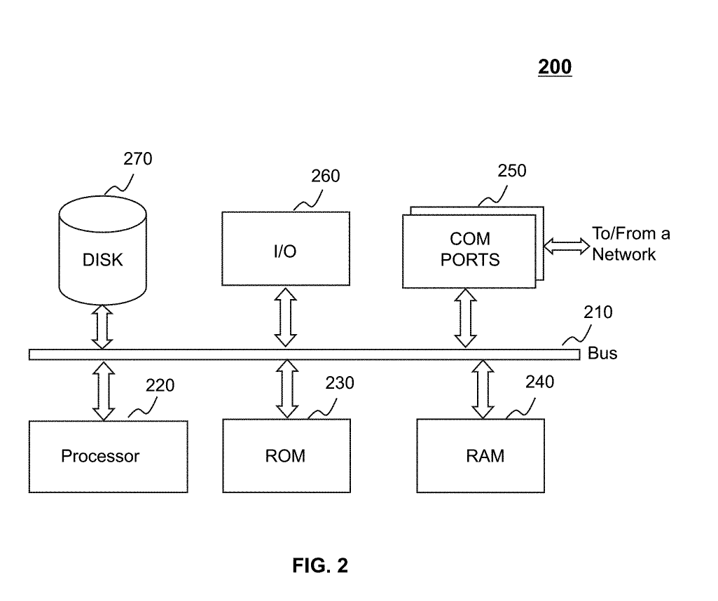

In some embodiments, the server 110 may be a single server or a server group. The server group may be centralized, or distributed (e.g., the server 110 may be a distributed system). In some embodiments, the server 110 may be local or remote. For example, the server 110 may access information and/or data stored in the requester terminal 130, the provider terminal 140, and/or the storage device 160 via the network 120. As another example, the server 110 may be directly connected to the requester terminal 130, the provider terminal 140, and/or the storage device 160 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing device 112. The processing device 112 may process information and/or data related to the service request to perform one or more functions described in the present disclosure. For example, the processing device 112 may generate at least one route planning record including at least one public transportation travel route. As another example, the processing device 112 may transmit the at least one route planning record to the requester terminal 130. In some embodiments, the processing device 112 may include one or more processing engines (e.g., single-core processing engine(s) or multi-core processor(s)). Merely by way of example, the processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the route planning system 100 (e.g., the server 110, the requester terminal 130, the provider terminal 140, the vehicle 150, the storage device 160, and the navigation system 170) may transmit information and/or data to other component(s) of the route planning system 100 via the network 120. For example, the server 110 may receive a service request from the requester terminal 130 via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, through which one or more components of the route planning system 100 may be connected to the network 120 to exchange data and/or information.

In some embodiments, a passenger may be an owner of the requester terminal 130. In some embodiments, the owner of the requester terminal 130 may be someone other than the passenger. For example, an owner A of the requester terminal 130 may use the requester terminal 130 to transmit a service request for a passenger B or receive a service confirmation and/or information or instructions from the server 110. In some embodiments, a service provider may be a user of the provider terminal 140. In some embodiments, the user of the provider terminal 140 may be someone other than the service provider. For example, a user C of the provider terminal 140 may use the provider terminal 140 to receive a service request for a service provider D, and/or information or instructions from the server 110. In some embodiments, “passenger” and “passenger terminal” may be used interchangeably, and “service provider” and “provider terminal” may be used interchangeably. The “passenger terminal”, “requester terminal”, and “client terminal” may be used interchangeably. In some embodiments, the provider terminal may be associated with one or more service providers (e.g., a night-shift service provider, or a day-shift service provider).

In some embodiments, the requester terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, smart glasses, a smart helmet, a smartwatch, smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, virtual reality glasses, a virtual reality patch, an augmented reality helmet, augmented reality glasses, an augmented reality patch, or the like, or any combination thereof. For example, the virtual reality device and/or the augmented reality device may include Google™ Glasses, an Oculus Rift, a HoloLens, a Gear VR, etc. In some embodiments, the built-in device in the vehicle 130-4 may include an onboard computer, an onboard television, etc. In some embodiments, the requester terminal 130 may be a device with positioning technology for locating the position of the passenger and/or the requester terminal 130.

The provider terminal 140 may include a plurality of provider terminals 140-1, 140-2, . . . , 140-n. In some embodiments, the provider terminal 140 may be similar to, or the same device as the requester terminal 130. In some embodiments, the provider terminal 140 may be customized to be able to implement the route planning system 100. In some embodiments, the provider terminal 140 may be a device with positioning technology for locating the service provider, the provider terminal 140, and/or a vehicle 150 associated with the provider terminal 140. In some embodiments, the requester terminal 130 and/or the provider terminal 140 may communicate with another positioning device to determine the position of the passenger, the requester terminal 130, the service provider, and/or the provider terminal 140. In some embodiments, the requester terminal 130 and/or the provider terminal 140 may periodically transmit the positioning information to the server 110. In some embodiments, the provider terminal 140 may also periodically transmit the availability status to the server 110. The availability status may indicate whether a vehicle 150 associated with the provider terminal 140 is available to carry a passenger. For example, the requester terminal 130 and/or the provider terminal 140 may transmit the positioning information and the availability status to the server 110 every thirty minutes. As another example, the requester terminal 130 and/or the provider terminal 140 may transmit the positioning information and the availability status to the server 110 each time the user logs into the mobile application associated with the route planning system 100.

In some embodiments, the provider terminal 140 may correspond to one or more vehicles 150. The vehicles 150 may carry the passenger and travel to the destination. The vehicles 150 may include a plurality of vehicles 150-1, 150-2, . . . , 150-n. One vehicle may correspond to one type of services (e.g., a taxi-hailing service, a chauffeur service, an express car service, a carpool service, a bus service, a driver hire service or shuttle service).

The storage device 160 may store data and/or instructions. In some embodiments, the storage device 160 may store data obtained from the requester terminal 130 and/or the provider terminal 140. For example, the storage device 160 may store a service request obtained from the requester terminal 130. In some embodiments, the storage device 160 may store data and/or instructions that the server 110 may execute or use to perform exemplary methods described in the present disclosure. For example, the storage device 160 may store one or more route planning record obtained from the server 110. In some embodiments, storage device 160 may include a mass storage, removable storage, a volatile read-and-write memory, a read-only memory (ROM), or the like, or any combination thereof. Exemplary mass storage may include a magnetic disk, an optical disk, solid-state drives, etc. Exemplary removable storage may include a flash drive, a floppy disk, an optical disk, a memory card, a zip disk, a magnetic tape, etc. Exemplary volatile read-and-write memory may include random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 160 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 160 may be connected to the network 120 to communicate with one or more components of the route planning system 100 (e.g., the server 110, the requester terminal 130, or the provider terminal 140). One or more components of the route planning system 100 may access the data or instructions stored in the storage device 160 via the network 120. In some embodiments, the storage device 160 may be directly connected to or communicate with one or more components of the route planning system 100 (e.g., the server 110, the requester terminal 130, the provider terminal 140). In some embodiments, the storage device 160 may be part of the server 110.

The navigation system 170 may determine information associated with an object, for example, one or more of the requester terminal 130, the provider terminal 140, the vehicle 150, etc. In some embodiments, the navigation system 170 may be the global positioning system (GPS), global navigation satellite system (GLONASS), compass navigation system (COMPASS), BeiDou navigation satellite system, Galileo positioning system, quasi-zenith satellite system (QZSS), etc. The information may include a location, an elevation, a velocity, or an acceleration of the object, or a current time. The navigation system 170 may include one or more satellites, for example, a satellite 170-1, a satellite 170-2, and a satellite 170-3. The satellites 170-1 through 170-3 may determine the information mentioned above independently or jointly. The navigation system 170 may transmit the information mentioned above to the network 120, the requester terminal 130, the provider terminal 140, or the vehicle 150 via wireless connections.

In some embodiments, one or more components of the route planning system 100 (e.g., the server 110, the requester terminal 130, the provider terminal 140) may have permissions to access the storage device 160. In some embodiments, one or more components of the route planning system 100 may read and/or modify information related to the passenger, service provider, and/or the public when one or more conditions are met. For example, the server 110 may read and/or modify one or more passengers' information after a service is completed. As another example, the server 110 may read and/or modify one or more service providers' information after a service is completed.

One of ordinary skill in the art would understand that when an element (or component) of the route planning system 100 performs, the element may perform through electrical signals and/or electromagnetic signals. For example, when a requester terminal 130 transmits out a service request to the server 110, a processor of the requester terminal 130 may generate an electrical signal encoding the request. The processor of the requester terminal 130 may then transmit the electrical signal to an output port. If the requester terminal 130 communicates with the server 110 via a wired network, the output port may be physically connected to a cable, which further may transmit the electrical signal to an input port of the server 110. If the requester terminal 130 communicates with the server 110 via a wireless network, the output port of the requester terminal 130 may be one or more antennas, which convert the electrical signal to electromagnetic signal. Similarly, a provider terminal 140 may receive an instruction and/or service request from the server 110 via electrical signal or electromagnet signals. Within an electronic device, such as the requester terminal 130, the provider terminal 140, and/or the server 110, when a processor thereof processes an instruction, transmits out an instruction, and/or performs an action, the instruction and/or action is conducted via electrical signals. For example, when the processor retrieves or saves data from a storage medium, it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 illustrates a schematic diagram of an exemplary computing device according to some embodiments of the present disclosure. The computing device may be a computer, such as the server 110 in FIG. 1 and/or a computer with specific functions, configured to implement any particular system according to some embodiments of the present disclosure. Computing device 200 may be configured to implement any components that perform one or more functions disclosed in the present disclosure. For example, the server 110 may be implemented in hardware devices, software programs, firmware, or any combination thereof of a computer like computing device 200. For brevity, FIG. 2 depicts only one computing device. In some embodiments, the functions of the computing device, providing function that recommending pick-up locations may require, may be implemented by a group of similar platforms in a distributed mode to disperse the processing load of the system.

Computing device 200 may include a communication terminal 250 that may connect with a network that may implement the data communication. Computing device 200 may also include a processor 220 that is configured to execute instructions and includes one or more processors. The schematic computer platform may include an internal communication bus 210, different types of program storage units and data storage units (e.g., a hard disk 270, a read-only memory (ROM) 230, a random-access memory (RAM) 240), various data files applicable to computer processing and/or communication, and some program instructions executed possibly by the processor 220. Computing device 200 may also include an I/O device 260 (i.e., a data exchange port) that may support the input and output of data flows between computing device 200 and other components. For example, the data exchange port may be connected to a service system for providing an online-to-offline service implemented on a client terminal (e.g., the requester terminal 130, the provider terminal 140). Moreover, computing device 200 may receive programs and data via the communication network.

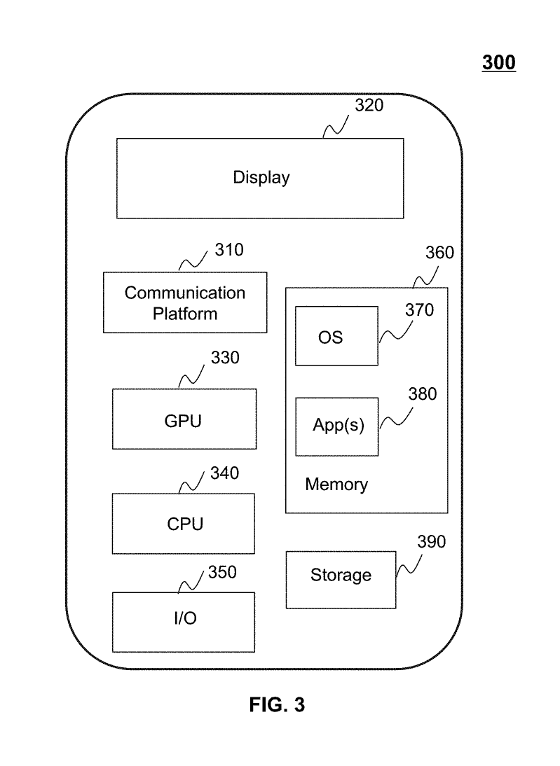

FIG. 3 is a schematic diagram illustrating exemplary hardware and/or software components of an exemplary mobile device on which a terminal may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, a mobile operating system (OS) 370, a storage 390. In some embodiments, any other suitable component, including but not limited to a system bus or a controller (not shown), may also be included in the mobile device 300.

In some embodiments, a mobile operating system 370 (e.g., iOS™, Android™′ Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the route planning system 100. User interactions with the information stream may be achieved via the I/O 350 and provided to the storage device 160, the server 110 and/or other components of the route planning system 100. In some embodiments, the mobile device 300 may be an exemplary embodiment corresponding to the requester terminal 130 or the provider terminal 140.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a system if appropriately programmed.

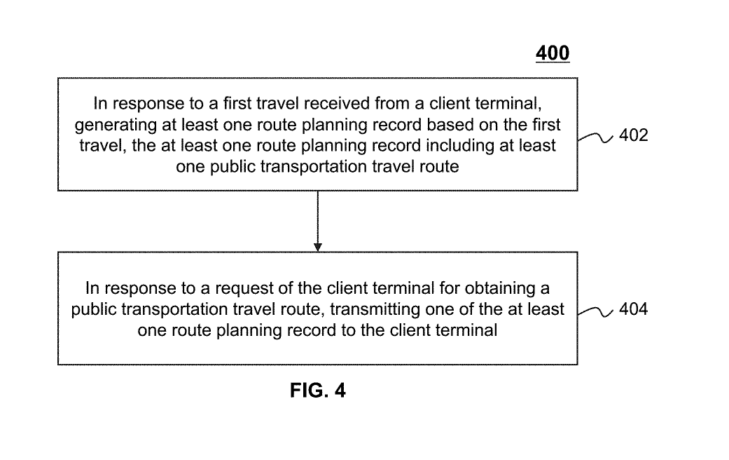

FIG. 4 is a flowchart illustrating an exemplary process 400 for route planning according to some embodiments of the present disclosure. In some embodiments, process 400 may be implemented in the route planning system 100. For example, process 400 may be stored in the storage device 160 and/or the storage (e.g., the ROM 230, the RAM 240, etc.) as the form of instructions, and invoked and/or executed by the server 110 (e.g., the processing device 112 in the server 110, or the processor 220 of the processing device 112 in the server 110).

In 402, in response to a first travel received from a client terminal, the processing device 112 may generate at least one route planning record based on the first travel. The at least one route planning record may include at least one public transportation travel route. In some embodiments, the first travel sent by a user of the client terminal (e.g., requester terminal 130) may include the start location, the destination, and the departure time of a service request associated with the first travel. Attribute information associated with the route planning record(s) may include the timestamp corresponding to the departure time.

In 404, the processing device 112 may transmit one of the at least one route planning record to the client terminal in response to a request of the client terminal for obtaining a public transportation travel route.

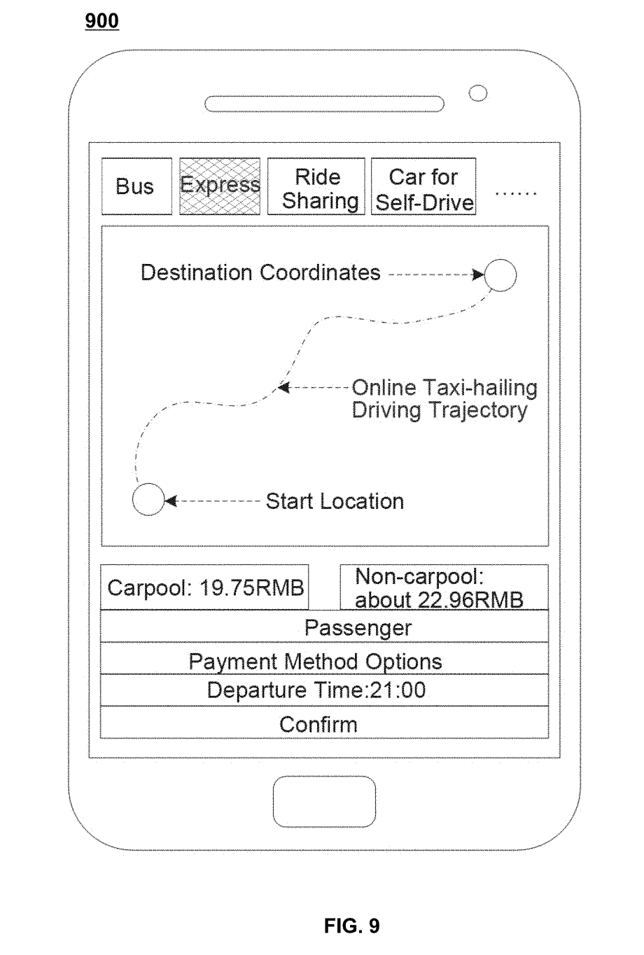

In some embodiments, at least one route planning record may be generated based on the first travel in response to the first travel received from a client terminal. The at least one route planning record may include at least one public transportation travel route. In response to a request of the client terminal for obtaining a public transportation travel route, one or more of the at least one route planning record corresponding to the request may be transmitted to the client terminal. For example, when a user wants to read a public transportation travel route after sending out a first travel, the user may input a request for obtaining a public transportation travel route. Further, the user may click a button (e.g., “Bus” button on a page of the online taxi-hailing application as shown in FIG. 9) associated with the client terminal to send the request for obtaining a public transportation travel route. Then the user may receive the route planning record(s) without manually inputting the travel information again, which may simplify operations of the user, provide convenient comparisons among multiple public transportation travel routes, and improve the user experience.

In some embodiments, to generate at least one route planning record based on the first travel, the processing device 112 may determine the start location and the destination associated with the at least one route planning record based on the first travel. For example, the processing device 112 may designate the destination of the first travel as the destination associated with the at least one route planning record. The processing device 112 may determine the at least one public transportation travel route based on coordinates of the start location and the destination associated with the at least one public transportation travel route. The coordinates of the start location and the destination associated with the at least one public transportation travel route may also be referred to as the start coordinates and the destination coordinates respectively The processing device 112 may further determine one or more operating conditions of one or more public transportations corresponding to each of the at least one public transportation travel route, based on the departure time of the first travel and the road condition associated with the each of the at least one public transportation travel route. In some embodiments, the one or more operating conditions may include operating periods and operating sections corresponding to a first portion of the one or more public transportations having fixed sites, and the distribution of a second portion of the one or more public transportations having non-fixed sites. The processing device 112 may also generate the at least one route planning record based on the one or more operating conditions of the one or more public transportations. Each of the at least one route planning record may include one or more identifiers of the one or more public transportations and an interface identifier configured to be displayed on the client terminal. The interface identifier may correspond to the each of the at least one route planning record. The interface identifier corresponding to the each of the at least one route record may be configured to distinguish one route record from another route planning record. The interface identifier may include a symbol, a number, a letter, etc.

In some embodiments, the start coordinates associated with the at least one route planning record may be determined based on the first travel. For example, the start coordinates may be coordinates of the start location of the first travel. As another example, the start coordinates may be coordinates of the location of the client terminal when sending the first travel to the route planning system. In response to the destination coordinates of the first travel, the at least one public transportation travel route may be determined based on the start coordinates and the destination coordinates. When the user reads the public transportation travel route, a prompt (i.e., the route planning record) may be directly pushed to the user without the user's input of travel information again. Further, in order to improve reliability of the route planning, the operating conditions of the public transportations (e.g., operating periods or operating sections corresponding to the public transportations having fixed sites (e.g., buses) and distribution of the public transportations having non-fixed sites (e.g., shared bikes)) may need to be considered. Besides, when the route planning record is generated, the identifiers of the public transportations may be provided to the user, which may make the user understand the public transportation travel routes more intuitively.

The arrival time for a public transportation associated with each public transportation travel route arriving at the start location may be predetermined based on the departure time, road conditions, and/or the distribution of shared bikes may be displayed at the start location of each public transportation travel route, to ensure that the user can comprehensively weight multiple public transportation travel routes based on the operating conditions, and the reliability of route planning may also be improved.

It should be noted that the start coordinates may include latitude and longitude coordinates associated with the start location or coordinates associated with an area determined based on at least one of Wi-Fi positioning technology, Global Position System (GPS) positioning technology, base station positioning technology, etc. A coordinate accuracy of the above positioning technologies may be less than 10 meters.

In some embodiments, to determine start coordinates associated with the at least one route planning record based on the first travel, the processing device 112 may analyze the location of the client terminal and the start location associated with the first travel. The location of the client terminal may be the geographic location of the client terminal when the first travel is generated. The processing device 112 may determine the distance between the location of the client terminal and the start location. The processing device 112 may designate coordinates corresponding to the start location as the start coordinates in response to a determination that the distance is greater than or equal to a distance threshold. The processing device 112 may designate coordinates corresponding to the location of the client terminal as the start coordinates in response to a determination that the distance is less than the distance threshold.

In some embodiments, when the distance is determined to be greater than or equal to the distance threshold, it may be determined that the distance between the location of the client terminal and the start location may be relatively great, and the coordinates corresponding to the start location may be designated as the start coordinates associated with the at least one route planning record. Alternatively or additionally, when the distance is determined to be less than the distance threshold, it may be considered that the location of the client terminal may not be positioned precisely, and the coordinates corresponding to the location of the client terminal may be designated as the start coordinates associated with the at least one route planning record, which may satisfy a travel request of the user. The distance threshold may be 300 meters.

In some embodiments, to push one of the at least one route planning record corresponding to the request to the client terminal in response to a request of the client terminal for obtaining one of the at least one public transportation travel route, the processing device 112 may push interface identifiers corresponding to a specific route planning record and/or an unspecific route planning record of the at least one route planning record based on a predetermined strategy in response to the request including planning the at least one public transportation travel route. The processing device 112 may instruct the client terminal to display the specific route planning record in the form of map interface. The map interface may display the one or more identifiers of the one or more public transportations and a second travel associated with the at least one public transportation travel route. The processing device 112 may instruct the client terminal to display the unspecific route planning record in the form of the interface identifier. The second travel may include at least one of travel parameters including the total travel duration of the at least one public transportation travel route, a travel trajectory of the at least one public transportation travel route, the total walking distance, or the transportation cost, or a combination thereof.

In some embodiments, the interface identifier corresponding to a specific route planning record and/or an unspecific route planning record of the at least one route planning record may be displayed based on the predetermined strategy. The specific route planning record may be displayed in the map interface, which may intuitively display the total travel duration of the at least one public transportation travel route, the travel trajectory of the at least one public transportation travel route, the total walking distance, or the transportation cost, or a combination thereof. Further, the unspecific route planning record may be displayed in the form of interface identifiers to save the network data usage.

In some embodiments, in response to a request of the client terminal for obtaining the interface identifier, the processing device 112 may push the unspecific route planning record corresponding to the interface identifier to the client terminal. The processing device 112 may further instruct the client terminal to display the unspecific route planning record corresponding to the interface identifier in the form of the map interface.

In response to the request of the client terminal for obtaining the interface identifier, the unspecific route planning record corresponding to the interface identifier may be pushed to the client terminal so as to provide various route planning records for the user. In order to facilitate the search of the route planning records requested by the user, the specific route planning records and unspecific route planning records may be selected based on the predetermined strategy. For example, a route planning record with the shortest total travel duration may be determined as a specific route planning record. As another example, a route planning record with the least total walking distance may be determined as a specific route planning record. As a further example, a route planning record having the highest use frequency or highest evaluation from the user that stored in a storage device (e.g., the storage device 160) may be determined as a specific route planning record.

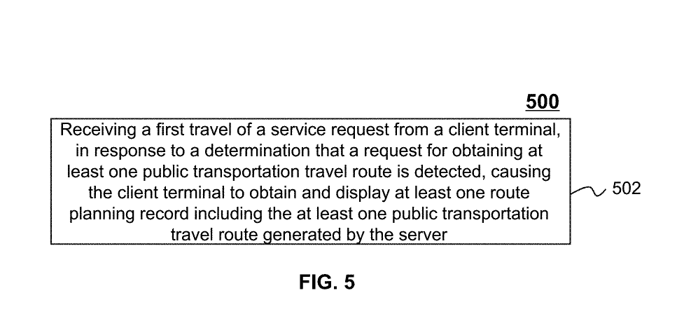

FIG. 5 is a flowchart illustrating an exemplary process 500 for route planning according to some embodiments of the present disclosure. In some embodiments, process 500 may be implemented in the routing planning system 100. For example, process 500 may be stored in the storage device 160 and/or the storage (e.g., the ROM 230, the RAM 240, etc.) as the form of instructions, and invoked and/or executed by the server 110 (e.g., the processing device 112 in the server 110, or the CPU 340 of the mobile device 300).

In 502, the processing device 112 may receive a first travel of a service request from a client terminal (e.g., the requester terminal 130). In response to a determination that a request for obtaining at least one public transportation travel route is detected, the client terminal (e.g., the CPU 340) may obtain and display at least one route planning record including the at least one public transportation travel route generated by the server (e.g., the processing device 112). Start coordinates associated with the at least one route planning record may be determined based on the first travel.

In some embodiments, in response to a first travel received from the client terminal, at least one route planning record may be generated based on the first travel. The at least one route planning record may include at least one public transportation travel route. In response to a request of the client terminal for obtaining one of the at least one public transportation travel route, one of the at least one route planning record corresponding to the request may be pushed to the client terminal. For example, when a user wants to obtain a public transportation travel route after sending out a first travel, the route planning record may be pushed to the user without the need of manual input by the user of the travel information again, which may simplify operations of the user, provide convenient comparisons among multiple public transportation travel routes, and improve the user experience.

In some embodiments, the first travel sent by the client terminal (or the user) may include the start location, the destination, and the departure time of a service request. Attribute information of the route planning record may include the timestamp corresponding to the departure time.

It should be noted that the start coordinates are not strict latitude and longitude coordinates, but a coordinate area determined based on at least one of Wi-Fi positioning technology, Global Position System (GPS) positioning technology, or base station positioning technology. The coordinate accuracy of the above positioning technologies may be less than 10 meters.

In some embodiments, to obtain and display at least one route planning record including the at least one public transportation travel route generated by the server, the client terminal (e.g., the CPU 340 or the display unit 702) may obtain interface identifiers corresponding to a specific route planning record and/or an unspecific route planning record of the at least one route planning record generated by the server based on a predetermined strategy. The client terminal (e.g., the display unit 702) may display the specific route planning record in the form of map interface. The map interface may display the one or more identifiers of the one or more public transportations and a second travel associated with the at least one public transportation travel route. The client terminal (e.g., the display unit 702) may display the unspecific route planning record in the form of the interface identifier. The second travel may include at least one of travel parameters including the total travel duration of the at least one public transportation travel route, a travel trajectory of the at least one public transportation travel route, the total walking distance, or the transportation cost, or a combination thereof.

In some embodiments, the interface identifiers corresponding to a specific route planning record and/or an unspecific route planning record of the at least one route planning record may be displayed based on a predetermined strategy. The specific route planning record may be displayed as the map interface, which may intuitively display the total travel duration of the at least one public transportation travel route, the travel trajectory of the at least one public transportation travel route, the total walking distance, and the transportation cost. Further, the unspecific route planning record may be displayed in the form of interface identifiers so as to save the network data usage.

In some embodiments, to obtain and display at least one route planning record including the at least one public transportation travel route generated by the server, the processing device 112 may, in response to a determination that a request for obtaining the interface identifier is detected, instruct the client terminal (e.g., the CPU 340 or the display unit 702) to obtain the unspecific route planning record corresponding to the interface identifier generated by the server. The processing device 112 may instruct the client terminal to display the unspecific route planning record corresponding to the interface identifier in the form of the map interface.

In some embodiments, in response to a request for planning the at least one public transportation travel route, the interface identifiers corresponding to a specific route planning record and/or an unspecific route planning record of the at least one route planning record may be pushed to the client terminal based on a predetermined strategy. The specific route planning record may be displayed as the map interface. The unspecific route planning record may be displayed in the form of interface identifiers so as to save the network data usage.

In some embodiments, to display the unspecific route planning record in the form of the interface identifier, the processing device 112 may cause the client terminal (e.g., the display unit 702) to display a plurality of interface identifiers as an interface list based on at least one of the travel parameters of the second travel.

In some embodiments, a plurality of interface identifiers may be displayed as an interface list based on at least one of the travel parameters of the second travel, which may provide convenience for the user to obtain a plurality of unspecific route planning records through the interface list, and display an unspecific route planning record corresponding to the touch operation of the user on the interface list.

In some embodiments, to display the specific route planning record in the form of map interface, the processing device 112 may cause the client terminal to (e.g., the display unit 702) to display the one or more operating conditions of the one or more public transportations corresponding to each of the at least one public transportation travel route in the map interface. The one or more operating conditions may include one or more operating periods and one or more operating sections corresponding to a first portion of the one or more public transportations having fixed sites, and the distribution of a second portion of the one or more public transportations having non-fixed sites.

In some embodiments, in order to improve the reliability of the route planning, the operating conditions of the public transportations may need to be considered. For example, operating periods or operating sections corresponding to a first portion of the public transportations having fixed sites (e.g., buses) and distribution of a second portion of the public transportations having non-fixed sites (e.g., shared bikes) may need to be considered. Besides, when the route planning record is generated, identifiers of the public transportations may be provided to the user, which may make the user understand the public transportation travel plans more intuitively.

The time when a public transportation associated with each public transportation travel route arrives at the start location may be predetermined based on the departure time and road conditions, and/or the distribution of shared bikes may be displayed at the start location of each public transportation travel route. As such, the user can comprehensively weight multiple public transportation travel routes based on the above operating conditions, and the reliability of route planning may also be improved.

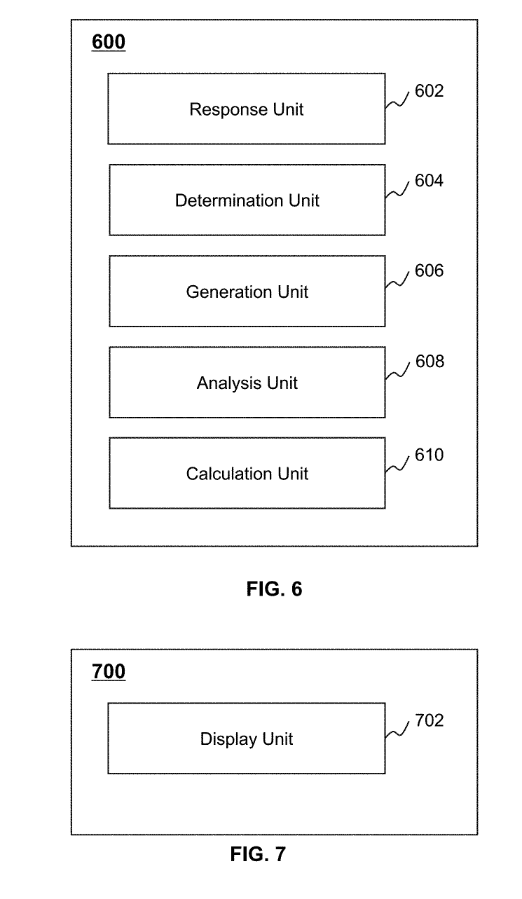

FIG. 6 is a block diagram illustrating an exemplary route planning device 600 according to some embodiments of the present disclosure. The route planning device 600 may include a response unit 602, a determination unit 604, a generation unit 606, an analysis unit 608, and a calculation unit 610. The units of the route planning device 600 may be hardware circuits of at least part of the processing device 112. The units of the route planning device 600 may also be implemented as an application or set of instructions read and executed by the processing device 112. Further, the units may be any combination of the hardware circuits and the application/instructions. For example, the units of the route planning device 600 may be the part of the processing device 112 when the processing device 112 is executing the application or set of instructions.

As shown in FIG. 6, the response unit 602 may be configured to, in response to a first travel received from a client terminal, generate at least one route planning record based on the first travel. The at least one route planning record may include at least one public transportation travel route. The response unit 602 may also be configured to transmit one of the at least one route planning record to the client terminal in response to a request of the client terminal for obtaining a public transportation travel route.

In some embodiments, at least one route planning record may be generated based on the first travel in response to the first travel received from the client terminal. The at least one route planning record may include at least one public transportation travel route. In response to a request of the client terminal for obtaining a public transportation travel route, one or more of the at least one route planning record corresponding to the request may be transmitted to the client terminal. For example, when a user wants to read a public transportation travel route after sending out a first travel, the user may input a request for obtaining a public transportation travel route. Further, the user may click a button (e.g., “Bus” button on a page of the online taxi-hailing application as shown in FIG. 9) associated with the client terminal to send the request for obtaining a public transportation travel route. Then the user may receive the route planning record(s) without manually inputting the travel information again, which may simplify operations of the user, provide convenient comparisons among multiple public transportation travel routes, and improve user experience.

In some embodiments, the first travel sent by the client terminal (or the user) may include the start location, the destination, and the departure time of a service request. Attribute information of the route planning record may include the timestamp corresponding to the departure time.

The determination unit 604 may be configured to determine the start coordinates associated with the at least one route planning record based on the first travel. The response unit 602 may also be configured to, in response to the destination coordinates of the first travel, determine the at least one public transportation travel route based on the start coordinates and the destination coordinates. The determination unit 604 may also be configured to determine one or more operating conditions of one or more public transportations corresponding to each of the at least one public transportation travel route, based on the departure time of the first travel and the road condition associated with the each of the at least one public transportation travel route. The one or more operating conditions may include operating periods and operating sections corresponding to a first portion of the one or more public transportations having fixed sites, and the distribution of a second portion of the one or more public transportations having non-fixed sites. The generation unit 606 may be configured to generate the at least one route planning record based on the one or more operating conditions of the one or more public transportations. Each of the at least one route planning record may include one or more identifiers of the one or more public transportations and an interface identifier configured to be displayed on the client terminal. The interface identifier may correspond to the each of the at least one route planning record.

In some embodiments, the start coordinates associated with the at least one route planning record may be determined based on the first travel. For example, the start coordinates may be coordinates of the start location of the first travel. As another example, the start coordinates may be coordinates of the location of the client terminal when sending the first travel to the route planning system. In response to the destination coordinates of the first travel, the at least one public transportation travel route may be determined based on the start coordinates and the destination coordinates. When the user reads the public transportation travel route, a prompt (i.e., the route planning record) may be directly pushed to the user without the user's input of travel information again. Further, in order to improve reliability of the route planning, the operating conditions of the public transportations (e.g., operating periods or operating sections corresponding to the public transportations having fixed sites (e.g., buses) and distribution of the public transportations having non-fixed sites (e.g., shared bikes)) may need to be considered. Besides, when the route planning record is generated, the identifiers of the public transportations may be provided to the user, which may make the user understand the public transportation travel routes more intuitively.

The arrival time for a public transportation associated with each public transportation travel route arriving at the start location may be predetermined based on the departure time, road conditions, and/or the distribution of shared bikes may be displayed at the start location of each public transportation travel route, to ensure that the user can comprehensively weight multiple public transportation travel routes based on the operating conditions, and the reliability of route planning may also be improved.

It should be noted that the start coordinates may include latitude and longitude coordinates associated with the start location or coordinates associated with an area determined based on at least one of Wi-Fi positioning technology, Global Position System (GPS) positioning technology, base station positioning technology, etc. The coordinate accuracy of the above positioning technologies may be less than 10 meters.

The analysis unit 608 may be configured to analyze the location of the client terminal and the start location associated with the first travel. The location of the client terminal may be the geographic location of the client terminal when the first travel is generated. The calculation unit 610 may be configured to determine the distance between the location of the client terminal and the start location. The determination unit 604 may be configured to designate coordinates corresponding to the start location as the start coordinates in response to a determination that the distance is greater than or equal to a distance threshold. The determination unit 604 may also be configured to designate coordinates corresponding to the location of the client terminal as the start coordinates in response to a determination that the distance is less than the distance threshold.

In some embodiments, when the distance is determined to be greater than or equal to the distance threshold, it may be determined that the distance between the location of the client terminal and the start location may be relatively great, and the coordinates corresponding to the start location may be designated as the start coordinates associated with the at least one route planning record. Alternatively or additionally, when the distance is determined to be less than the distance threshold, it may be considered that the location of the client terminal may not be positioned precisely, and the coordinates corresponding to the location of the client terminal may be designated as the start coordinates associated with the at least one route planning record, which may satisfy a travel request of the user. The distance threshold may be 300 meters.

In some embodiments, the response unit 602 may be configured to push interface identifiers corresponding to a specific route planning record and/or an unspecific route planning record of the at least one route planning record based on a predetermined strategy in response to the request including planning the at least one public transportation travel route. The response unit 602 may instruct the client terminal to display the specific route planning record in the form of map interface. The map interface may display the one or more identifiers of the one or more public transportations and a second travel associated with the at least one public transportation travel route. The response unit 602 may instruct the client terminal to display the unspecific route planning record in the form of the interface identifier. The second travel may include at least one of travel parameters including the total travel duration of the at least one public transportation travel route, a travel trajectory of the at least one public transportation travel route, the total walking distance, or the transportation cost, or a combination thereof.

In some embodiments, the interface identifier corresponding to a specific route planning record and/or an unspecific route planning record of the at least one route planning record may be displayed based on the predetermined strategy. The specific route planning record may be displayed in the map interface, which may intuitively display the total travel duration of the at least one public transportation travel route, the travel trajectory of the at least one public transportation travel route, the total walking distance, or the transportation cost, or a combination thereof. Further, the unspecific route planning record may be displayed in the form of interface identifiers to save the network data usage.

In some embodiments, in response to a request of the client terminal for obtaining the interface identifier, the response unit 602 may push the unspecific route planning record corresponding to the interface identifier to the client terminal. The response unit 602 may further instruct the client terminal to display the unspecific route planning record corresponding to the interface identifier in the form of the map interface.

In response to the request of the client terminal for obtaining the interface identifier, the unspecific route planning record corresponding to the interface identifier may be pushed to the client terminal so as to provide various route planning records for the user. In order to facilitate the search of the route planning records requested by the user, the specific route planning records and unspecific route planning records may be selected based on the predetermined strategy. For example, a route planning record with the shortest total travel duration may be determined as a specific route planning record. As another example, a route planning record with the least total walking distance may be determined as a specific route planning record. As a further example, a route planning record having the highest use frequency or highest evaluation from the user that stored in a storage device (e.g., the storage device 160) may be determined as a specific route planning record.

FIG. 7 is a block diagram illustrating an exemplary route planning device 700 according to some embodiments of the present disclosure. The route planning device 700 may include a display unit 702. The unit(s) of the route planning device 700 may be a hardware circuit of at least part of the requester terminal 130. The unit(s) of the route planning device 700 may also be implemented as an application or set of instructions read and executed by the requester terminal 130 (e.g., the CPU 340 or the GPU 330). Further, the unit(s) may be any combination of the hardware circuits and the application/instructions. For example, the unit(s) of the route planning device 700 may be the part of the requester terminal 130 (e.g., the CPU 340 or the GPU 330) when the requester terminal 130 (e.g., the CPU 340 or the GPU 330) is executing the application or set of instructions.

As shown in FIG. 4, after a server (e.g., the processing device 112) receives a a first travel of a service request from a client terminal, the display unit 702 may be configured to, in response that a request for obtaining at least one public transportation travel route is detected, obtain and display at least one route planning record including the at least one public transportation travel route generated by the server (e.g., the processing device 112). Start coordinates associated with the at least one route planning record may be determined based on the first travel.

In some embodiments, in response to a first travel received from the client terminal, at least one route planning record may be generated based on the first travel. The at least one route planning record may include at least one public transportation travel route. In response to a request of the client terminal for obtaining one of the at least one public transportation travel route, one of the at least one route planning record corresponding to the request may be pushed to the client terminal. For example, when a user wants to obtain a public transportation travel route after sending out a first travel, the route planning record may be pushed to the user without the need of manual input by the user of the travel information again, which may simplify operations of the user, provide convenient comparisons among multiple public transportation travel routes, and improve user experience.

In some embodiments, the first travel sent by the client terminal (or the user) may include the start location, the destination, and the departure time of a service request. Attribute information of the route planning record may include the timestamp corresponding to the departure time.

It should be noted that the start coordinates are not strict latitude and longitude coordinates, but a coordinate area determined based on at least one of Wi-Fi positioning technology, GPS technology, or base station positioning technology. The coordinate accuracy of the above positioning technologies may be less than 10 meters.

In some embodiments, the display unit 702 may be configured to obtain interface identifiers corresponding to a specific route planning record and/or an unspecific route planning record of the at least one route planning record generated by the server based on a predetermined strategy. The display unit 702 may be configured to display the specific route planning record in the form of map interface. The map interface may display the one or more identifiers of the one or more public transportations and a second travel associated with the at least one public transportation travel route. The display unit 702 may also be configured to display the unspecific route planning record in the form of the interface identifier. The second travel may include at least one of travel parameters including the total travel duration of the at least one public transportation travel route, a travel trajectory of the at least one public transportation travel route, the total walking distance, or the transportation cost, or a combination thereof.

In some embodiments, the interface identifiers corresponding to a specific route planning record and/or an unspecific route planning record of the at least one route planning record may be displayed based on a predetermined strategy. The specific route planning record may be displayed as the map interface, which may intuitively display the total travel duration of the at least one public transportation travel route, the travel trajectory of the at least one public transportation travel route, the total walking distance, and the transportation cost. Further, the unspecific route planning record may be displayed in the form of interface identifiers so as to save the network data usage.

In some embodiments, the display unit 702 may be configured to, in response to a determination that a request for obtaining the interface identifier is detected, obtain the unspecific route planning record corresponding to the interface identifier generated by the server. The display unit 702 may also be configured to instruct the client terminal to display the unspecific route planning record corresponding to the interface identifier in the form of the map interface.

In some embodiments, in response to a request for planning the at least one public transportation travel route, the interface identifiers corresponding to a specific route planning record and/or an unspecific route planning record of the at least one route planning record may be pushed to the client terminal based on a predetermined strategy. The specific route planning record may be displayed as the map interface. The unspecific route planning record may be displayed in the form of interface identifiers so as to save the network data usage.

In some embodiments, the display unit 702 may display a plurality of interface identifiers as an interface list based on at least one of the travel parameters of the second travel.

In some embodiments, a plurality of interface identifiers may be displayed as an interface list based on at least one of the travel parameters of the second travel, which may provide convenience for the user to obtain a plurality of unspecific route planning records through the interface list, and display an unspecific route planning record corresponding to the touch operation of the user on the interface list.

In some embodiments, the display unit 702 may display the one or more operating conditions of the one or more public transportations corresponding to each of the at least one public transportation travel route in the map interface. The one or more operating conditions may include one or more operating periods and one or more operating sections corresponding to a first portion of the one or more public transportations having fixed sites, and the distribution of a second portion of the one or more public transportations having non-fixed sites.

In some embodiments, in order to improve the reliability of the route planning, the operating conditions of the public transportations may need to be considered. For example, operating periods or operating sections corresponding to a first portion of the public transportations having fixed sites (e.g., buses) and distribution of a second portion of the public transportations having non-fixed sites (e.g., shared bikes) may need to be considered. Besides, when the route planning record is generated, identifiers of the public transportations may be provided to the user, which may make the user understand the public transportation travel plans more intuitively.

The time when a public transportation associated with each public transportation travel route arrives at the start location may be predetermined based on the departure time and road conditions, and/or the distribution of shared bikes may be displayed at the start location of each public transportation travel route. As such, the user can comprehensively weight multiple public transportation travel routes based on the above operating conditions, and the reliability of route planning may also be improved.

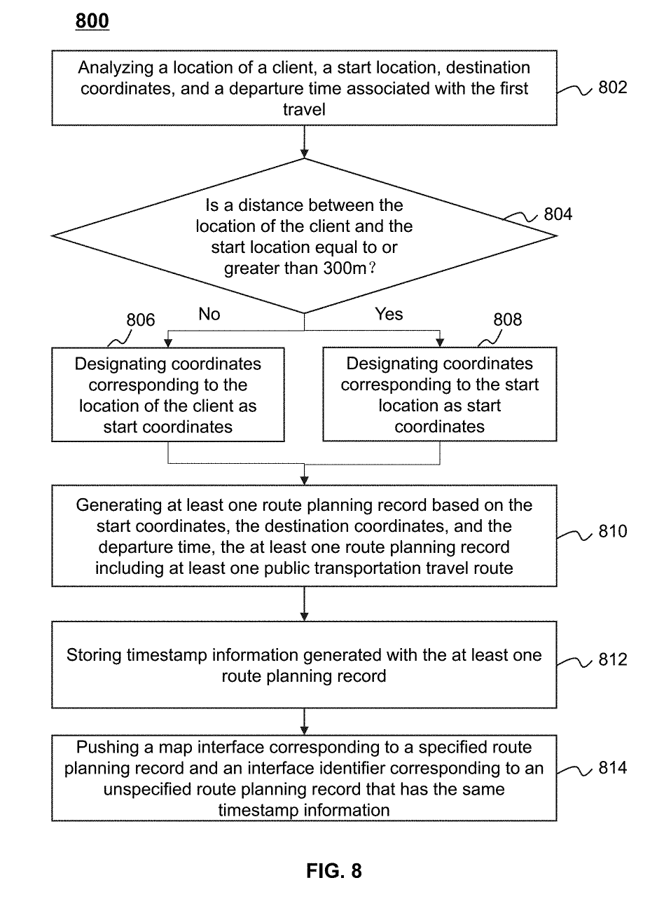

FIG. 8 is a flowchart illustrating an exemplary process for route planning according to some embodiments of the present disclosure. In some embodiments, process 800 may be implemented in the routing planning system 100. For example, process 800 may be stored in the storage device 160 and/or the storage (e.g., the ROM 230, the RAM 240, etc.) as the form of instructions, and invoked and/or executed by the server 110 (e.g., the processing device 112 in the server 110, or the processor 220 of the processing device 112 in the server 110).

In 802, the processing device 112 may analyze the location of a client terminal, the start location, destination coordinates, and the departure time associated with the first travel.

In 804, the processing device 112 may determine whether the distance between the location of the client terminal and the start location is greater than or equal to a threshold (e.g., 300 m). If it is determined that the distance is greater than or equal to 300 m, process 800 may proceed to operation 808. If it is determined that that the distance is less than 300 m, process 800 may proceed to operation 806.

In 806, the processing device 112 may designate coordinates corresponding to the location of the client terminal as start coordinates.

In 808, the processing device 112 may designate coordinates corresponding to the start location as start coordinates.

In 810, the processing device 112 may generate at least one route planning record based on the start coordinates, the destination coordinates, and the departure time. The at least one route planning record may include at least one public transportation travel route.

In 812, the processing device 112 may store the timestamp information associated with the departure time generated with the at least one route planning record.

In 814, the processing device 112 may push a map interface corresponding to a specific route planning record and an interface identifier corresponding to an unspecific route planning record that has the same timestamp information.

FIG. 9 is a schematic diagram illustrating an exemplary express interface 900 on an online taxi-hailing application according to some embodiments of the present disclosure. As shown in FIG. 9, the user may enter a start location, destination coordinates, and a departure time (e.g., 21:00) in an “Express” interface on the online taxi-hailing application. A server (e.g., the server 110) may transmit a predetermined carpooling service fee 19.75 RMB, and a predetermined non-carpooling service fee 22.96 RMB. The server 110 may display a preview of “Online taxi-hailing driving trajectory.” And after the user selects “Passenger” and “Payment method options,” whether the user touch “Confirm” on the interface or not, the server 110 may acquire the travel (i.e., the first travel) and generate the timestamp as attribute information.

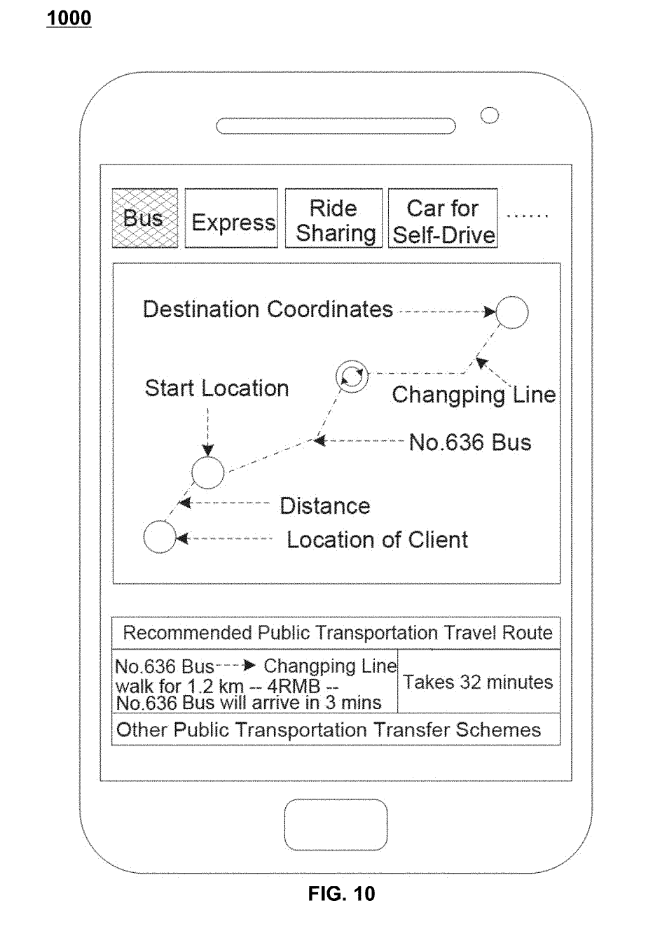

FIG. 10 is a schematic diagram illustrating an exemplary public transportation interface (also referred to as bus interface) 1000 on an online taxi-hailing application according to some embodiments of the present disclosure. As shown in FIG. 10, after the client terminal sends out the travel (e.g., the first travel), if the user touch “Bus” on the interface, the server 110 may push a route planning record including a public transportation travel route. For example, if the distance between the location of the client terminal and the start location is 1 kilometer (greater than the threshold 300 meters), the start location of the first travel may be determined as the start coordinates of the route planning record. If the predetermined strategy is taking the least time for route planning, a route planning record displayed on the map interface may include “No. 636 Bus→Changping Line”, travel information (e.g., the second travel) such as “walk for 1.2 kilometers (km)”, “4 RMB”, “No. 636 Bus will arrive in 3 minutes (mins)”, and “Takes 32 minutes”, and identifiers corresponding to “No. 636 Bus” and “Changping Line” may be displayed on the map interface. In order to save the network data usage, the text “Other Public Transportation Transfer Schemes” may be replaced by an interface identifier. When the user touches the interface identifier, other public transportation transfer schemes may be displayed.

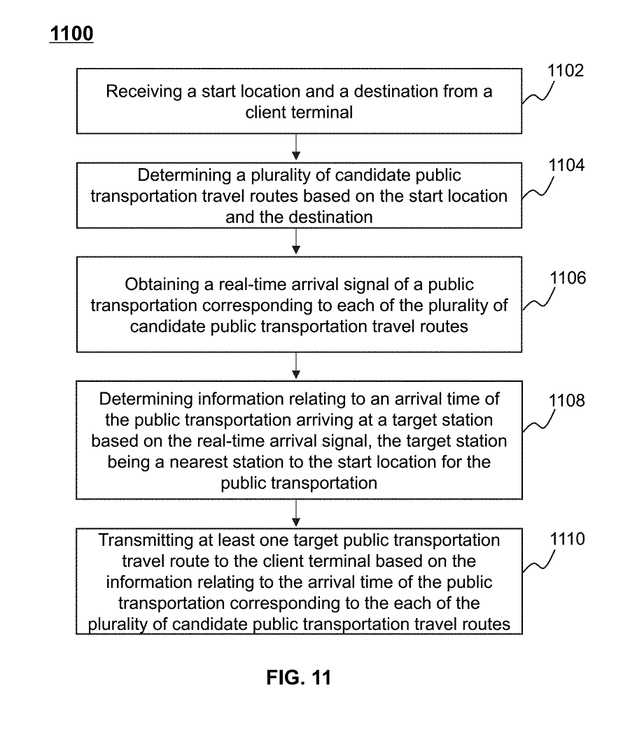

FIG. 11 is a flowchart illustrating an exemplary process 1100 for determining one or more public transportation travel routes according to some embodiments of the present disclosure. In some embodiments, process 1100 may be implemented in the route planning system 100. For example, process 1100 may be stored in the storage device 160 and/or the storage (e.g., the ROM 230, the RAM 240, etc.) as the form of instructions, and invoked and/or executed by the server 110 (e.g., the processing device 112 in the server 110, or the processor 220 of the processing device 112 in the server 110).

In 1102, the processing device 112 may receive a start location and a destination from a client terminal.

In 1104, the processing device 112 may determine a plurality of candidate public transportation travel routes based on the start location and the destination.

In 1106, the processing device 112 may obtain a real-time arrival signal of a public transportation corresponding to each of the plurality of candidate public transportation travel routes.

In 1108, the processing device 112 may determine information relating to an arrival time of the public transportation arriving at a target station based on the real-time arrival signal. The target station may be the nearest station to the start location for the public transportation.

In 1110, the processing device 112 may transmit at least one target public transportation travel route to the client terminal based on the information relating to the arrival time of the public transportation corresponding to the each of the plurality of candidate public transportation travel routes.

In some embodiments, when the client terminal determines the start location and the destination via an online taxi-hailing application, the plurality of candidate public transportation travel routes may be determined based on the start location and the destination. Specifically, the plurality of candidate public transportation travel routes may be determined based on various factors including, for example, whether the plurality of candidate public transportation travel routes are direct, whether the plurality of candidate public transportation travel routes involve a transfer, an expected duration of each of the plurality of candidate public transportation travel routes. Also, a public transportation corresponding to each of the plurality of candidate public transportation travel routes may transmit the real-time arrival signal to a data service platform associated with the online taxi-hailing application upon arriving at a station. Specifically, the real-time arrival signal may be transmitted to the data service platform by triggering a signal transmitter on the public transportation. The signal transmitter may be triggered when a driver of the public transportation presses the door opening bottom. Further, the real-time arrival signal of the public transportation corresponding to each of the plurality of candidate public transportation travel routes may be obtained when the client terminal sends a request for transmitting public transportation travel routes based on the input of the start location and the destination by the user to a server (e.g., the processing device 112). The information relating to the arrival time of the public transportation arriving at the target station may be determined based on the real-time arrival signal. At least one target public transportation travel route may be transmitted to the client terminal based on the information relating to the arrival time. According to the present disclosure, the arrival times of different public transportations may be presented to the client terminal. On or more optimal travel routes may be transmitted to the client terminal as options, thereby improving travel experience of the client terminal.

In some embodiments, the real-time arrival signal of the public transportation may include an arrival station, a vehicle number, a license plate, a driving direction, an area the public transportation located, or the like, or a combination thereof.

In some embodiments, to ensure that the arrival time to the target station may be determined based on the real-time arrival signal of the public transportation, the real-time arrival signal may include the current arrival station when transmitting the real-time arrival signal, the vehicle number, the license plate, the driving direction (up or down), the area the public transportation located, etc. At the same time, a public transportation control system may monitor each public transportation based on the real-time arrival signal.

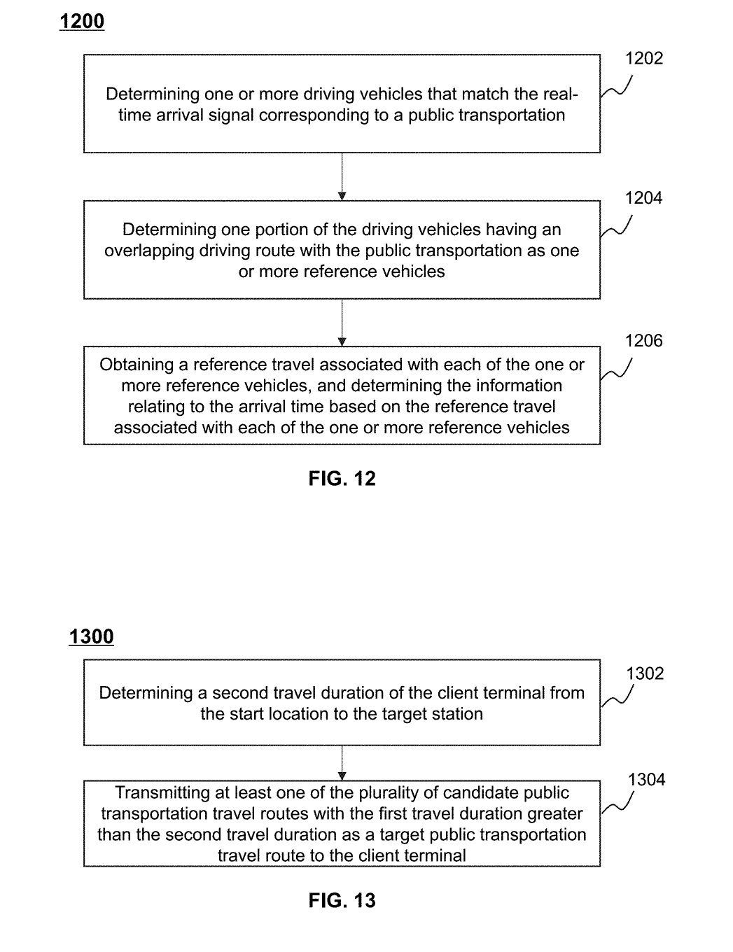

FIG. 12 is a flowchart illustrating an exemplary process for determining information relating to an arrival time of a public transportation according to some embodiments of the present disclosure. In some embodiments, process 1200 may be implemented in the route planning system 100. For example, process 1200 may be stored in the storage device 160 and/or the storage (e.g., the ROM 230, the RAM 240, etc.) as the form of instructions, and invoked and/or executed by the server 110 (e.g., the processing device 112 in the server 110, or the processor 220 of the processing device 112 in the server 110). Operation 1108 may be performed according to process 1200 as described in FIG. 12.

In 1220, the processing device 112 may determine one or more driving vehicles that match the real-time arrival signal corresponding to a public transportation.

The driving vehicles may be contracted vehicles of the online taxi-hailing application. The driving directions of the driving vehicles may match the driving direction of the public transportation.

In 1222, the processing device 112 may determine one portion of the driving vehicles having an overlapping driving route with the public transportation as one or more reference vehicles.

In 1224, the processing device 112 may obtain a reference travel associated with each of the one or more reference vehicles and determining the information relating to the arrival time based on the reference travel associated with each of the one or more reference vehicles.

In some embodiment, the information relating to the arrival time of the public transportation arriving at the target station based on the real-time arrival signal of the public transportation may be determined based on the reference travel associated with the contracted vehicles of the online taxi-hailing application. The reference travel corresponding to the current arrival station and the target station of the public transportation may be pre-determined based on the historical travel of the contracted vehicles. The information relating to the arrival time of the public transportation may be determined based on the reference travels associated with the driving vehicles having overlapping driving routes by collecting, counting, and analyzing the historical travel information associated with the contracted vehicles. The accuracy and reliability of the obtained arrival time signal may be ensured by analyzing and summarizing a large amount of empirical data, improving the value of data stored in the data service platform associated with the online taxi-hailing application and practicality of the online taxi-hailing application.

In some embodiments, the reference travel may include a driving speed of a reference public transportation, the driving distance from the arrival station to the target station, the driving duration of a reference public transportation from the arrival station to the target station, or a combination thereof.

In some embodiments, the information relating to the arrival time of the public transportation arriving at the target station may be determined based on the reference travel associated with the contracted vehicles of the online taxi-hailing application. For example, the information relating to the arrival time of the public transportation arriving at the target station may be determined based on the driving speed and the driving distance. The driving speed may be an average of a plurality of driving speeds. As another example, the information relating to the arrival time of the public transportation arriving at the target station may be determined based on the driving duration for the contracted vehicles from the current arrival station to the target station. The driving duration may be an average of a plurality of driving durations.

In some embodiments, the information relating to the arrival time may include an arrival time point of the public transportation arriving at the target station, the travel duration of the public transportation from the arrival station to the target station, or a combination thereof.

In some embodiments, to ensure that the user is able to select the optimal public transportation travel route based on the information relating to the arrival time of the public transportation, the information relating to the arrival time may include the arrival time point of the public transportation arriving at the target station and the travel duration for the public transportation from the arrival station when transmitting the real-time arrival signal to the target station.

FIG. 13 is a flowchart illustrating an exemplary process for transmitting a public transportation travel route according to some embodiments of the present disclosure. In some embodiments, process 1300 may be implemented in the route planning system 100. For example, process 1300 may be stored in the storage device 160 and/or the storage (e.g., the ROM 230, the RAM 240, etc.) as the form of instructions, and invoked and/or executed by the server 110 (e.g., the processing device 112 in the server 110, or the processor 220 of the processing device 112 in the server 110). Operation 1110 may be performed according to process 1300 as described in FIG. 13.

In 1302, the processing device 112 may determine a second travel duration of the client terminal from the start location to the target station.

In 1304, the processing device 112 may transmit at least one of the plurality of candidate public transportation travel routes with the first travel duration greater than the second travel duration as a target public transportation travel route to the client terminal.

In some embodiments, at least one of the plurality of candidate public transportation travel routes with the first travel duration greater than the second travel duration (for example, the walking duration or the riding duration) for the client terminal to arriving at the target station from the start location may be transmitted to the client terminal as the at least one target public transportation travel route. The user may arrive at the target station earlier than the public transportation, which makes it convenient for the user to arrange the travel time and improves the travel experience of the user.

In some embodiments, the online taxi-hailing application may be DIDI application. When User A is outbound from a train station of city B, User A may plan to go to a conference center C from the train station by public transportation. User A may open the DIDI application and enter the train station as a start point (i.e., the start location) and the conference center C as the end point (i.e., the destination). The data service platform (for example, DIDI large data platform) of the DIDI application may select a plurality of possible public transportation travel routes (i.e., the plurality of candidate public transportation travel routes) based on the start point and the end point. The nearest station D to the train station may be determined. The data service platform may determine one or more public transportations that transmit real-time arrival signals to the data service platform. For example, public transportations E, F, and G are arriving at stations H, K, and M, respectively, on their driving routes. Stations H, K, and M may be away from the station D by three stations, two stations, and two stations, respectively. Further, reference vehicles that arrive the station D from the stations H, K, and M may be determined based on historical travel information associated with contracted vehicles stored in the data service platform of the DIDI application. Further, the data service platform may obtain driving distances and the average driving speed of the reference vehicles based on the historical travel information. The data service platform may calculate the driving duration based on the driving distances and the average driving speed. The data service platform may obtain average driving duration corresponding to each of the reference vehicles based on the historical travel information. The data service platform may transmit the driving durations or the average of the driving durations to the client terminal, so that the target public transportation travel route may be transmitted to the client terminal based on the matching degree of the driving durations and the duration when User A walks from the train station to the station D. For example, routes relating to the public transportations E and G may be transmitted to the client terminal, reminding the user accurate arrival time of the public transportations so that the user may arrange the walking speed to ensure to arrive at the station D before the public transportations.

According to some embodiments for public transportation travel route, the client terminal may avoid installing unnecessary applications, public transportation applications, etc. Arrive time of the public transportation may also be reminded to the client terminal together with the travel routes based on the real-time locations of the public transportations. It is convenient for the user to plan the travel. The public transportation company may monitor the public transportations and determine a regional vehicle for each public transportation based on time points of the public transportation arriving at stations.

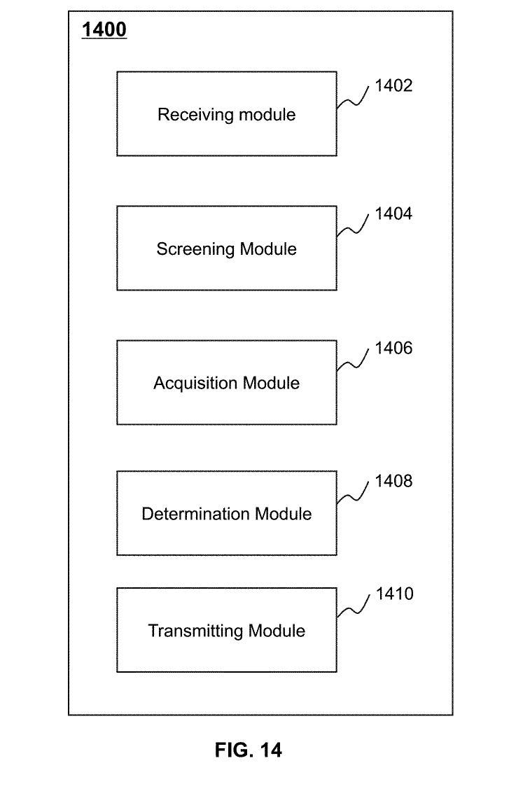

FIG. 14 is a block diagram illustrating a device 1400 for public transportation travel route transmitting according to some embodiments of the present disclosure. As shown in FIG. 14, the device 1400 may be applied to an online taxi-hailing application. The device may include a receiving module 1402, a screening module 1404, an acquisition module 1406, a determination module 1408, and a transmitting module 1410. The units of the device 1400 may be hardware circuits of at least part of the processing device 112. The units of the device 1400 may also be implemented as an application or set of instructions read and executed by the processing device 112. Further, the units may be any combination of the hardware circuits and the application/instructions. For example, the units of the device 1400 may be the part of the processing device 112 when the processing device 112 is executing the application or set of instructions.

The receiving module 1402 may be used to receive the start location and the destination from a client terminal. The screening module 1404 may be used to determine a plurality of candidate public transportation travel routes based on the start location and the destination received by the receiving module 1402. The acquisition module 1406 may be used to obtain a real-time arrival signal of a public transportation corresponding to each of the plurality of candidate public transportation travel routes determined by the screening module 1404. The determination module 1408 may be used to determine information relating to an arrival time of the public transportation arriving at a target station based on the real-time arrival signal obtained by the acquisition module 1406. The target station may be the nearest station to the start location for the public transportation. The transmitting module 1410 may be used to transmit at least one target public transportation travel route to the client terminal based on the information relating to an arrival time of the public transportation determined by the determination module 1408.

In some embodiments, when the client terminal determines the start location and the destination via the online car-hailing application, the plurality of candidate public transportation travel routes may be determined based on the start location and the destination. Specifically, the plurality of candidate public transportation travel routes may be determined based on various factors including, for example, whether the plurality of candidate public transportation travel routes are direct, whether the plurality of candidate public transportation travel routes involve a transfer, and an expected duration of each of the plurality of candidate public transportation travel routes. Also, the public transportation corresponding to each of the plurality of candidate public transportation travel routes may transmit the real-time arrival signal to the data service platform of the online car-hailing application upon arriving at a station. Specifically, the real-time arrival signal may be transmitted to the data service platform by triggering a signal transmitter on the public transportation. The signal transmitter may be triggered when a driver of the public transportation presses the door opening bottom. Further, the real-time arrival signal of the public transportation corresponding to each of the plurality of candidate public transportation travel routes may be obtained when the client terminal sends a request for transmitting public transportation travel routes based on the input of the start location and the destination by the user to a server (e.g., the processing device 112). The information relating to an arrival time of the public transportation arriving at the target station may be determined based on the real-time arrival signal. At least one target public transportation travel route may be transmitted to the client terminal based on the information relating to the arrival time. According to the present disclosure, the arrival time of different public transportations may be presented to the client terminal. One or more optimal travel routes may be transmitted to the client terminal as options, thereby improving travel experience of the client terminal.

In some embodiments, the real-time arrival signal of the public transportation may include an arrival station, a vehicle number, a license plate, a driving direction, and an area the public transportation located.

In some embodiments, to ensure that the arrival time to the target station may be determined based on the real-time arrival signal of the public transportation, the real-time arrival signal may include the current arrival station when transmitting the real-time arrival signal, the vehicle number, the license plate, the driving direction (up or down), the area the public transportation located, etc. At the same time, a public transportation control system may monitor each public transportation based on the real-time arrival signal.

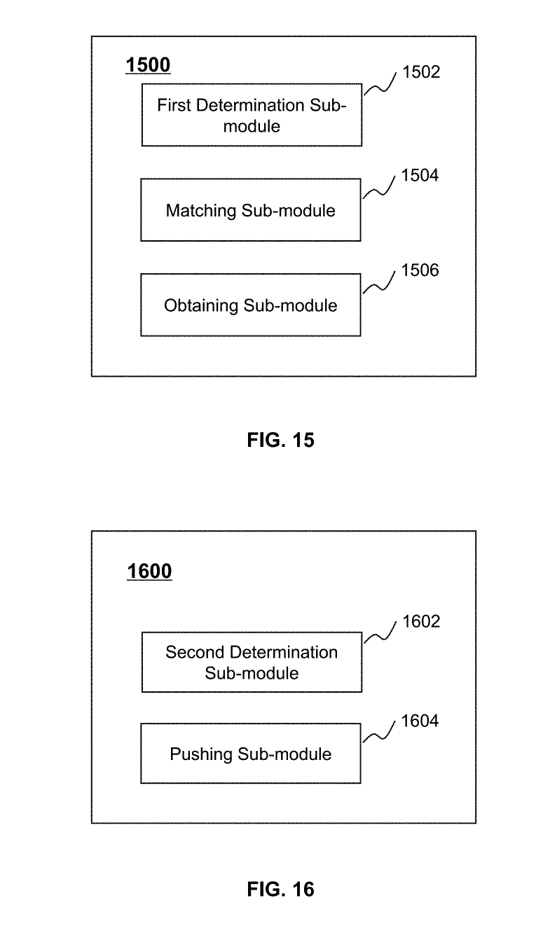

FIG. 15 is a block diagram illustrating an exemplary determination module 1500 according to some embodiments of the present disclosure. The determination module 1500 may include a first determination sub-module 1502, a matching sub-module 1504, and an obtaining sub-module 1506.

The first determination sub-module 1502 may be used to determine one or more driving vehicles that match the real-time arrival signal corresponding to a public transportation. The driving vehicles may be contracted vehicles of the online car-hailing application. The driving directions of the driving vehicles may match the driving direction of the public transportation. The matching sub-module 1504 may be used to determine one portion of the driving vehicles having an overlapping driving route with the public transportation as one or more reference vehicles. The obtaining sub-module 1506 may be used to obtain a reference travel associated with each of the one or more reference vehicles and determine the information relating to the arrival time based on the reference travel associated with each of the one or more reference vehicles.

In some embodiments, the information relating to the arrival time of the public transportation arriving at the target station based on the real-time arrival signal of the public transportation may be determined based on the reference travel associated with the contracted vehicles of the online car-hailing application. The reference corresponding to the current arrival station and the target station of the public transportation may be pre-determined based on the historical travel of the contracted vehicles. The information relating to the arrival time of the public transportation may be determined based on the reference travel associated with the driving vehicles having overlapping driving routes by collecting, counting, and analyzing the historical travel information associated with the contracted vehicles. The accuracy and reliability of the obtained arrival time signal may be ensured by analyzing and summarizing a large amount of empirical data, improving the value of data stored in the data service platform associated with the online car-hailing application and practicality of the online car-hailing application.

In some embodiments, the travel information may include: a driving speed and the distance from the arrival station to the target station, or the driving duration from the arrival station to the target station.

In some embodiments, the information relating to the arrival time of the public transportation arriving at the target station may be determined based on the reference travel associated with the contracted vehicles of the online car-hailing application. For example, the information relating to the arrival time of the public transportation arriving at the target station may be determined based on the driving speed and the driving distance. The driving speed may be an average of a plurality of driving speeds. As another example, the information relating to the arrival time of the public transportation arriving at the target station may be determined based on the driving duration for the contracted vehicles from the current arrival station to the target station. The driving duration be an average of a plurality of driving duration.

In some embodiments, the information relating to the arrival time may include an arrival time point of the public transportation arriving at the target station, the travel duration of the public transportation from the arrival station to the target station, or the like, or a combination thereof.

In some embodiments, to ensure that the user is able to select an optimal public transportation travel route based on the information relating to the arrival time of the public transportation, the information relating to the arrival time may include the arrival time point of the public transportation arriving at the target station and the travel duration for the public transportation from the arrival station when transmitting the real-time arrival signal to the target station.

FIG. 16 is a block diagram illustrating an exemplary transmitting module 1600 according to some embodiments of the present disclosure. The transmitting module 1600 may include a second determination sub-module 1602 and a pushing sub-module 1604.

The second determination sub-module 1602 may be used to determine a second travel duration of the client terminal from the start location to the target station. The pushing sub-module 1604 may be used to transmit at least one of the plurality of candidate public transportation travel routes with the first travel duration greater than the second travel duration as the at least one target public transportation travel route to the client terminal.

In some embodiments, at least one of the plurality of candidate public transportation travel routes with the first travel duration greater than the second travel duration (for example, the walking duration or the riding duration) for the client terminal to arriving at the target station from the start location may be transmitted to the client terminal as the at least one target public transportation travel route. The user may arrive at the target station earlier than the public transportation, which makes it convenient for the user to arrange the travel time and improves travel experience of the user.

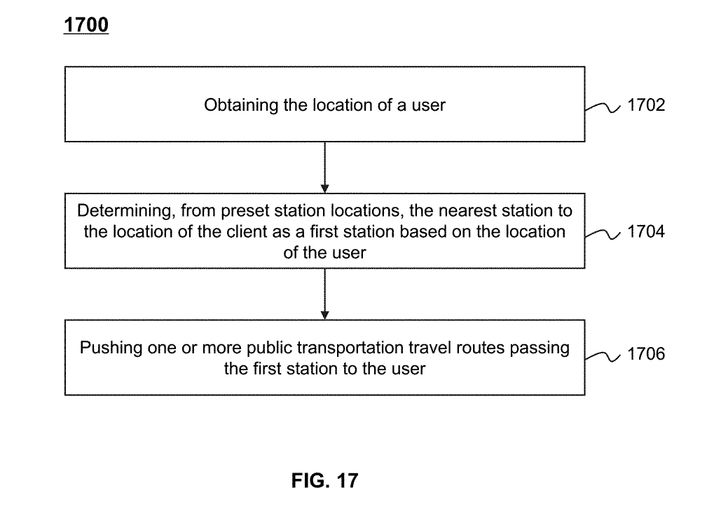

FIG. 17 is a flowchart illustrating an exemplary process 1700 for pushing a public transportation travel route according to some embodiments of the present disclosure. In some embodiments, process 1700 may be implemented in the route planning system 100. For example, process 1700 may be stored in the storage device 160 and/or the storage (e.g., the ROM 230, the RAM 240, etc.) as the form of instructions, and invoked and/or executed by the server 110 (e.g., the processing device 112 in the server 110, or the processor 220 of the processing device 112 in the server 110).

In 1702, the processing device 112 may obtain the location of a user.

In some embodiments, a user may usually carry a mobile terminal (i.e., a client terminal) with him or her, and the mobile terminal of the user may be located using a positioning technology such as GPS technology. A current geographic location of the user may be obtained.

In 1704, the processing device 112 may determine, from preset station locations, the nearest station to the location of the user as a first station based on the location of the user.

The preset station locations may include geographic location coordinates of the preset station locations. In some embodiments, the preset station locations may be pre-stored in a server (e.g., the server 110). For example, the stations a No. 84 bus passes may include the Peony Garden West Station, the Tower Yard South Station, Jimen Bridge South Station, . . . , etc. The information of station locations associated with the No. 84 bus may include all stations the No. 84 bus passes and a station location of each of the stations. Thus, the preset station locations may be obtained after statistical analysis of stations of all public transportation travel routes and the corresponding station locations. Further, a public transportation travel route may be determined by taking factors such as whether it is easy for the user to take a public transportation and distances between the station locations and the location of the user into consideration.

In 1706, the processing device 112 may push one or more public transportation travel routes passing the first station to the user.

In some embodiments, a device for public transportation travel route pushing based on the location of the user may be independent or integrated into another device such as a smartphone, a computer, and a server.

One or more public transportations associated with a public transportation travel route passing a certain station may stop at the station. For example, stations of the No. 84 bus and the No. 21 bus may both include the Peony Garden West Station, which both the No. 84 bus and the No. 21 bus may pass by and stop at. Thus, the public transportation travel routes passing the station Peony Garden West Station may include the No. 84 bus route and the No. 21 bus route.

There are many ways to push the public transportation travel routes. For example, the processing device 112 may push the one or more public transportation travel routes to the user in the form of a list or a popup message. As another example, the processing device 112 may push the one or more public transportation travel routes to the user using a map interface. Specifically, the processing device 112 may display the one or more public transportation travel routes on the map. It should be noted that there are other ways to push the public transportation travel route as long as the user can acquire the public transportation travel routes.

In some embodiments, there may be a variety of pushing contents, as long as the user can know which public transportation travel route is being pushed. Take No. 84 bus route as an example; assume the No. 84 bus route is determined as the public transportation travel route to be pushed, and the route information associated with the No. 84 bus may be pushed to the user. In other words, the information relating to No. 84 bus may be displayed to the user. As another example, the No. 84 bus route and each of the stations of the No. 84 bus may be listed. Specifically, No. 84 bus route including the Peony Garden West Station, the Tower Yard South Station, Jimen Bridge South Station, . . . , etc., may be displayed to the user. As a further example, a trajectory of the No. 84 bus route may be displayed on a map, and the name of each station on the trajectory may also be displayed on the map. It should be noted that the above descriptions of the pushing ways and contents is merely for example and is not intended to limit the scope of the present disclosure.

Take an actual scenario as an example; when a user is in an unfamiliar environment, he or she may want to know surrounding public transportations quickly and accurately. According to the present disclosure, the location of the user may be obtained. The nearest station to the location of the user may be determined by searching the preset station locations. One or more public transportation travel routes passing through the nearest station may be pushed to the user. Since the one or more public transportation travel routes may be determined based on the nearest station to the location of the user. The determined one or more public transportation travel routes may reflect public transportation conditions around the user reliably. Thus, the user may quickly determine which public transportation travel routes are currently available.

In some embodiments, the area range around the user may be determined, and the area may be planned based on the location of the user. For example, an area within a range away from the user may be determined as a nearby area of the user, which may be used to determine one or more public transportation travel routes. In some embodiments, the processing device 112 may determine an area covered by a circle whose radius is preset and center is the location of the user. The processing device 112 may designate the area enclosed by the circle as a nearby area of the user. Correspondingly, in 102, the processing device 112 may determine, from the preset station locations, the station closest to the location of the user and within the nearby area of the user as the first station based on the location of the user. The radius may be set according to actual needs of the user. For example, if a user wants to take a public transportation (e.g., a bus) within a range of 50 meters, the radius may be set to 50 meters. According to the present disclosure, it is possible to quickly and easily determine the nearby area of the user, and further determine the public transportation travel routes near the user. In some embodiments, the distance from the location of the user to the station may be used to determine the public transportation travel route. The user can quickly know the surrounding public transportation conditions and conveniently take a travel by public transportations (or buses).

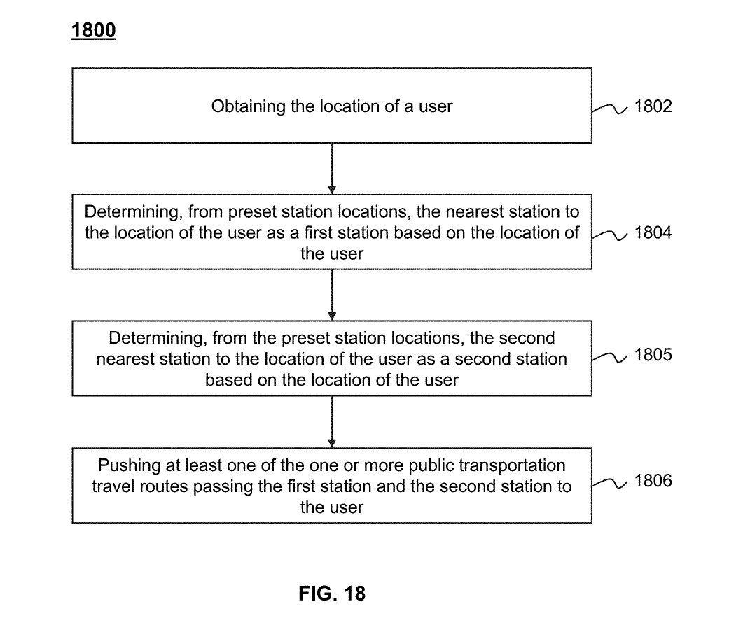

FIG. 18 is a flowchart illustrating an exemplary process 1800 for public transportation travel route pushing according to some embodiments of the present disclosure. In some embodiments, process 1800 may be implemented in the route planning system 100. For example, process 1800 may be stored in the storage device 160 and/or the storage (e.g., the ROM 230, the RAM 240, etc.) as the form of instructions, and invoked and/or executed by the server 110 (e.g., the processing device 112 in the server 110, or the processor 220 of the processing device 112 in the server 110). Operation 1802 and operation 1804 may be described in connection with operation 1702 and operation 1704 respectively in FIG. 17.

In 1805, the processing device 112 may determine, from the preset station locations, the second nearest station to the location of the user as a second station based on the location of the user.

In 1806, the processing device 112 may push at least one of the one or more public transportation travel routes passing through the first station and the second station to the user.

Take a scenario as an example; when the user wants to know the surrounding public transportation conditions, the location of the user may be first obtained. The nearest station and the second nearest station to the location of the user may be determined by searching for station locations. One or more public transportation travel routes passing the nearest station and the second nearest station may then be pushed to the user.

In some embodiments, not only the nearest station to the location of the user but also the second nearest station to the location of the user may be considered for determining one or more public transportation travel routes. One or more public transportation travel routes passing through the nearest station and the second nearest station may be pushed to the user. Thus, the user may know the surrounding public transportation conditions based on the information pushed to him or her.

In practical applications, in order to allow the user to arrange his/her travel more conveniently, the one or more public transportation travel routes pushed to the user may be ranked based on distances from the current location of a public transportation corresponding to each of the one or more public transportation travel routes to the user.

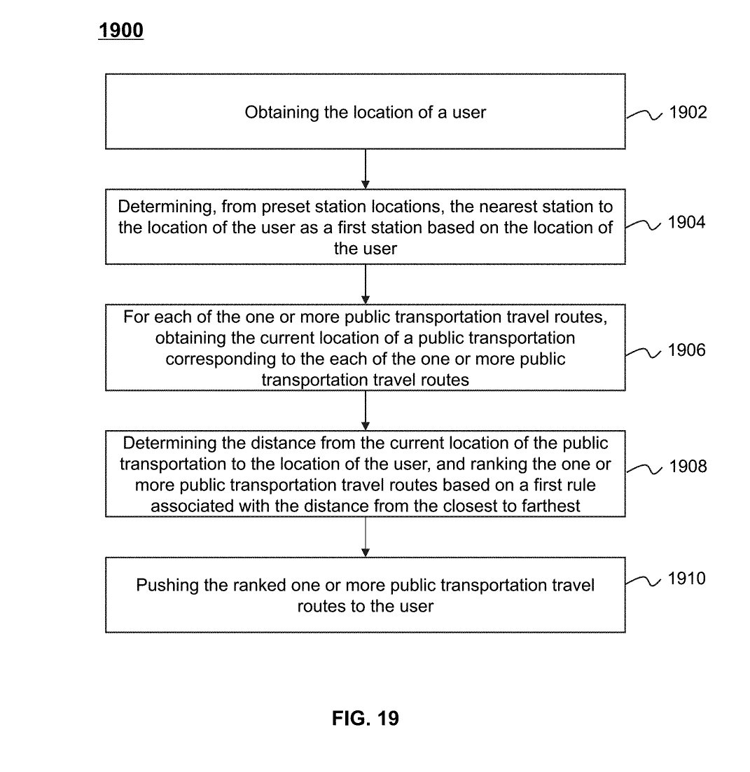

FIG. 19 is a flowchart illustrating an exemplary process 1900 for pushing public transportation travel route according to some embodiments of the present disclosure. In some embodiments, process 1900 may be implemented in the route planning system 100. For example, process 1900 may be stored in the storage device 160 and/or the storage (e.g., the ROM 230, the RAM 240, etc.) as the form of instructions, and invoked and/or executed by the server 110 (e.g., the processing device 112 in the server 110, or the processor 220 of the processing device 112 in the server 110). Operation 1706 and operation 1806 may be performed according to process 1900. Operation 1902 and operation 1904 may be described in connection with operation 1702 and operation 1704 respectively in FIG. 17.

In 1906, the processing device 112 may, for each of the one or more public transportation travel routes, obtain the current location of a public transportation corresponding to the each of the one or more public transportation travel routes.

In 1908, the processing device 112 may determine the distance from the current location of the public transportation to the location of the user. The processing device 112 may rank the one or more public transportation travel routes based on a first rule associated with the distance from the closest to farthest.

In 1910, the processing device 112 may push the ranked one or more public transportation travel routes to the user.

Specifically, the location of the user may be firstly obtained, and the nearest station and the second nearest station to the location of the user may be determined by searching for station locations. One or more public transportation travel routes passing the nearest station and the second nearest station may be then pushed to the user. Further, the distance from the current location of the public transportation to the location of the user may be determined. The one or more public transportation travel routes may be ranked based on a first rule associated with the distance from the closest to farthest. The ranked one or more public transportation travel routes may be pushed to the user. The public transportation corresponding to each of the one or more public transportation travel routes may include a public transportation that is traveling according to the each of the one or more public transportation travel routes. The distance from the current location of the public transportation to the location of the user may be used to determine whether the public transportation is arriving at the nearest station or the second nearest station.

For example, the current coordinates of the user may be (0, 0). Station s1 with coordinates (2, 1), station s2 with coordinates (0, 1), and a station s3 with coordinates (3, 1) may be in a nearby area of the user. The stations s2 and s1 may be determined as the nearest station and the second nearest station, respectively, by searching the station locations. Public transportation travel routes passing the stations s2 and s1 may include a No. 1 bus route, a No. 104 bus route, and a No. 106 bus route. The current location of the No. 1 bus may be (2, 2), the current location of the No. 104 bus may be (2, 3), and the current location of the No. 106 bus may be (4, 3) according to position data of each public transportation. Thus, a list of the public transportation travel routes ranked based on a rule associated with the distance from nearest to farthest may be No. 1 bus route, No. 104 bus route, and No. 106 bus route.

Further, in operation, the user may be familiar with the public transportation travel routes that he or she usually takes. Thus, the user may only want to determine whether there is a nearby public transportation travel route that he or she wants to take. In order to improve the pertinence and efficiency of pushing public transportation travel routes, the user may enter an initial number of a public transportation corresponding to the at least one of the one or more public transportation travel routes in a search box. All public transportation travel routes near the user which begin with the initial number may be searched for and pushed to the user. For example, an initial number of No. 84 bus route is 8, and an initial number of No. 21 bus route is 2.

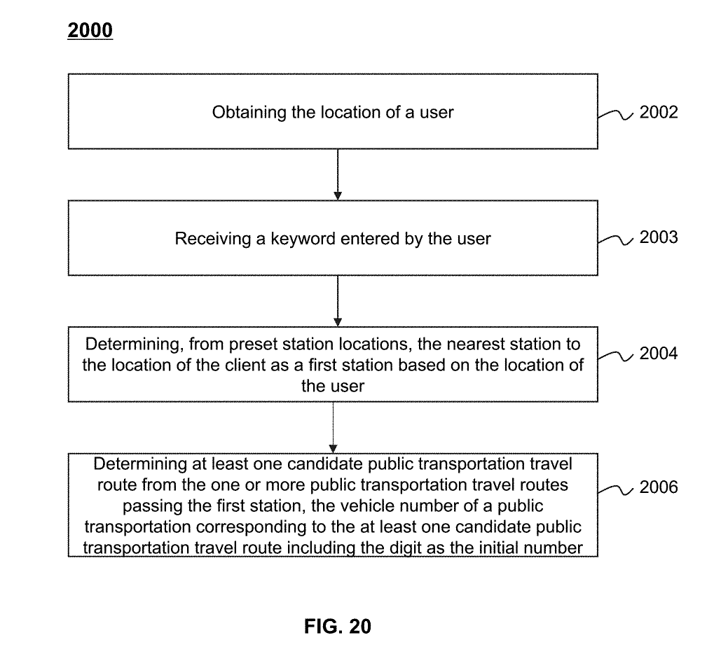

FIG. 20 is a flowchart illustrating an exemplary process 2000 for pushing a public transportation travel route according to some embodiments of the present disclosure. In some embodiments, process 2000 may be implemented in the route planning system 100. For example, process 2000 may be stored in the storage device 160 and/or the storage (e.g., the ROM 230, the RAM 240, etc.) as the form of instructions, and invoked and/or executed by the server 110 (e.g., the processing device 112 in the server 110, or the processor 220 of the processing device 112 in the server 110).

In 2003, the processing device 112 may receive a keyword entered by the user.

In 2006, the processing device 112 may determine at least one candidate public transportation travel route from the one or more public transportation travel routes passing the first station. The vehicle number of a public transportation corresponding to the least one candidate public transportation travel route may include the digit as an initial number. The vehicle number of a public transportation may be used to denote a route of the public transportation. For example, a bus may pass the Peony Garden West Station, the Tower Yard South Station, . . . , Jimen Bridge South Station, . . . , etc. The vehicle number of the bus passing the Peony Garden West Station, the Tower Yard South Station, . . . , Jimen Bridge South Station, . . . , etc., is 84. Then the route passing the Peony Garden West Station, the Tower Yard South Station, . . . , Jimen Bridge South Station, . . . , etc., may also be denoted as No. 84 bus route.

In addition, the user may also not enter anything in the search box, and public transportation travel routes near the user may be searched for default. In some embodiments, if the user roughly knows which public transportation travel route he or she needs to take, but does not specifically remember which route it is or whether it is possible to take the route nearby, then the user can enter an initial number of a public transportation corresponding to a public transportation travel route which he or she wants to take. For example, the user remembers that the initial number associated with the public transportation travel route is 1, then the user can enter 1 in the search box. Correspondingly, nearby public transportation travel routes with an initial number 1 may be determined by searching the data of the public transportation travel routes. The public transportation travel routes may be then pushed to the user.

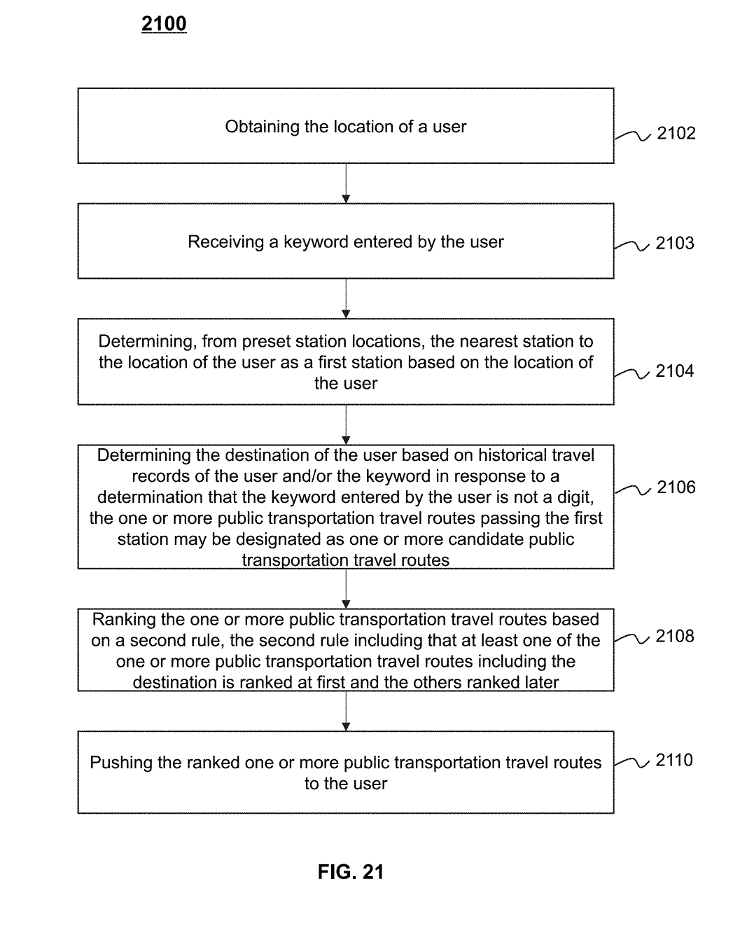

FIG. 21 is a flowchart illustrating an exemplary process 2100 for public transportation travel route pushing according to some embodiments of the present disclosure. In some embodiments, process 2100 may be implemented in the route planning system 100. For example, process 2100 may be stored in the storage device 160 and/or the storage (e.g., the ROM 230, the RAM 240, etc.) as the form of instructions, and invoked and/or executed by the server 110 (e.g., the processing device 112 in the server 110, or the processor 220 of the processing device 112 in the server 110). Operation 2102 to operation 2104 may be described in connection with operation 2002 to operation 2004 in FIG. 20 respectively.

In 2106, the processing device 112 may determine the destination of the user based on historical travel records of the user and/or the keyword in response to a determination that the keyword entered by a user is not a digit. The one or more public transportation travel routes passing the first station may be designated as one or more candidate public transportation travel routes.

In 2108, the processing device 112 may rank, based on a second rule, the one or more public transportation travel routes. The second rule may include that at least one of the one or more public transportation travel routes including the destination is ranked at first and the others ranked later.

In 2110, the processing device 112 may push the ranked one or more public transportation travel routes to the user.

Specifically, if the keyword entered by the user is not a digit, a content that the user wants to enter may be predicted before the user completes the input. Public transportation travel routes associated with the predicted content may be pushed based on the predicted content. In some embodiments, if the processing device 112 detects that the keyword is not a digit, the processing device 112 may determine the destination of the user based on historical travel records of the user and/or the keyword. The one or more public transportation travel routes may be ranked based on the second rule. The second rule may include that at least one of the one or more public transportation travel routes, which may include the destination, is ranked at first and the others ranked later. The ranked one or more public transportation travel routes to the user may be pushed to the user. For example, if a portion of the public transportation travel routes pass the predicted destination, the portion of the public transportation travel routes may be ranked forward, which may achieve more accurate and reliable public transportation travel route pushing.

It should be noted that the above implementations may be implemented separately or in combination.

According to the process for public transportation travel route pushing provided by the embodiments, the current location of a user may be obtained. The nearest station to the location of the user may be determined by searching station locations of each of the public transportation travel routes. One or more public transportation travel routes passing the nearest station may be pushed to the user. Therefore, the user can accurately and quickly know which public transportation travel routes are currently available, and quickly know the surrounding public transportation conditions, which may facilitate travel route planning of the user.

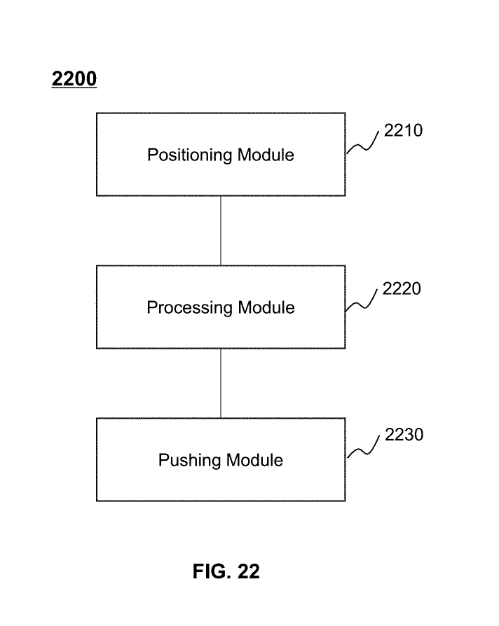

FIG. 22 is a block diagram illustrating an exemplary device 2200 for public transportation travel route pushing based on the location of a user according to some embodiments of the present disclosure. The device 2200 for public transportation travel route pushing may include a positioning module 2210, a processing module 2220 and a pushing module 2230. The modules of the device 2200 may be hardware circuits of at least part of the processing device 112. The modules may also be implemented as an application or set of instructions read and executed by the processing device 112. Further, the modules may be any combination of the hardware circuits and the application/instructions. For example, the modules may be the part of the processing device 112 when the processing device 112 is executing the application or set of instructions.

The positioning module 2210 may be configured to obtain the location of a user.

The processing module 2220 may be configured to determine, from preset station locations, the nearest station to the location of the user as a first station based on the location of the user.

The pushing module 2230 may be configured to push one or more public transportation travel routes passing the first station to the user.

In some embodiments, a user may usually carry a mobile terminal with him or her, and the mobile terminal of the user may be located using a positioning technology such as GPS technology. A current geographic location of the user may be obtained. The preset station locations may include geographic location coordinates of the preset station locations. In some embodiments, the preset station locations may be pre-stored in a server (e.g., the server 110). In some embodiments, a device for public transportation travel route pushing based on the location of the user may be independent or integrated into another device such as a smartphone, a computer, and a server.

Take a scenario as an example; the positioning module 2210 may obtain the location of a user. The processing module 2220 may determine the nearest station to the location of the user by searching the preset station locations. The pushing module 2230 may push one or more public transportation travel routes passing through the nearest station to the user. Since the one or more public transportation travel routes may be determined based on the nearest station to the location of the user. The determined one or more public transportation travel routes may reflect public transportation conditions around the user reliably.

In some embodiments, the device 2200 may also include an area module. The area module may be configured to designate an area covered by a circle whose radius is preset, and center is the location of the user as a nearby area of the user. Correspondingly, the processing module 2220 may be configured to determine, from the preset station locations, the station closest to the location of the user and within the nearby area of the user as the first station based on the location of the user.

According to the present disclosure, it is possible to quickly and easily determine the nearby area of the user, and further determine the public transportation travel routes near the user. In some embodiments, the distance from the location of the user to the station may be used to determine the public transportation travel route. The user can quickly know the surrounding public transportation conditions and conveniently take a travel by public transportations (or buses).

In some embodiments, to make the user understand the surrounding public transportation conditions more comprehensively and based on any embodiments described above, the processing module 2220 may be configured to determine, from the preset station locations, the second nearest station to the location of the user as a second station based on the location of the user. Correspondingly, the pushing module 2230 may be configured to push at least one of the one or more public transportation travel routes passing through the first station and the second station to the user.

Take a scenario as an example; when the user wants to know the surrounding public transportation conditions, the positioning module 2210 may obtain the location of the user first. The processing module 2220 may determine the nearest station and the second nearest station to the location of the user by searching for the preset station locations. The pushing module 2230 may push one or more public transportation travel routes passing the nearest station and the second nearest station to the user.

In some embodiments, not only the nearest station to the location of the user but also the second nearest station to the location of the user may be considered for determining one or more public transportation travel routes. One or more public transportation travel routes passing through the nearest station and the second nearest station may be pushed to the user. Thus, the user may know the surrounding public transportation conditions based on the information pushed to him or her.

In practical applications, in order to allow the user to arrange his/her travel more conveniently, the one or more public transportation travel routes pushed to the user may be ranked based on distances from the current location of a public transportation corresponding to each of the one or more public transportation travel routes to the user.

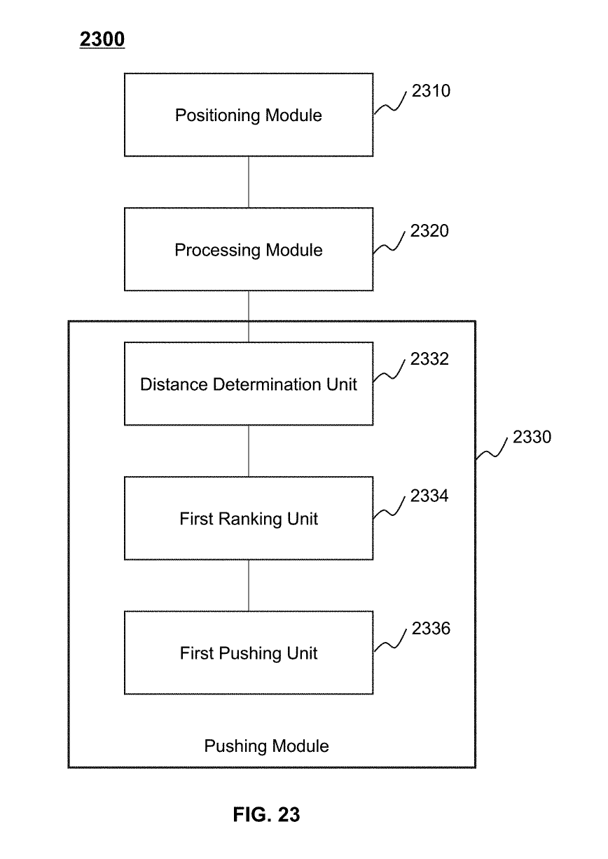

FIG. 23 is a block diagram illustrating an exemplary device 2300 for public transportation travel route pushing based on the location of a user according to some embodiments of the present disclosure. The device 2300 for public transportation travel route pushing may include a positioning module 2310, a processing module 2320 and a pushing module 2330. The modules of the device 2300 may be hardware circuits of at least part of the processing device 112. The modules may also be implemented as an application or set of instructions read and executed by the processing device 112. Further, the modules may be any combination of the hardware circuits and the application/instructions. For example, the modules may be the part of the processing device 112 when the processing device 112 is executing the application or set of instructions.

In some embodiments, the pushing module 2330 may include a distance determination unit 2332, a first ranking unit 2334 and a first pushing module 2336. The distance determination unit 2332 may be configured to, for each of the one or more public transportation travel routes, obtain the current location of a public transportation corresponding to the each of the one or more public transportation travel routes.

The first ranking unit 2334 may be configured to determine the distance from the current location of the public transportation to the location of the user and rank the one or more public transportation travel routes based on a first rule associated with the distance from the closest to farthest.

The first pushing module 2336 may be configured to push the ranked one or more public transportation travel routes to the user.

In some embodiments, the positioning module 2310 may obtain the location of the user. The processing module 2320 may determine the nearest station and the second nearest station to the location of the user by searching for the preset station locations. One or more public transportation travel routes passing the nearest station and the second nearest station may be then pushed to the user. Further, the distance determination unit 2332 may determine the distance from the current location of the public transportation to the location of the user. The first ranking unit 2334 may rank the one or more public transportation travel routes based on a first rule associated with the distance from the closest to farthest. The first pushing module 2336 may push the ranked one or more public transportation travel routes to the user.

Further, in operation, the user may be familiar with the public transportation travel routes that he or she usually takes. Thus, the user may only want to determine whether there is a nearby public transportation travel route that he or she wants to take. In order to improve the pertinence and efficiency of pushing public transportation travel routes, the user may enter an initial number of a public transportation corresponding to the at least one of the one or more public transportation travel routes in a search box.

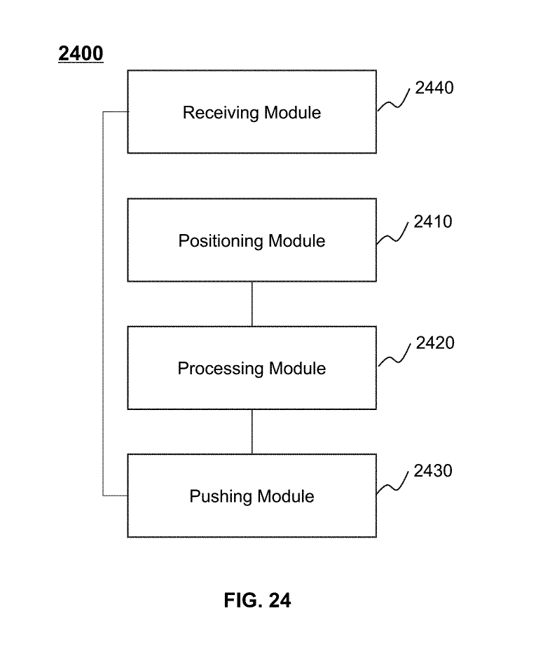

FIG. 24 is a block diagram illustrating an exemplary device 2400 for public transportation travel route pushing based on the location of a user according to some embodiments of the present disclosure. The device 2400 for public transportation travel route pushing may include a positioning module 2410, a processing module 2420, a pushing module 2430, and a receiving module 2440. The modules of the device 2400 may be hardware circuits of at least part of the processing device 112. The modules may also be implemented as an application or set of instructions read and executed by the processing device 112. Further, the modules may be any combination of the hardware circuits and the application/instructions. For example, the modules may be the part of the processing device 112 when the processing device 112 is executing the application or set of instructions.

In some embodiments, the receiving module 2440 may be configured to receive a keyword entered by the user.

The pushing module 2430 may be configured to determine at least one candidate public transportation travel route from the one or more public transportation travel routes passing the first station. The vehicle number of a public transportation corresponding to the least one candidate public transportation travel route may include the digit as an initial number. The vehicle number of a public transportation may be used to denote a route of the public transportation. For example, a bus may pass the Peony Garden West Station, the Tower Yard South Station, . . . , Jimen Bridge South Station, . . . , etc. The vehicle number of the bus passing the Peony Garden West Station, the Tower Yard South Station, . . . , Jimen Bridge South Station, . . . , etc., is 84. Then the route passing the Peony Garden West Station, the Tower Yard South Station, . . . , Jimen Bridge South Station, . . . , etc., may also be denoted as No. 84 bus route.

In addition, the user may also not enter anything in the search box, and public transportation travel routes near the user may be searched for default. In some embodiments, if the user roughly knows which public transportation travel route he or she needs to take, but does not specifically remember which route it is or whether it is possible to take the route nearby, then the user can enter an initial number of a public transportation corresponding to a public transportation travel route which he or she wants to take. For example, the user remembers that the initial number associated with the public transportation travel route is 1, then the user can enter 1 in the search box. Correspondingly, nearby public transportation travel routes with an initial number 1 may be determined by searching the data of the public transportation travel routes. The public transportation travel routes may be then pushed to the user.

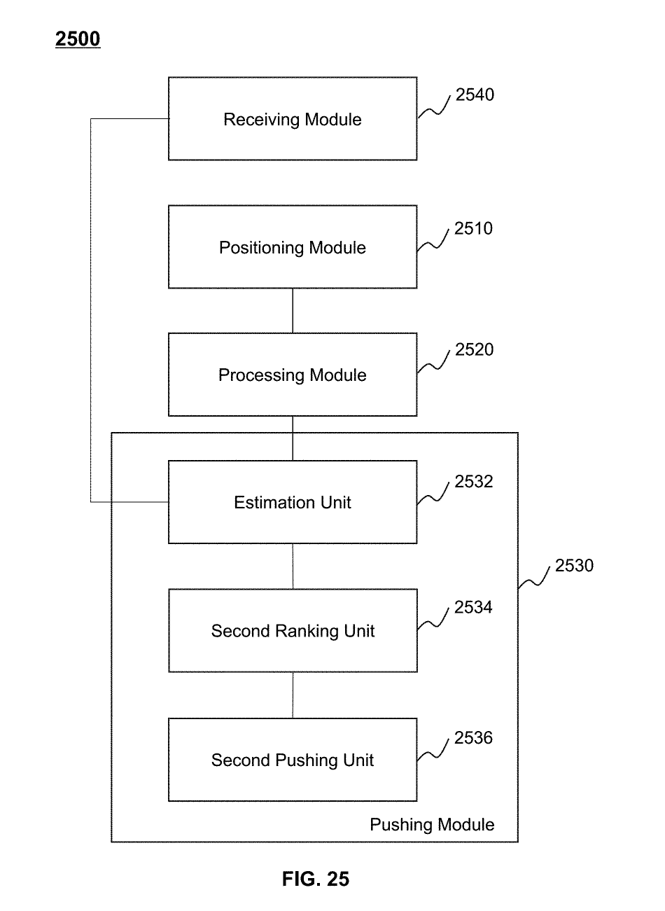

FIG. 25 is a block diagram illustrating an exemplary device 2500 for public transportation travel route pushing based on the location of a user according to some embodiments of the present disclosure. The device 2500 for public transportation travel route pushing may include a positioning module 2510, a processing module 2520, a pushing module 2530, and a receiving module 2540. The modules of the device 2500 may be hardware circuits of at least part of the processing device 112. The modules may also be implemented as an application or set of instructions read and executed by the processing device 112. Further, the modules may be any combination of the hardware circuits and the application/instructions. For example, the modules may be the part of the processing device 112 when the processing device 112 is executing the application or set of instructions.

The pushing module 2530 may include an estimation unit 2532, a second ranking unit 2534, and a second pushing unit 2536. The estimation unit 2532 may be configured to determine the destination of the user based on historical travel records of the user and/or the keyword in response to a determination that the keyword entered by a user is not a digit. The one or more public transportation travel routes passing the first station may be designated as one or more candidate public transportation travel routes.

The second ranking unit 2534 may be configured to rank, based on a second rule, the one or more public transportation travel routes. The second rule may include that at least one of the one or more public transportation travel routes including the destination is ranked at first and the others ranked later.

The second pushing unit 2536 may be configured to push the ranked one or more public transportation travel routes to the user.

Specifically, if the keyword entered by the user is not a digit, the estimation unit 2532 may predict a content that the user wants to enter before the user completes the input and push public transportation travel routes associated with the predicted content based on the predicted content. In some embodiments, if the estimation unit 2532 detects that the keyword is not a digit, the estimation unit 2532 may determine the destination of the user based on historical travel records of the user and/or the keyword. The second ranking unit 2534 may rank one or more public transportation travel routes based on the second rule. The second rule may include that at least one of the one or more public transportation travel routes, which may include the destination, is ranked at first and the others ranked later. The second pushing unit 2536 may push the ranked one or more public transportation travel routes to the user. For example, if a portion of the public transportation travel routes pass the predicted destination, the portion of the public transportation travel routes may be ranked forward, which may achieve more accurate and reliable public transportation travel route pushing.

It should be noted that the above implementations may be implemented separately or in combination.

According to the device for public transportation travel route pushing provided by the embodiments, the current location of a user may be obtained. The nearest station to the location of the user may be determined by searching station locations of each of the public transportation travel routes. One or more public transportation travel routes passing the nearest station may be pushed to the user. Therefore, the user can accurately and quickly know which public transportation travel routes are currently available, and quickly know the surrounding public transportation conditions, which may facilitate travel route planning of the user.

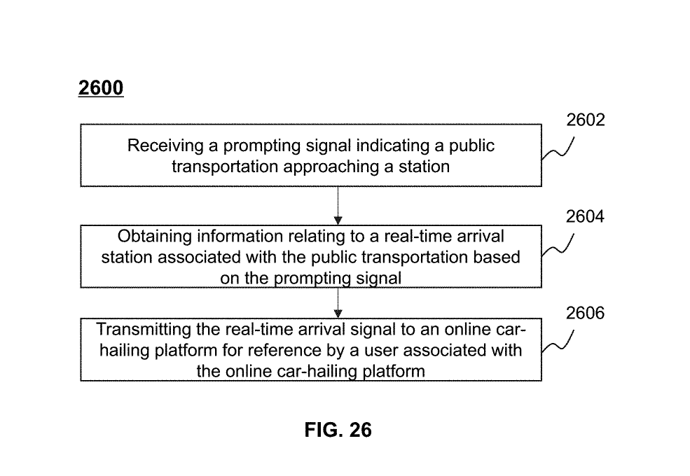

FIG. 26 is a flowchart illustrating an exemplary process 2600 for transmitting information according to some embodiments of the present disclosure. In some embodiments, process 2600 may be implemented in the route planning system 100. For example, process 2600 may be stored in the storage device 160 and/or the storage (e.g., the ROM 230, the RAM 240, etc.) as the form of instructions, and invoked and/or executed by the server 110 (e.g., the processing device 112 in the server 110, or the processor 220 of the processing device 112 in the server 110).

In 2602, the processing device 112 may receive a prompting signal indicating a public transportation approaching a station.

In 2604, the processing device 112 may obtain information relating to a real-time arrival station associated with the public transportation based on the prompting signal.

In 2606, the processing device 112 may transmit the information relating to a real-time arrival station to an online taxi-hailing platform (i.e., a client terminal) for reference by a user associated with the online taxi-hailing platform.

In some embodiments, the information relating to the real-time arrival station of the public transportation may be obtained when the public transportation arrives at the station, which may effectively ensure the timeliness, validity, and accuracy of the information relating to the real-time arrival station of the public transportation, and avoid the problem of untimely access to the information relating to the real-time arrival station of the public transportation caused by periodic transmission of GPS signals. The obtained information relating to the real-time arrival station may be transmitted to the online taxi-hailing platform for reference by the user, which may ensure the accuracy and instantaneity of user-obtained information. Thus, the user experience may be improved.

In some embodiments, the obtained the information relating to the real-time arrival station may be transmitted to the online taxi-hailing platform via a wireless transmission such as WIFI or cellular signal.

In some embodiments, the prompting signal may be generated when a door-open button of the public transportation is triggered. In some embodiments, the prompting signal may be generated when an arrival prompting button of the public transportation is triggered.

In some embodiments, in order to ensure the accuracy of the information relating to the real-time arrival station of the public transportation, the processing device 112 may obtain the information relating to the real-time arrival station of the public transportation when the door-open button of the public transportation is pressed. In some embodiments, the processing device 112 may obtain the information relating to the real-time arrival station of the public transportation when the arrival prompting button of the public transportation is pressed. It should be noted that, in order to improve the user experience, the above two ways may be selected according to actual situations.

In some embodiments, the information relating to the real-time arrival station may include an arriving station of the public transportation, the vehicle number of the public transportation, the driving direction of the public transportation, and the current location of the public transportation.

In some embodiments, in order to ensure that the online taxi-hailing platform can perform effective analysis based on the information relating to the real-time arrival station of the public transportation, and provide the user with more various and real-time information of the public transportation. The information relating to the real-time arrival station may include at least one of the arriving station of the public transportation when the information relating to the real-time arrival station is transmitted, the vehicle number of the public transportation, the driving direction (upstream or downstream) of the public transportation, or the current location of the public transportation (i.e., position coordinates of the current station the public transportation arriving at). A public transportation control system may achieve effective monitor of each public transportation based on the information relating to the real-time arrival station of the public transportation.

In some embodiments, after receiving the information relating to the real-time arrival station of the public transportation, the online taxi-hailing platform may predict a time point that the public transportation will arrive at the next station by combining with big data included in the online taxi-hailing platform. Therefore, the online taxi-hailing platform may present the user with the arrival time of different public transportations, predict a time\when the public transportation will arrive at the next station, and recommend optimal travel routes to the user for selection based on the above information, which may improve the travel experience of the user.

In some embodiments, the processing device 112 may determine a time point when the public transportation will arrive at the next station based on the driving information of contracted vehicles of the online taxi-hailing platform. For example, the processing device 112 may pre-collect the driving information of the contracted vehicles from the arrival station of the public transportation to the next station in the historical routes. According to the collected information, statistics, and analysis of the historical driving information of the contracted vehicles, the driving information of a vehicle whose travel route is overlapping with the public transportation may be used to determine the arrival time of a public transportation. By analysis and summarization of a large number of empirical data, the accuracy and reliability of the obtained information relating to the arrival time may be ensured, the value of the data stored in the data service platform (e.g., the server 110) of the online taxi-hailing platform may be improved, and the practicality of the online car-hailing application may be improved.

In some embodiments, the information relating to an arrival time of a public transportation arriving at a target station (e.g., the next station) may be determined based on the driving information of the contracted vehicles of the online taxi-hailing platform. For example, the processing device 112 may determine the information relating to the arrival time of the public transportation based on the driving speed and driving distance in the driving information. The driving speed may be the average value of a large number of the historical driving speeds. As another example, the processing device 112 may determine the information relating to the arrival time of the public transportation based on the travel time of the contracted vehicles of the online taxi-hailing platform passing through the route corresponding to the current station and the target station. The travel time may be the average value of a large number of the historical travel time.

Therefore, the user may not need to install too many applications, such as other car-hailing applications, a public transportation inquiry application, etc. In addition, a travel route and the arrival time of the public transportation may be pushed to a user according to the obtained real-time location of the public transportation, which may help the user to schedule a travel plan. The arrival time of the public transportation arriving a station may help the public transportation company to monitor the public transportation. In some embodiments, whether an interzonal vehicle is needed may be determined based on the time when the public transportation arrives at each station.

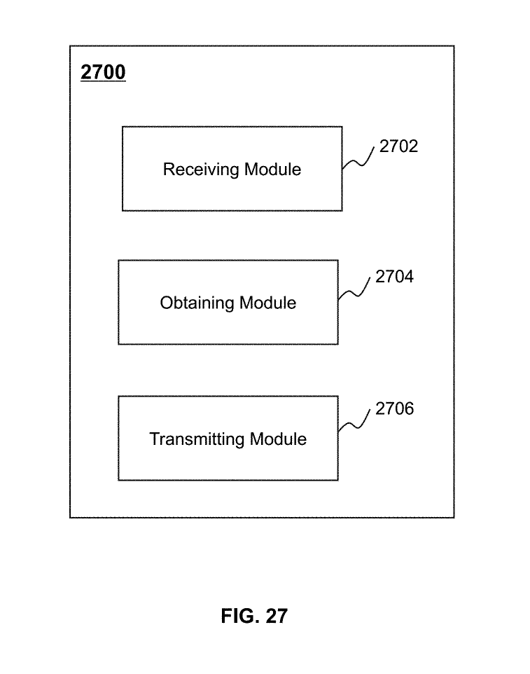

FIG. 27 is a schematic diagram illustrating an exemplary device 2700 for transmitting information according to an embodiment of the present disclosure. As shown in FIG. 27, the device 2700 may include a receiving module 2702, an obtaining module 2704, and a transmitting module 2706. The units of the device 2700 may be hardware circuits of at least part of the processing device 112. The units of the device 2700 may also be implemented as an application or set of instructions read and executed by the processing device 112. Further, the units may be any combination of the hardware circuits and the application/instructions. For example, the units of the device 2700 may be the part of the processing device 112 when the processing device 112 is executing the application or set of instructions.

The receiving module 2702 may be configured to receive a prompting signal indicating a public transportation arriving at a station. The obtaining module 2704 may be configured to obtain information relating to a real-time arrival station associated with the public transportation based on the prompting signal received by the receiving module 2702. The transmitting module 2706 may be configured to transmit the information relating to the real-time arrival station obtained by the obtaining module 2704 to an online taxi-hailing platform (e.g., a client terminal) for reference by a user associated with the online taxi-hailing platform.

In some embodiments, the information relating to the real-time arrival station of the public transportation may be obtained when the public transportation arrives at the station, which may effectively ensure the timeliness, validity, and accuracy of the information relating to the real-time arrival station of the public transportation, and avoid the problem of untimely access to the information relating to the real-time arrival station of the public transportation caused by periodic transmission of GPS signals. The obtained information relating to the real-time arrival station may be transmitted to the online taxi-hailing platform for reference by the user, which may ensure the accuracy and instantaneity of user-obtained information. Thus, the user experience may be improved.

In some embodiments, the obtained information relating to the real-time arrival station can be transmitted to the online taxi-hailing platform via a wireless transmission such as WIFI or cellular signal.

In some embodiments, the prompting signal may be generated when a door-open button of the public transportation is triggered. In some embodiments, the prompting signal may be generated when an arrival prompting button of the public transportation is triggered.

In some embodiments, in order to ensure the accuracy of the information relating to the real-time arrival station of the public transportation, the obtaining module 2704 may obtain the information relating to the real-time arrival station of the public transportation when the door-open button of the public transportation is pressed. In some embodiments, the obtaining module 2704 may obtain the information relating to the real-time arrival station of the public transportation when the arrival prompting button of the public transportation is pressed. It should be noted that, in order to improve the user experience, the above two ways may be selected according to the actual situations.

In some embodiments, the information relating to the real-time arrival station may include an arrival station of the public transportation, the vehicle number of the public transportation, the driving direction of the public transportation, and the current location of the public transportation.

In some embodiments, in order to ensure that the online taxi-hailing platform can perform effective analysis based on the information relating to the real-time arrival station of the public transportation, and provide the user with more various and real-time information of the public transportation. The information relating to the real-time arrival station may include at least one of the arrival station of the public transportation when the information relating to the real-time arrival station is transmitted, the vehicle number of the public transportation, the driving direction (upstream or downstream) of the public transportation, or the current location of the public transportation (i.e., position coordinates of the current station the public transportation arriving at). A public transportation control system may achieve effective monitor of each public transportation based on the information relating to the real-time arrival station of the public transportation.

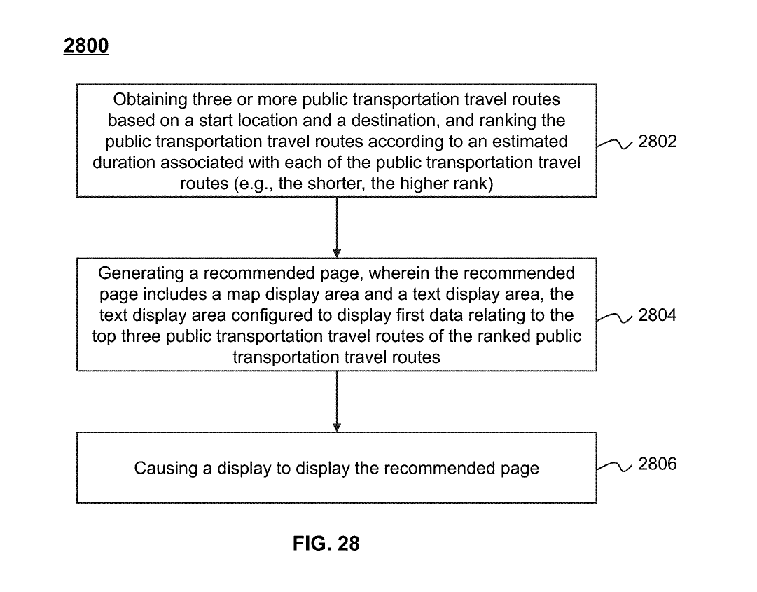

FIG. 28 is a flowchart illustrating an exemplary process 2800 for display according to some embodiments of the present disclosure. In some embodiments, process 2800 may be implemented in the route planning system 100. For example, process 2800 may be stored in the storage device 160 and/or the storage (e.g., the ROM 230, the RAM 240, etc.) as the form of instructions, and invoked and/or executed by the server 110 (e.g., the processing device 112 in the server 110, or the processor 220 of the processing device 112 in the server 110).

In 2802, the processing device 112 may obtain three or more public transportation travel routes based on a start location and a destination of a service request. The processing device 112 may rank the public transportation travel routes according to an estimated duration associated with each of the public transportation travel routes (e.g., the shorter, the higher rank).

In 2804, the processing device 112 may generate a recommended page. In some embodiments, the recommended page may include a map display area and a text display area. The text display area may be configured to display first data relating to top three public transportation travel routes of the ranked public transportation travel routes. The first data may include a vehicle number of a public transportation corresponding to each of the top three public transportation travel routes and an estimated duration associated with each of the top three public transportation travel routes.

In 2806, the processing device 112 may cause a display to display the recommended page.

In some embodiments, the map display area and the text display area may be separated from each other on the recommended page. A plurality of public transportation travel routes may be displayed on a map, which may facilitate the comparison of the plurality of public transportation travel routes based on the map. The recommended result may be visual, and the user experience may be improved. Further, according to statistical analysis of big data, the satisfaction rate of the top (e.g., three) public transportation travel routes may over 80%, which may basically meet the need of users. Limiting the display of the top three public transportation travel routes instead of displaying all public transportation travel routes may help to control the space of the text display area when there are many public transportation travel routes available. Other public transportation travel routes with lower adoption rates may not be shown, which may make the full use of the space of the recommended page to ensure sufficient map display area. In some embodiments, the start location and the destination entered by a user may be displayed in the map display area. In some embodiments, the three public transportation travel routes may be displayed in the map display area. Further, the first data relating to the top three public transportation travel routes may include a vehicle number of a public transportation corresponding to each of the top three public transportation travel routes and an estimated duration associated with each of the top three public transportation travel routes. When the transfer is involved in a public transportation travel route, the vehicle number may refer to vehicle numbers of public transportations corresponding to the public transportation travel route that are taken successively, so that different public transportation travel routes can be clearly distinguished. The estimated duration may refer to a duration spent by the user from the start location to the destination when using the corresponding public transportation travel route, which may generally be a primary reference for the user when selecting a public transportation travel route. The first data including the vehicle number and the estimated duration may help the user to compare different public transportation travel routes and make full use of the text display area with limited space. Thus, the user experience may be improved.

In some embodiments, the text display area may be configured to display the first data relating to the first number of public transportation travel routes in the form of a list. The text display area displaying the public transportation travel routes in the form of the list may help the user to distinguish different public transportation travel routes. Each public transportation travel route may be displayed in the same display form, which may make the display results clearly, and improve the user experience.

In some embodiments, the text display area may share the same edge with the boundary of the recommended page. The text display area sharing the same edge with the boundary of the recommended page may focus the text display area on a bottom of the recommended page and the rest space of the recommended page on an upper part. Thus, the integrity of the map display area may not be influenced by the text display area, which may help to display the map and improve the user experience.

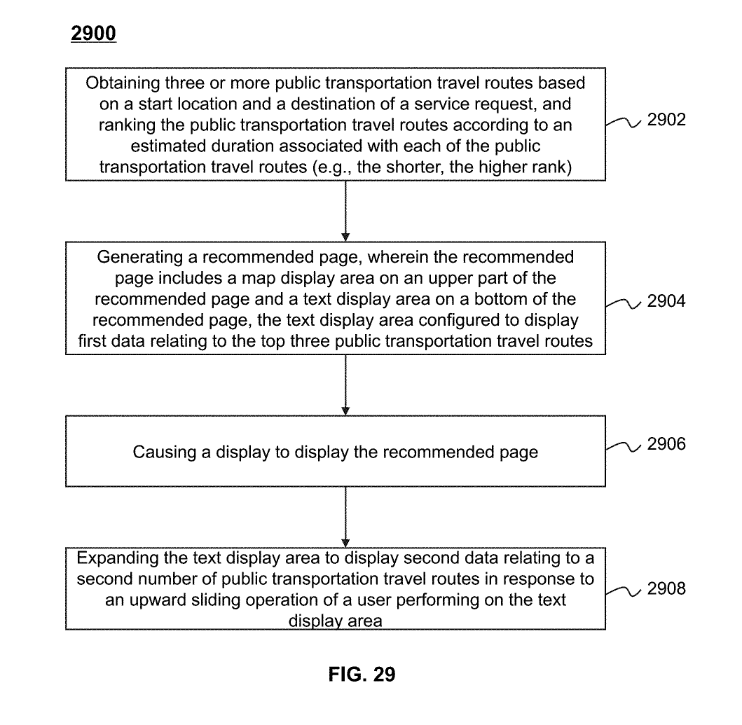

FIG. 29 is a flowchart illustrating an exemplary process 2900 for display a recommended page according to some embodiments of the present disclosure. In some embodiments, process 2900 may be implemented in the route planning system 100. For example, process 2900 may be stored in the storage device 160 and/or the storage (e.g., the ROM 230, the RAM 240, etc.) as the form of instructions, and invoked and/or executed by the server 110 (e.g., the processing device 112 in the server 110, or the processor 220 of the processing device 112 in the server 110).

In 2902, the processing device 112 may obtain a plurality of (e.g., three or more) public transportation travel routes based on a start location and a destination of a service request. The processing device 112 may rank the public transportation travel routes according to an estimated duration associated with each of the public transportation travel routes from short to long.

In 2904, the processing device 112 may generate a recommended page. The recommended page may include a map display area on an upper part of the recommended page and a text display area on a bottom of the recommended page. The text display area may be configured to display first data relating to the top three public transportation travel routes. The first data may include a vehicle number of a public transportation corresponding to each of the top three public transportation travel routes and an estimated duration associated with each of the top three public transportation travel routes.

In 2906, the processing device 112 may cause a display to display the recommended page.

In 2908, the processing device 112 may expand the text display area to display second data relating to a second number of public transportation travel routes in response to an upward sliding operation of a user performing on the text display area.

In some embodiments, more public transportation travel routes may be displayed by expanding the text display area, which can provide the user more options when the default recommended three public transportation travel routes cannot meet the need of the user. Besides, by setting the upward slide operation and using the upward slide operation as a trigger command for expanding the text display area, the slide direction of the user may be consistent with the expansion direction of the text display area, producing an effect of opening the text display area by sliding, which may meet human visual habits and bring friendly operating experience. In some embodiments, after expanding the text display area, the text display area may be shortened to a state of displaying three public transportation travel routes in response to a downward slide operation of the user. In some embodiments, the expanding of the text display area may be achieved by switching to a larger text display area to display all the public transportation travel routes. In some embodiments, the whole text display area may be moved upward, and the un-displayed public transportation travel routes may appear from the bottom of the recommended page. Thus, all the public transportation travel routes may be displayed. In some embodiments, the second number of the public transportation travel routes may include all the public transportation travel routes, which may change with the recommended result. In some embodiments, the second number may be set as a fixed value. In some embodiments, the second number of the displayed public transportation travel routes may be controlled by a sliding distance. The second number may be a variable.

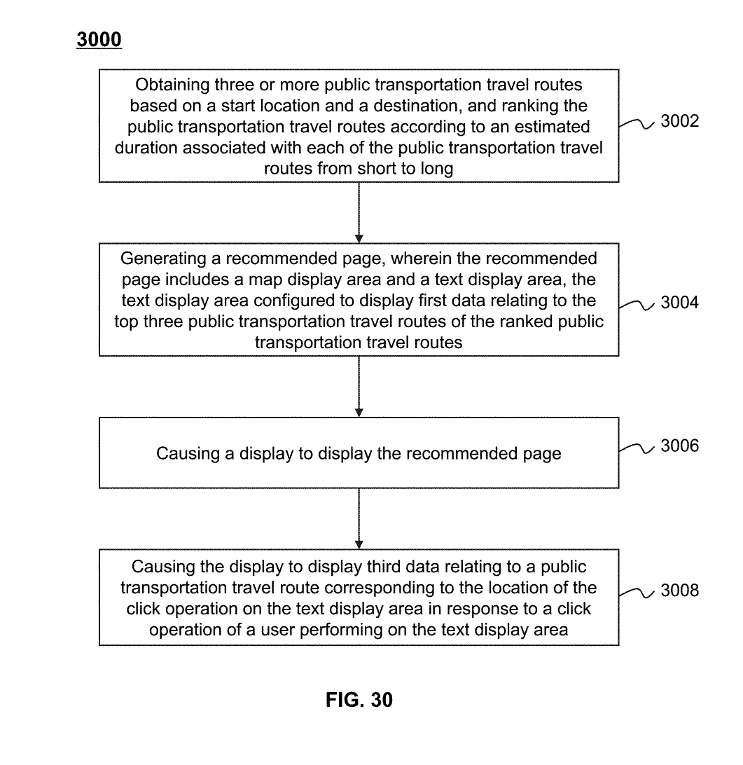

FIG. 30 is a flowchart illustrating an exemplary process 3000 for display a recommended page according to a third embodiment of the present disclosure. In some embodiments, process 3000 may be implemented in the route planning system 100. For example, process 3000 may be stored in the storage device 160 and/or the storage (e.g., the ROM 230, the RAM 240, etc.) as the form of instructions, and invoked and/or executed by the server 110 (e.g., the processing device 112 in the server 110, or the processor 220 of the processing device 112 in the server 110).

In 3002, the processing device 112 may obtain three or more public transportation travel routes based on a start location and a destination. The processing device 112 may rank the public transportation travel routes according to an estimated duration associated with each of the public transportation travel routes from short to long.

In 3004, the processing device 112 may generate a recommended page. The recommended page may include a map display area and a text display area. The text display area may be configured to display first data relating to the top three public transportation travel routes. The first data may include a vehicle number of a public transportation corresponding to each of the top three public transportation travel routes and an estimated duration associated with each of the top three public transportation travel routes.

In 3006, the processing device 112 may cause a display to display the recommended page.

In 3008, the processing device 112 may cause the display to display third data relating to a public transportation travel route corresponding to the location of the click operation on the text display area in response to a click operation of a user performing on the text display area.

In some embodiments, the third data relating to a public transportation travel route may be displayed by clicking one public transportation travel route on the text display area, which may help the user to understand the public transportation travel route to make a decision or instruct the user to take the corresponding public transportation. At the same time, the third data may be still displayed on the text display area, and the map display area may display the corresponding public transportation travel route, which makes the public transportation travel route display more visual.

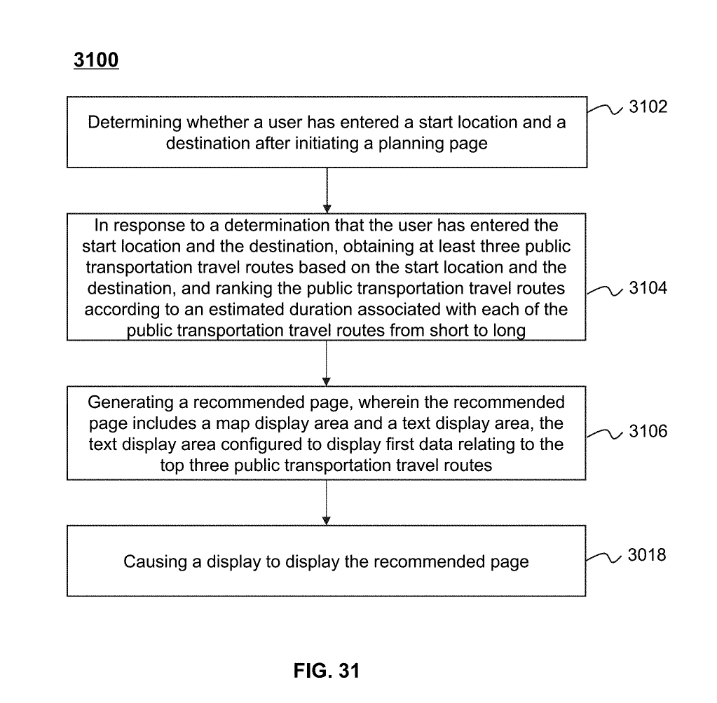

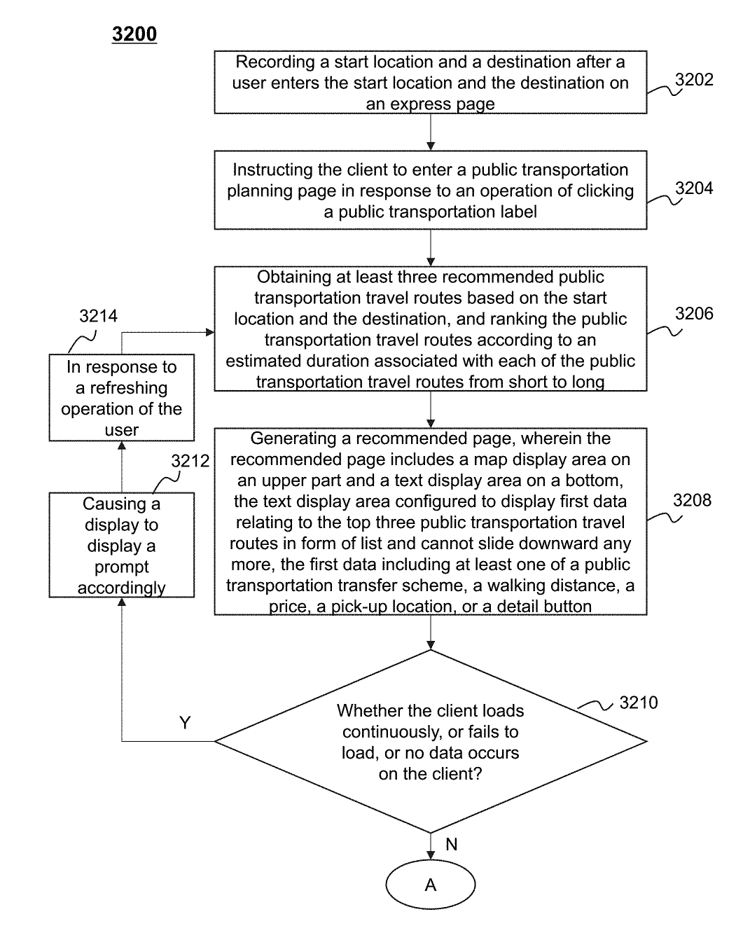

FIG. 31 is a flowchart illustrating an exemplary process 3100 for display according to some embodiments of the present disclosure. In some embodiments, process 3100 may be implemented in the route planning system 100. For example, process 3100 may be stored in the storage device 160 and/or the storage (e.g., the ROM 230, the RAM 240, etc.) as the form of instructions, and invoked and/or executed by the server 110 (e.g., the processing device 112 in the server 110, or the processor 220 of the processing device 112 in the server 110).

In 3102, the processing device 112 may determine whether a user has entered the start location and the destination after initiating a planning page.

In 3104, the processing device 112 may, in response to a determination that the user has entered the start location and the destination, obtain at least three public transportation travel routes based on the start location and the destination. The processing device 112 may rank the public transportation travel routes according to an estimated duration associated with each of the public transportation travel routes from short to long.

In 3106, the processing device 112 may generate a recommended page. The recommended page may include a map display area and a text display area. The text display area may be configured to display first data relating to the top three public transportation travel routes. The first data may include a vehicle number of a public transportation corresponding to each of the top three public transportation travel routes and an estimated duration associated with each of the top three public transportation travel routes.

In 3108, the processing device 112 may cause a display to display the recommended page.

In some embodiments, determining whether the user has entered the start location and the destination before initiating the planning page may cause different pages relating to the route planning to communicate with each other, which may reduce the input number of the user, improve the level of intelligence, and further improve the user experience. Specifically, when process 400 for displaying travel routes is applied to a platform or application relating to the route planning, the travel route such as driving routes, public transportation travel routes, walking routes, etc., may be planned on different pages to meet the different needs of users. For example, when the platform or application is an online taxi-hailing platform, a driving page may be further divided into, for example, a car rental interface, a taxi interface, a special car interface, etc. If no suitable cars are found, the user can turn to the public transportation interface to inquire a public transportation travel route. In the same online taxi-hailing platform, the user may not have to enter the start location and the destination when the interface (or page) is switched.

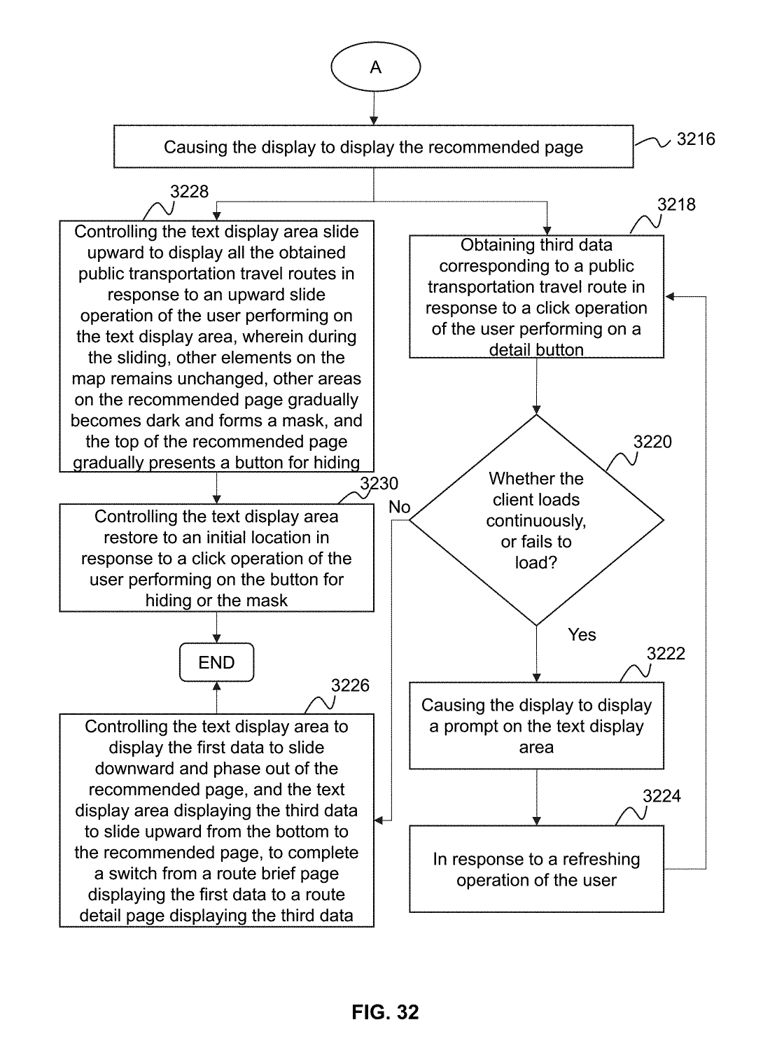

FIG. 32 is a flowchart illustrating an exemplary process 3200 for display according to some embodiments of the present disclosure. The process for display may be used for displaying an interface of an online car-hailing platform. In some embodiments, process 3200 may be implemented in the route planning system 100. For example, process 3200 may be stored in the storage device 160 and/or the storage (e.g., the ROM 230, the RAM 240, etc.) as the form of instructions, and invoked and/or executed by the server 110 (e.g., the processing device 112 in the server 110, or the processor 220 of the processing device 112 in the server 110).

In 3202, the processing device 112 may record the start location and the destination after a user enters a start location and a destination on the page of a type of service (e.g., an express car page).

In 3204, the processing device 112 may instruct the client to enter a public transportation planning page in response to an operation of clicking a public transportation label.

In 3206, the processing device 112 may obtain at least three public transportation travel routes based on a start location and a destination. The processing device 112 may rank the public transportation travel routes according to an estimated duration associated with each of the public transportation travel routes from short to long.

In 3208, the processing device 112 may generate a recommended page. The recommended page may include a map display area on an upper part and a text display area on a bottom. The text display area may be configured to display first data relating to the top three public transportation travel routes in the form of a list and cannot slide downward anymore. The first data may include at least one of a public transportation transfer scheme, the walking distance, a price, a pick-up station, or a detail button.

In 3210, the processing device 112 may determine whether the client loads continuously, or fails to load, or no data occurs on the client. If it is determined that the client loads continuously, or fails to load, or no data occurs on the client, process 3200 may proceed to perform operation 3212. If it is determined that the client loads successfully, or there is data occurring on the client, process 3200 may proceed to perform 3216.

In 3212, the processing device 112 may cause a display to display a prompt accordingly.

In 3214, the processing device 112 may return to 3206 in response to a refreshing operation of the user.

In 3216, the processing device 112 may cause the display to display the recommended page.

In 3218, the processing device 112 may obtain third data corresponding to a public transportation travel route in response to a click operation of the user performing on a detail button.

In 3220, the processing device 112 may determine whether the client loads continuously or fails to load. If it is determined that the client loads continuously or fails to load, process 3200 may proceed to 3222. If it is determined that the client loads successfully, the process 3200 may proceed to 3226.

In 3222, the processing device 112 may cause a display to display a prompt on the text display area accordingly.

In 3224, the processing device 112 may return to perform operation 3218 in response to a refreshing operation of the user.

In 3226, the processing device 112 may control the text display area to display the first data to slide downward and phase out of the recommended page, and the text display area displaying the third data to slide upward from the bottom to the recommended page, to complete a switch from a route brief page displaying the first data to a route detail page displaying the third data.

In 3228, the processing device 112 may control the text display area slide upward to display all the obtained public transportation travel routes in response to an upward slide operation of the user performing on the text display area. In some embodiments, during the sliding, other elements on the map may remain unchanged, other areas on the recommended page may gradually become darker and form a mask, and the top of the recommended page may gradually present a button for hiding.

In 3230, the processing device 112 may control the text display area restores to an initial location in response to a click operation of the user performing on the button for hiding or the mask.

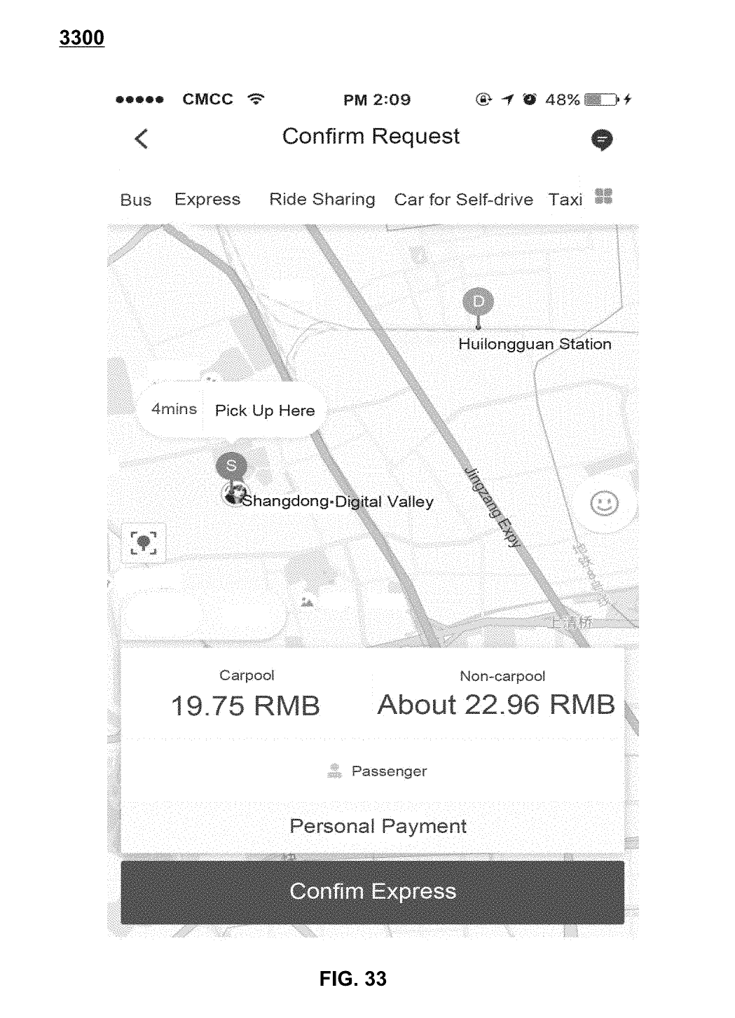

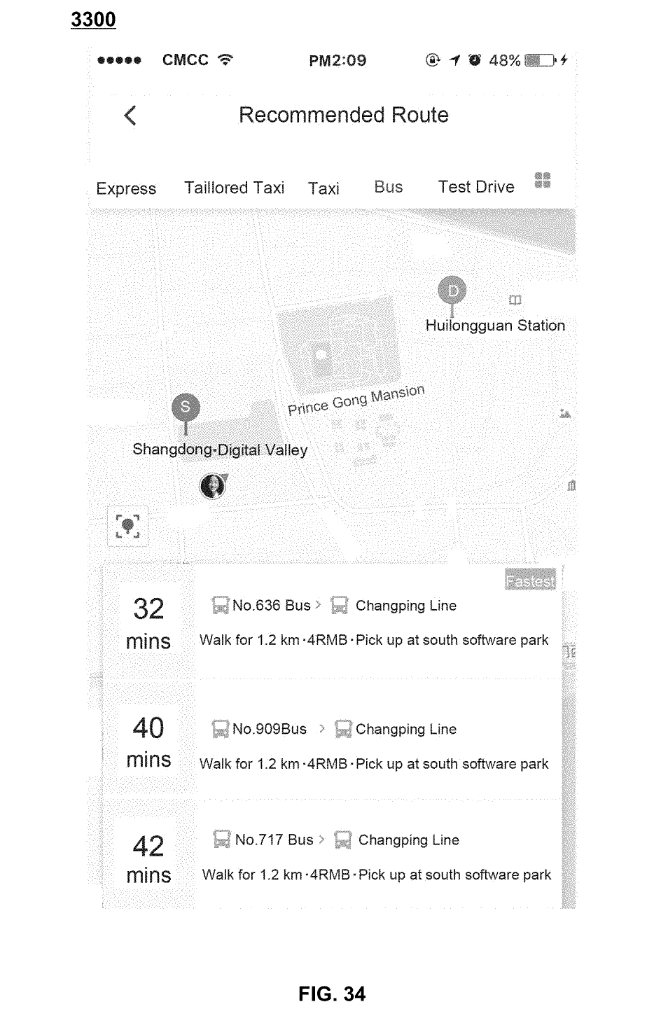

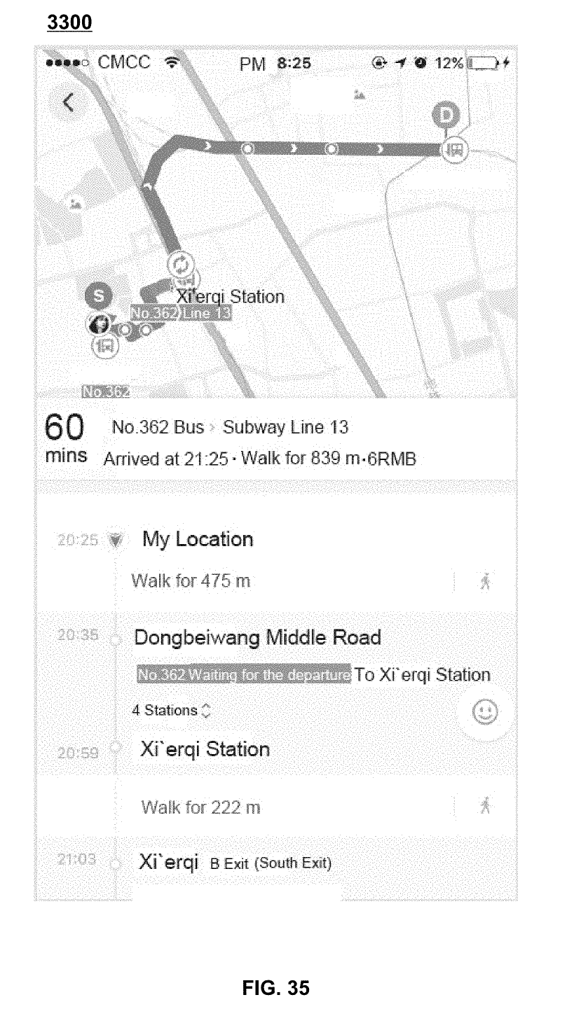

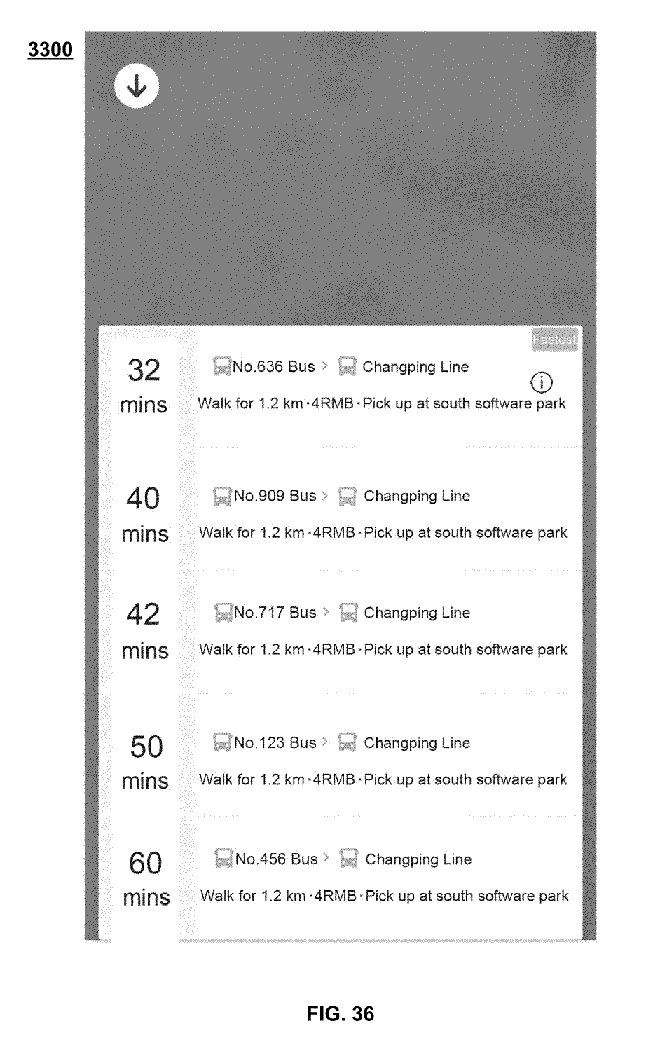

FIGS. 33-36 are schematic diagrams illustrating an online taxi-hailing application 3300 according to some embodiments of the present disclosure. In some embodiments, a user may switch an express car reservation page shown in FIG. 33 to a public transportation planning page shown in FIG. 34 and launch a transfer search in real time. When the express car reservation page or the public transportation planning page shows continuous loading, loading failure, or no data occurs, the corresponding prompt may include respectively “network error, please check and try again,” “query failed, click to reload,” and “no suitable public transportation travel route.” FIG. 35 shows a route detail page as described in 3218. As shown in FIG. 36, when all the public transportation travel routes are displayed, if the list of all the public transportation travel routes does not cover one screen, the highest point that an upward slide operation reaches to may be on the upper edge of the text display area. If the list exceeds one screen, the text display area may slide upward to display the recommended page until the bottom of the list slides to the lower edge of the text display area. In 3228, the text display area may be restored by the click operation for hiding the button or the mask. In some embodiments, the text display area may be restored by the slide operation. For example, when a user performs the downward slide operation on the text display area, the text display area may be slid downward, the mask of the map display area may be gradually hidden, other elements on the map may remain unchanged, and the text display area may slide to the initial location.

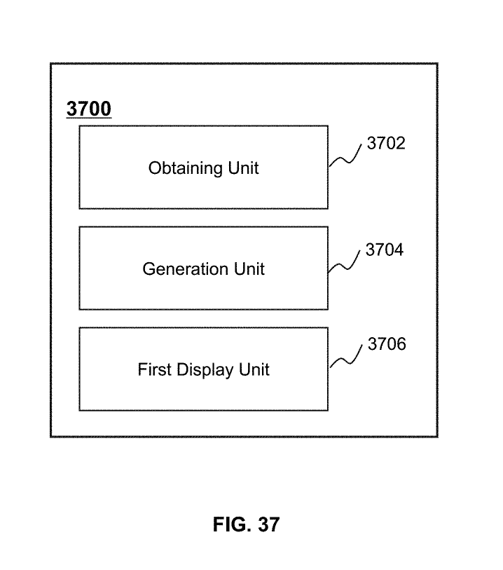

FIG. 37 is a schematic diagram illustrating an exemplary device 3700 for display according to some embodiments of the present disclosure. The device 3700 may include an obtaining unit 3702, a generation unit 3704, and a first display unit 3706. The units of the device 3700 may be hardware circuits of at least part of the processing device 112 or the requester terminal 130 (e.g., the CPU 340 or GPU 330). The units of the device 3700 may also be implemented as an application or set of instructions read and executed by the processing device 112. Further, the units may be any combination of the hardware circuits and the application/instructions. For example, the units of the device 3700 may be the part of the processing device 112 when the processing device 112 is executing the application or set of instructions.

The obtaining unit 3702 may be configured to obtain three or more public transportation travel routes based on a start location and a destination of a service request. The obtaining unit 3702 may also be configured to rank the public transportation travel routes according to an estimated duration associated with each of the public transportation travel routes (e.g., the shorter, the higher rank).

The generation unit 3704 may be configured to generate a recommended page. In some embodiments, the recommended page may include a map display area and a text display area. The text display area may be configured to display first data relating to top three public transportation travel routes of the ranked public transportation travel routes. The first data may include a vehicle number of a public transportation corresponding to each of the top three public transportation travel routes and an estimated duration associated with each of the top three public transportation travel routes.

The first display unit 3706 may be configured to cause a display to display the recommended page.

In some embodiments, the map display area and the text display area may be separated each other on the recommended page by the generation unit 3704 from. A plurality of public transportation travel routes obtained by the obtaining unit 3702 may be displayed on a map, which may facilitate the comparison of the plurality of public transportation travel routes based on the map. The recommended result may be visual, and the user experience may be improved. Further, according to statistical analysis of big data, the satisfaction rate of the top (e.g., three) public transportation travel routes may over 80%, which may basically meet the need of users. Limiting the display of the top three public transportation travel routes instead of displaying all public transportation travel routes may help to control the space of the text display area when there are many public transportation travel routes available. Other public transportation travel routes with lower adoption rates may not be shown, which may make the full use of the space of the recommended page to ensure sufficient map display area. In some embodiments, the start location and the destination entered by a user may be displayed in the map display area. In some embodiments, the three public transportation travel routes may be displayed in the map display area. Further, the first data relating to the top three public transportation travel routes may include a vehicle number of a public transportation corresponding to each of the top three public transportation travel routes and an estimated duration associated with each of the top three public transportation travel routes. When the transfer is involved in a public transportation travel route, the vehicle number may refer to vehicle numbers of public transportations corresponding to the public transportation travel route that are taken successively, so that different public transportation travel routes can be clearly distinguished. The estimated duration may refer to a duration spent by the user from the start location to the destination when using the corresponding public transportation travel route, which may generally be a primary reference for the user when selecting a public transportation travel route. The first data including the vehicle number and the estimated duration may help the user to compare different public transportation travel routes and make full use of the text display area with limited space. Thus, the user experience may be improved.

In some embodiments, the text display area may be configured to display the first data relating to the first number of public transportation travel routes in the form of a list. The text display area displaying the public transportation travel routes in the form of the list may help the user to distinguish different public transportation travel routes. Each public transportation travel route may be displayed in the same display form, which may make the display results clearly, and improve the user experience.

In some embodiments, the text display area may share the same edge with the boundary of the recommended page. The text display area sharing the same edge with the boundary of the recommended page may focus the text display area on a bottom of the recommended page and the rest space of the recommended page on an upper part. Thus, the integrity of the map display area may not be influenced by the text display area, which may help to display the map and improve the user experience.

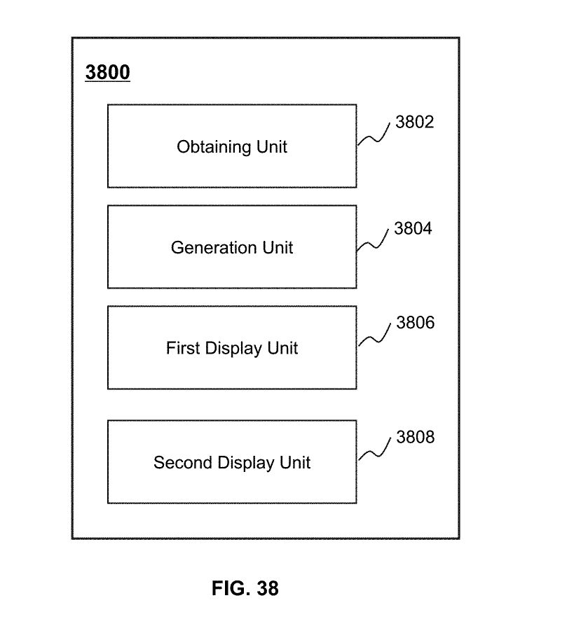

FIG. 38 is a schematic diagram illustrating an exemplary device 3800 for display according to some embodiments of the present disclosure. The device 3800 may include an obtaining unit 3802, a generation unit 3804, a first display unit 3806, and a second display unit 3808. The units of the device 3800 may be hardware circuits of at least part of the processing device 112 or the requester terminal 130 (e.g., the CPU 340 or GPU 330). The units of the device 3800 may also be implemented as an application or set of instructions read and executed by the processing device 112. Further, the units may be any combination of the hardware circuits and the application/instructions. For example, the units of the device 3800 may be the part of the processing device 112 when the processing device 112 is executing the application or set of instructions.

The obtaining unit 3802 may be configured to obtain a plurality of (e.g., three or more) public transportation travel routes based on a start location and a destination of a service request. The obtaining unit 3802 may also be configured to rank the public transportation travel routes according to an estimated duration associated with each of the public transportation travel routes from short to long.

The generation unit 3804 may be configured to generate a recommended page. The recommended page may include a map display area on an upper part of the recommended page and a text display area on a bottom of the recommended page. The text display area may be configured to display first data relating to the top three public transportation travel routes. The first data may include a vehicle number of a public transportation corresponding to each of the top three public transportation travel routes and an estimated duration associated with each of the top three public transportation travel routes.

The first display unit 3806 may be configured to cause a display to display the recommended page.

The second display unit 3808 may be configured to expand the text display area to display second data relating to a second number of public transportation travel routes in response to an upward sliding operation of a user performing on the text display area.

In some embodiments, more public transportation travel routes may be displayed by expanding the text display area, by the second display unit 3808, which can provide the user more options when the default recommended three public transportation travel routes cannot meet the need of the user. Besides, by setting the upward slide operation and using the upward slide operation as a trigger command for expanding the text display area, the slide direction of the user may be consistent with the expansion direction of the text display area, producing an effect of opening the text display area by sliding, which may meet human visual habits and bring friendly operating experience. In some embodiments, after expanding the text display area, the text display area may be shortened to a state of displaying three public transportation travel routes in response to a downward slide operation of the user. In some embodiments, the expanding of the text display area may be achieved by switching to a larger text display area to display all the public transportation travel routes. In some embodiments, the whole text display area may be moved upward, and the un-displayed public transportation travel routes may appear from the bottom of the recommended page. Thus, all the public transportation travel routes may be displayed. In some embodiments, the second number of the public transportation travel routes may include all the public transportation travel routes, which may change with the recommended result. In some embodiments, the second number may be set as a fixed value. In some embodiments, the second number of the displayed public transportation travel routes may be controlled by a sliding distance. The second number may be a variable. In some embodiments, the first display unit 3806 and the second display unit 3808 may be the same display unit.

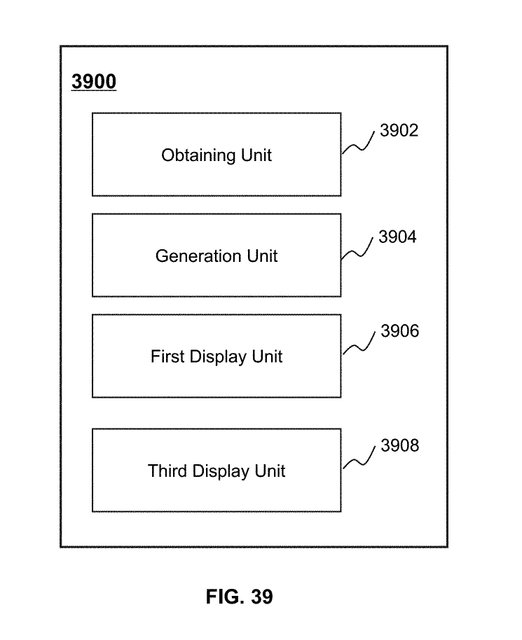

FIG. 39 is a schematic diagram illustrating an exemplary device 3900 for display according to some embodiments of the present disclosure. The device 3900 may include an obtaining unit 3902, a generation unit 3904, a first display unit 3906, and a third display unit 3908. The units of the device 3900 may be hardware circuits of at least part of the processing device 112 or the requester terminal 130 (e.g., the CPU 340 or GPU 330). The units of the device 3900 may also be implemented as an application or set of instructions read and executed by the processing device 112. Further, the units may be any combination of the hardware circuits and the application/instructions. For example, the units of the device 3900 may be the part of the processing device 112 when the processing device 112 is executing the application or set of instructions.

The obtaining unit 3902 may be configured to obtain three or more public transportation travel routes based on a start location and a destination. The obtaining unit 3902 may also be configured to rank the public transportation travel routes according to an estimated duration associated with each of the public transportation travel routes from short to long.

The generation unit 3904 may be configured to generate a recommended page. The recommended page may include a map display area and a text display area. The text display area may be configured to display first data relating to the top three public transportation travel routes. The first data may include a vehicle number of a public transportation corresponding to each of the top three public transportation travel routes and an estimated duration associated with each of the top three public transportation travel routes.

The first display unit 3906 may be configured to cause a display to display the recommended page.

The third display unit 3908 may be configured to cause the display to display third data relating to a public transportation travel route corresponding to the location of the click operation on the text display area in response to a click operation of a user performing on the text display area.

In some embodiments, the third display unit 3908 may cause the display to display third data relating to a public transportation travel route by clicking one public transportation travel route on the text display area, which may help the user to understand the public transportation travel route to make a decision or instruct the user to take the corresponding public transportation. The third data relating to the public transportation travel route may include the walking distance, the vehicle number, the driving direction, picking-up/taking-off stations, the number of stations, the driving duration, or the like. In some embodiments, when the transfer is involved in a public transportation travel route, the third display unit 3908 may successively display one or more public transportations based on order of taking the public transportations. At the same time, the third data may be still displayed on the text display area, and the map display area may display the corresponding public transportation travel route, which makes the public transportation travel route display more visual. In some embodiments, the first display unit 3906 and the third display unit 3908 may be the same display unit.

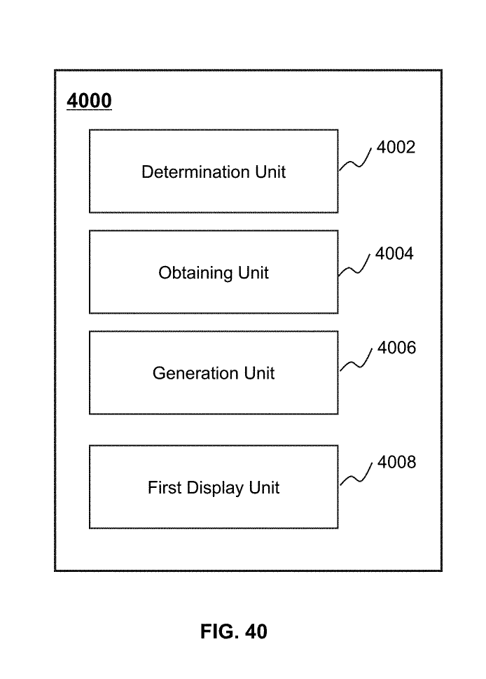

FIG. 40 is a schematic diagram illustrating an exemplary device 4000 for display according to some embodiments of the present disclosure. As shown in FIG. 40, the device 4000 may include a determination unit 4002, an obtaining unit 4004, a generation unit 4006, and a first display unit 4008. The units of the device 4000 may be hardware circuits of at least part of the processing device 112 or the requester terminal 130 (e.g., the CPU 340 or GPU 330). The units of the device 4000 may also be implemented as an application or set of instructions read and executed by the processing device 112. Further, the units may be any combination of the hardware circuits and the application/instructions. For example, the units of the device 4000 may be the part of the processing device 112 when the processing device 112 is executing the application or set of instructions.

The determination unit 4002 may be configured to determine whether a user has entered the start location and the destination after initiating a planning page.

The obtaining unit 4004 may be configured to, in response to a determination that the user has entered the start location and the destination, obtain at least three public transportation travel routes based on the start location and the destination. The obtaining unit 4004 may also be configured to rank the public transportation travel routes according to an estimated duration associated with each of the public transportation travel routes from short to long.

The generation unit 4006 may be configured to generate a recommended page.

The recommended page may include a map display area and a text display area. The text display area may be configured to display first data relating to the top three public transportation travel routes. The first data may include a vehicle number of a public transportation corresponding to each of the top three public transportation travel routes and an estimated duration associated with each of the top three public transportation travel routes.

The first display unit 4008 may be configured to cause a display to display the recommended page.

In some embodiments, determining whether the user has entered the start location and the destination before initiating the planning page (by the determination unit 4002) may cause different pages relating to the route planning to communicate with each other, which may reduce the input number of the user, improve the level of intelligence, and further improve the user experience. Specifically, when the information display device for displaying travel routes is applied to a platform or application relating to the route planning, the travel route such as driving routes, public transportation travel routes, walking routes, etc., may be planned on different pages to meet the different needs of users. For example, when the platform or application is an online taxi-hailing platform, a driving page may be further divided into, for example, a car rental interface, a taxi interface, a special car interface, etc. If no suitable cars are found, the user can turn to the public transportation interface to inquire a public transportation travel route. In the same online taxi-hailing platform, the user may not have to enter the start location and the destination when the interface (or page) is switched.

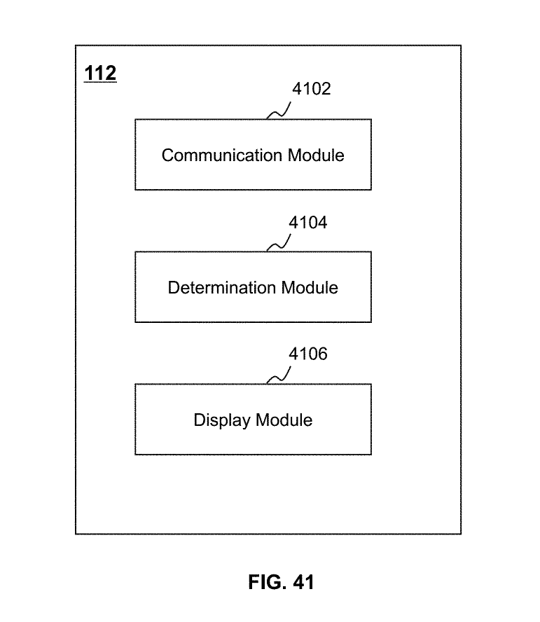

FIG. 41 is schematic diagram illustrating an exemplary processing device 112 according to some embodiments of the present disclosure. The processing device 112 may be in communication with a storage device (e.g., the storage device 160, and may execute instructions stored in the storage device. In some embodiments, the processing device 112 may include a communication module 4102, a determination module 4104, and a display module 4106. The modules of the processing device 112 may be a hardware circuit of at least part of the processing device 112. The modules of the processing device 112 may also be implemented as an application or set of instructions read and executed by the processing device 112. Further, the modules may be any combination of the hardware circuits and the application/instructions. For example, the modules of the processing device 112 may be the part of the processing device 112 when the processing device 112 is executing the application or set of instructions.

The communication module 4102 may be configured to receive information and/or data from a service system via a network (e.g., the network 120). In some embodiments, the service system may be an online transportation service application installed on a client terminal. In some embodiments, the service system may facilitate a taxi hailing service, an express service, a ride-sharing service, a carpool service, a bus service, a chauffeur service, a driver hire, or the like.

In some embodiments, the communication module 4102 may receive information of a first travel from the service system via the network 120. The term “first travel” used herein refers to a travel plan issued by a user via the client terminal. The information of the first travel may include a start location (also referred to a second start location), a destination, a departure time, or the like, or any combination thereof. Alternatively or additionally, the communication module 4102 may also receive a request from a user for obtaining one of the at least one public transportation travel route. For the convenience of travel, the user may initiate a request for obtaining a public transportation travel route using the client terminal. For example, the user may generate a request by character input, or voice input via the client terminal. In some embodiments, the public transportation travel route may include a total travel duration, a travel trajectory, the total walking distance, the transportation cost, or the like.

The communication module 4102 may also be configured to transmit information and/or data to the service system via the network 120. In some embodiments, the communication module 4102 may transmit one or more of the at least one route planning record in response to the received request to the service system of the client terminal via the network 120. For example, the communication module 4102 may transmit a first interface identifier corresponding to a specific route planning record to the client terminal. As another example, the communication module 4102 may transmit one or more second interface identifiers corresponding to the one or more unspecific route planning records to the client terminal.

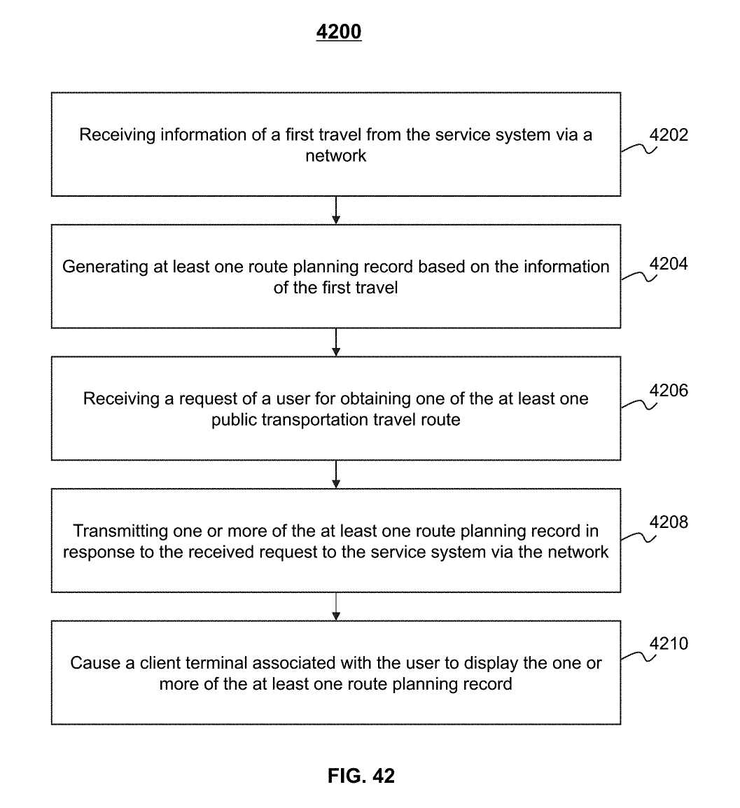

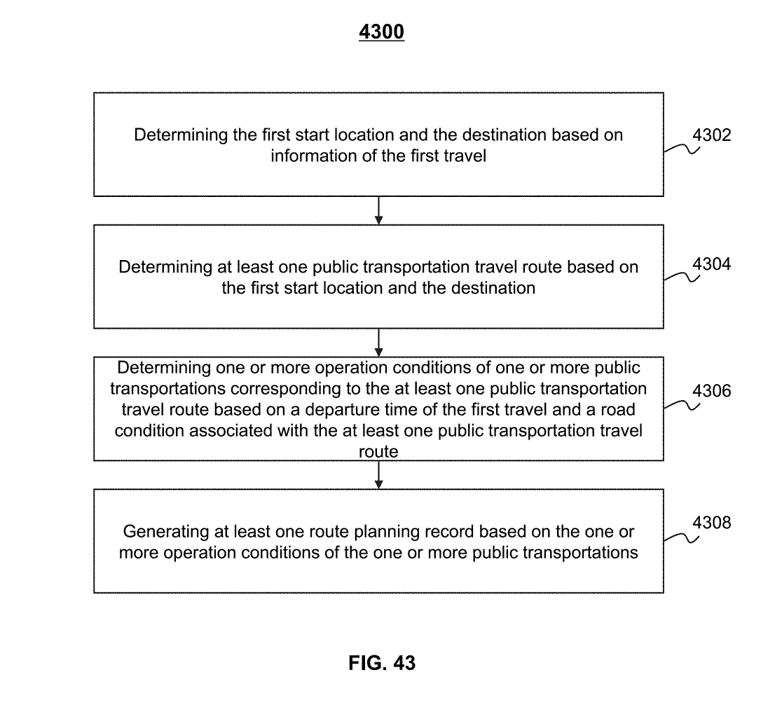

The determination module 4104 may be configured to generate at least one route planning record based on the information of the first travel. In some embodiments, the at least one route planning record may include at least one public transportation travel route. The at least one public transportation travel route may include one or more public transportations, such as a bus, a subway, a shared bicycle, etc. Each of the at least one route planning record may include one or more identifiers of the one or more public transportations and an interface identifier configured to distinguish one route planning record from another route planning record. More descriptions of the determination of route planning records may be found elsewhere in the present disclosure (e.g., operation 4204 of FIG. 42, FIGS. 43-45, and the descriptions thereof).

The display module 4106 may be configured to cause the client terminal associated with the user to display the one or more of the at least one route planning record. In some embodiments, the display module 4106 may instruct the client terminal to display the specific route planning record in the form of a map interface. The map interface may display one or more identifiers of one or more public transportations and a second travel associated with the public transportation travel route. The second travel may include at least one of travel parameters including at least one of a total travel duration of the public transportation travel route, a travel trajectory of the public transportation travel route, the total walking distance, or the transportation cost. Alternatively or additionally, the display module 4106 may instruct the client terminal to display the unspecific route planning records in the form of one or more second interface identifiers. For example, the client terminal may display a second interface identifier on the client terminal, which may include an identifier of a public transportation corresponding to the unspecific route planning record. When a user clicks the second interface identifier, the client terminal may display the unspecific route planning record in the form of the map interface.

It should be noted that the above description of the processing device 112 is provided for the purposes of illustration, and is not intended to limit the scope of the present disclosure. For persons having ordinary skills in the art, multiple variations and modifications may be made under the teachings of the present disclosure. However, those variations and modifications do not depart from the scope of the present disclosure. In some embodiments, any module mentioned above may be divided into two or more units. For example, the communication module 4102 may be divided into two units, one of which is configured to receive information and/or data from the service system, and the other is configured to transmit information and/or data to the service system. In some embodiments, the processing device 112 may further include one or more additional modules. For example, the processing device 112 may further include a storage module (not shown in FIG. 4) configured to store data generated by the modules of the processing device 112.

FIG. 42 is a flowchart illustrating an exemplary process for route planning according to some embodiments of the present disclosure. In some embodiments, process 4200 may be implemented in the route planning system 100. For example, the process 4200 may be stored in the storage device 160 and/or the storage (e.g., the ROM 230, the RAM 240, etc.) as the form of instructions, and invoked and/or executed by the server 110 (e.g., the processing device 112 of the server 110, or the processor 220 of the processing device 112 of the server 110).

In 4202, the processing device 112 (e.g., the communication module 4102) may receive information of a first travel from a service system via a network (e.g., the network 120). In some embodiments, the service system may be an online transportation service application installed on a client terminal (e.g., the requester terminal 130, the mobile device 300). In some embodiments, the service system may facilitate a taxi hailing service, an express service, a ride-sharing service, a carpool service, a bus service, a chauffeur service, a driver hire, or the like.

The term “first travel” used herein refers to a travel plan issued by a user via the client terminal. In some embodiments, the information of the first travel may be entered into the service system by the user. The information of the first travel may include a start location (also referred to a second start location), a destination, a departure time, or the like, or any combination thereof.

In 4204, the processing device 112 (e.g., the determination module 4104) may generate at least one route planning record based on the information of the first travel. In some embodiments, the at least one route planning record may include at least one public transportation travel route. The at least one public transportation travel route may include one or more public transportations, such as a bus, a subway, a shared bicycle, etc. Each of the at least one route planning record may include one or more identifiers of the one or more public transportations and an interface identifier configured to distinguish one route planning record from another route planning record. The interface identifier may be displayed on the client terminal. In some embodiments, the one or more identifiers of each of the one or more public transportations may include a license plate, a vehicle number, etc. In some embodiments, the determination of the route planning record may be found elsewhere in the present disclosure (e.g., FIG. 43 and the descriptions thereof).

In 4206, the processing device 112 (e.g., the communication module 4102) may receive a request of a user for obtaining one of the at least one public transportation travel route. For the convenience of travel, the user may initiate a request for obtaining a public transportation travel route using the client terminal. For example, the user may generate a request by character input, or voice input via the client terminal. The generated request may be transmitted to and received by the processing device 112 via the network 120. In some embodiments, the public transportation travel route may include a total travel duration, a travel trajectory, the total walking distance, the transportation cost, or the like.

In 4208, the processing device 112 (e.g., the communication module 4102) may transmit one or more of the at least one route planning record in response to the received request to the service system via the network 120. In some embodiments, after receiving the request of the user, the processing device 112 may transmit one or more route planning records (e.g., a specific route planning record, one or more unspecific route planning records) corresponding to the public transportation travel route requested by the user to the service system of the client terminal. For example, the processing device 112 may transmit a first interface identifier corresponding to a specific route planning record to the client terminal. As another example, the processing device 112 may transmit one or more second interface identifiers corresponding to one or more unspecific route planning records to the client terminal. More descriptions for the specific route planning record and/or the unspecific route planning records may be found elsewhere in the present disclosure (e.g., FIGS. 4-8 and the descriptions thereof).

In 4210, the processing device 112 (e.g., the display module 4106) may cause the client terminal associated with the user to display the one or more of the at least one route planning record. In some embodiments, the processing device 112 may instruct the client terminal to display the specific route planning record in the form of a map interface. The map interface may display one or more identifiers of one or more public transportations and a second travel associated with the public transportation travel route. The second travel may include at least one of travel parameters including at least one of a total travel duration of the public transportation travel route, a travel trajectory of the public transportation travel route, the total walking distance, or the transportation cost. In some embodiments, the processing device 112 may instruct the client terminal to display the unspecific route planning records in the form of one or more second interface identifiers. For example, the client terminal may display a second interface identifier on the client terminal, which may include an identifier of a public transportation corresponding to the unspecific route planning record. When a user clicks the second interface identifier, the client terminal may display the unspecific route planning record in the form of the map interface.

In some embodiments, the processing device 112 may cause the client terminal to generate a recommended page. The recommended page may include a map display area and a text display area. The map display area may be configured to display the map interface. The text display area may be configured to display first data relating to a first number of the one or more second interface identifiers by, for example, the form of a list. In some embodiments, the first data relating to the first number of the one or more second interface identifiers may include a vehicle number of a public transportation corresponding to an unspecific route planning records and an estimated duration associated with a public transportation travel route corresponding to an unspecific route planning record. In some embodiments, the text display area may share the edge with the boundary of the recommended page.

The processing device 112 may cause the client terminal to display the recommended page by a display of the client terminal (e.g., a touchscreen). In some embodiments, the processing device 112 may cause the client terminal, in response to a slide operation of the user performing on the text display area, to expand the text display area to display second data relating to a second number of the one or more second interface identifiers. The slide operation may be directed from the text display area to the center of the recommended page. Alternatively, the processing device 112 may cause the client terminal, in response to a click operation of the user performing on the text display area, to display third data relating to a second identifier corresponding to the location of the click operation on the text display area.

It should be noted that the above description of the process 4200 is provided for the purposes of illustration and is not intended to limit the scope of the present disclosure. For persons having ordinary skills in the art, multiple variations and modifications may be made under the teachings of the present disclosure. However, those variations and modifications do not depart from the scope of the present disclosure. In some embodiments, in 4206, the processing device 112 may receive and/or obtain a request for planning at least one public transportation travel route. In some embodiments, in 4206, the processing device 112 may receive a request for obtaining one of the one or more second interface identifiers.

FIG. 43 is a flowchart illustrating an exemplary process for generating at least one route planning record according to some embodiments of the present disclosure. In some embodiments, process 4300 may be implemented in the route planning system 100. For example, the process 4300 may be stored in the storage device 160 and/or the storage (e.g., the ROM 230, the RAM 240, etc.) as the form of instructions, and invoked and/or executed by the server 110 (e.g., the processing device 112 of the server 110, or the processor 220 of the processing device 112 of the server 110). In some embodiments, operation 4204 may be performed according to process 4300.

In 4302, the processing device 112 (e.g., the determination module 4104) may determine the first start location and the destination based on information of the first travel. The first start location and/or the destination may correspond to latitude and longitude coordinates. The first start location may be the start location of a public transportation travel route. The destination may be destination of the public transportation travel route. In general, the destination may be the destination entered by a user corresponding to the first travel or suggested by the processing device 112 according to the user's previous requests. The first start location may be determined based on the location of the user, and the start location entered by the user (also referred to as the second start location) corresponding to the first travel. The location of the user may be a geographic location of the user when the first travel is generated. The geographic location of the user may be determined by a positioning chipset of the client terminal.

To determine the first start location, the processing device 112 may analyze the location of the user and the second start location. The processing device 112 may determine the distance between the location of the user and the second start location and determine whether the distance is greater than or equal to than a distance threshold. The processing device 112 may also designate the second start location as the first start location based on a result of the determination that the distance is greater than or equal to a distance threshold. Alternatively, the processing device 112 may designate the location of the user as the first start location based on a result of the determination that the distance is less than the distance threshold. The distance threshold may be a default value of the route planning system 100 or adjusted by a user. In some embodiments, the distance threshold may be 100 meters, 300 meters, 500 meters, 1 kilometer, or the like.

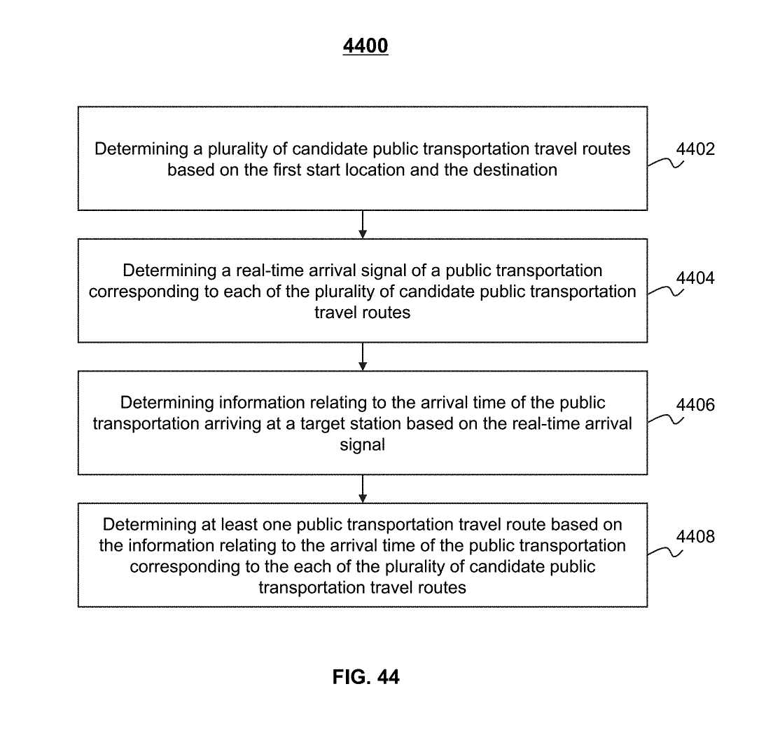

In 4304, the processing device 112 (e.g., the determination module 4104) may determine at least one public transportation travel route based on the first start location and the destination. In some embodiments, the processing device 112 may determine at least one public transportation travel route passing the first start location and the destination. The determination of the at least one public transportation travel route may be found elsewhere in the present disclosure (e.g., FIG. 44 and the descriptions thereof).

In 4306, the processing device 112 (e.g., the determination module 4104) may determine one or more operating conditions of one or more public transportations corresponding to the at least one public transportation travel route based on the departure time of the first travel and the road condition associated with the at least one public transportation travel route. The departure time may be the time of the user starting the first travel. The road condition associated with the at least one public transportation travel route may include traffic conditions, traffic controls, road constructions, road closure, weather conditions, environmental conditions, or the like, or any combination thereof. In some embodiments, the one or more operating conditions may include operating periods and operating sections corresponding to a first portion of the one or more public transportations, which may have fixed sites, and the distribution of a second portion of the one or more public transportations, which may have non-fixed sites. For example, the first portion of the one or more public transportations may involve a subway, or bus, or a combination thereof, while the second portion of the one or more public transportations may involve bicycle or car rental service.

In 4308, the processing device 112 (e.g., the determination module 4104) may generate at least one route planning record based on the one or more operating conditions of the one or more public transportations. Each of the at least one route planning record may include one or more identifiers of the one or more public transportations and an interface identifier configured to distinguish a route planning record from another. The interface identifier may be displayed on the client terminal. In some embodiments, the one or more identifiers of the one or more public transportations may include a license plate, a vehicle number, etc.

FIG. 44 is a flowchart illustrating an exemplary process for generating at least one route planning record according to some embodiments of the present disclosure. In some embodiments, process 4400 may be implemented in the route planning system 100. For example, the process 4400 may be stored in the storage device 160 and/or the storage (e.g., the ROM 230, the RAM 240, etc.) as the form of instructions, and invoked and/or executed by the server 110 (e.g., the processing device 112 of the server 110, or the processor 220 of the processing device 112 of the server 110). In some embodiments, operation 4304 of the process 4300 may be performed according to process 4400.

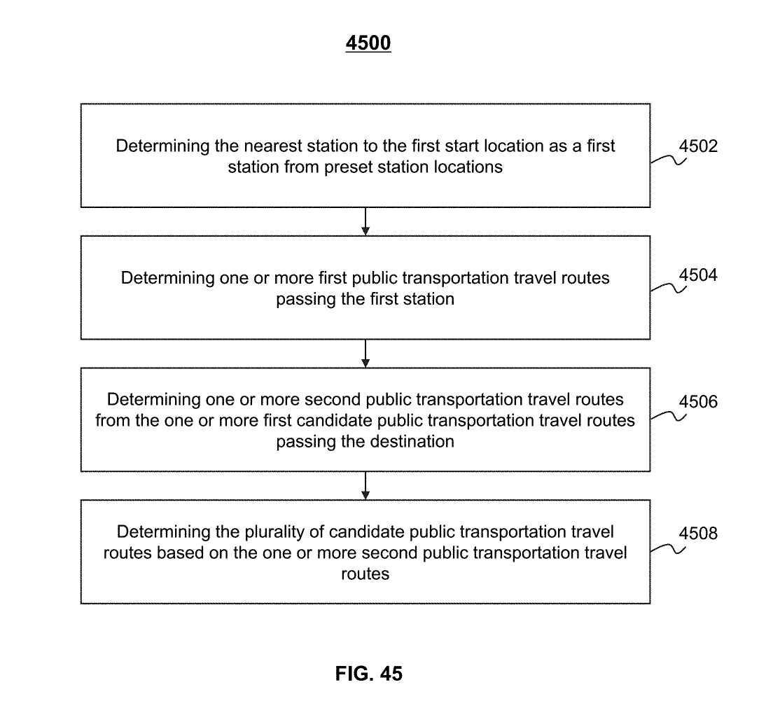

In 4402, the processing device 112 (e.g., the determination module 4104) may determine a plurality of candidate public transportation travel routes based on the first start location and the destination. The processing device 112 may determine a plurality of candidate public transportation travel routes passing the first start location and the destination. In some embodiments, the plurality of candidate public transportation travel route may be determined based on various factors including, for example, whether the plurality of candidate public transportation travel routes are direct, whether the plurality of candidate public transportation travel routes involve a transfer, an expected duration of each of the plurality of candidate public transportation travel route. The determination of the candidate public transportation travel routes may be found elsewhere in the present disclosure (e.g., FIG. 45 and the descriptions thereof).

In 4404, the processing device 112 (e.g., the determination module 4104) may determine a real-time arrival signal of a public transportation corresponding to each of the plurality of candidate public transportation travel routes. In some embodiments, the real-time arrival signal may include at least one of an arrival station of the public transportation, the vehicle number of the public transportation, the license plate of the public transportation, the driving direction of the public transportation, or the area of the public transportation located (e.g., the current location of the public transportation).

In some embodiments, to determine the real-time arrival signal of a public transportation, the processing device 112 may receive a prompting signal indicating that the public transportation is approaching or has arrived at a station. The prompting signal may be generated when an door-open button of the public transportation is triggered. Alternatively or additionally, the prompting signal may be generated when an arrival prompting button of the public transportation is triggered. The processing device 112 may obtain the real-time arrival signal associated with the public transportation based on the prompting signal.

In some embodiments, the public transportation may be equipped with a signal transmitter. The signal transmitter may be configured to transmit the real-time arrival signal to the processing device 112. In some embodiments, the signal transmitter may be triggered when an arrival prompting button of the public transportation is triggered. In some embodiments, the signal transmitter may be triggered when the prompting signal is received.

In 4406, the processing device 112 (e.g., determination module 4104) may determine information relating to the arrival time of the public transportation arriving at a target station based on the real-time arrival signal. In some embodiments, the information relating to the arrival time may include the arrival time point of the public transportation arriving at the target station, the first travel duration of the public transportation from the arrival station to the target station, or the like.

In some embodiments, the processing device 112 may determine driving vehicles that match the real-time arrival signal. The driving vehicles may be contracted vehicles of the service system. The driving information of the contracted (or driving vehicles) in historical travel routes may be pre-collected by the processing device 112. The driving direction of the driving vehicles may match the driving direction of the public transportation. The processing device 112 may determine one or more of the driving vehicles having an overlapping driving route with the public transportation as one or more reference vehicles. The processing device 112 may obtain one or more reference travels associated with each of the one or more reference vehicles. In some embodiments, each of the one or more reference travels may include the driving speed and the distance from the arrival station to the target station. Alternatively, each of the one or more reference travels may include the driving duration from the arrival station to the target station. The processing device 112 may determine the information relating to the arrival time based on the one or more reference travels associated with each of the one or more reference vehicles.

In 4408, the processing device 112 (e.g., the determination module 4104) may determine at least one public transportation travel route based on the information relating to the arrival time of the public transportation corresponding to the each of the plurality of candidate public transportation travel routes.

In some embodiments, the processing device 112 may determine a second travel duration of the client terminal from the first start location to the target station. In some embodiments, the second travel duration may include the walking duration, the riding duration, or the like, or a combination thereof. For example, a user may walk from the first start location to the target station. Alternatively, the user may ride a bicycle from the first start location to the target station. The processing device 112 may determine at least one of the plurality of candidate public transportation travel routes as the at least one public transportation travel route. The first travel duration of the determined at least one public transportation travel routes may be greater than the second travel duration of the client terminal from the first start location to the target location.

FIG. 45 is a flowchart illustrating an exemplary process for generating at least one route planning record according to some embodiments of the present disclosure. In some embodiments, process 4500 may be implemented in the route planning system 100. For example, the process 4500 may be stored in the storage device 160 and/or the storage (e.g., the ROM 230, the RAM 240, etc.) as the form of instructions, and invoked and/or executed by the server 110 (e.g., the processing device 112 of the server 110, or the processor 220 of the processing device 112 of the server 110). In some embodiments, operation 4402 may be performed according to process 4500.

In 4502, the processing device 112 (e.g., the determination module 4104) may determine, from preset station locations, the nearest station to the first start location as a first station. In some embodiments, the preset station locations may include a plurality of station names and station locations that one or more public transportations may pass, which may be stored in a storage (e.g., the storage device 160). The processing device 112 may determine the nearest station by taking distances between the preset station locations and the first start location into consideration. The nearest station may be designated as the first station.

In 4504, the processing device 112 (e.g., the determination module 4104) may determine one or more first public transportation travel routes passing the first station. In some embodiments, the processing device 112 may determine, from the preset station locations, the second nearest station to the location of the user as a second station. The processing device 112 may determine the one or more first public transportation travel routes passing the first station and the second station.

In 4506, the processing device 112 (e.g., the determination module 4104) may determine, from the one or more first public transportation travel routes, one or more second public transportation travel routes passing the destination. The second public transportation travel routes may pass the first station and the destination. In some embodiments, no public transportation travel routes may pass the destination. The processing device 112 may determine, from the preset station locations, the nearest station to the destination as a third station. The processing device 112 may determine, from the one or more first public transportation travel routes, one or more second public transportation travel routes passing the third station.

In 4508, the processing device 112 (e.g., the determination module 4104) may determine a plurality of candidate public transportation travel routes based on the one or more second public transportation travel routes.

In some embodiments, for each of the one or more second public transportation travel routes, the processing device 112 may obtain the current location of a public transportation corresponding to the each of the one or more second public transportation travel routes. In some embodiments, the current location of the public transportation may be determined by a positioning chipset of the public transportation. Alternatively, the current location of the public transportation may be determined based on real-time arrival signal of the public transportation. The processing device 112 may determine the distance from the current location of the public transportation to the first start location (or to the first station). The distance from the current location of the public transportation to the first start location may be used to determine whether the public transportation is arriving at the first station. The processing device 112 may rank the one or more second public transportation travel routes based on a first rule associated with the distance from closest to farthest. The processing device 112 may determine the plurality of candidate public transportation travel routes based on the ranked one or more second public transportation travel routes. For example, the processing device 112 may select a portion of the ranked second public transportation travel routes that ranked at the top as the plurality of candidate public transportation travel routes.

It should be noted that the above description of the process 4500 is provided for the purposes of illustration and is not intended to limit the scope of the present disclosure. For persons having ordinary skills in the art, multiple variations and modifications may be made under the teachings of the present disclosure. However, those variations and modifications do not depart from the scope of the present disclosure. In some embodiments, in 4508, the processing device 112 may receive input of a keyword entered by the client terminal. The processing device 112 may determine whether the keyword includes a digit. The processing device 112 may designate at least one of the one or more second public transportation travel routes as a plurality of candidate public transportation travel routes. A vehicle number of a public transportation corresponding to one of the plurality of candidate public transportation travel routes may include the digit as an initial number.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer-readable media having computer readable program code embodied thereon.

A computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer-readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran, Perl, COBOL, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1-23. (canceled)

24. A method for public transportation travel route pushing implemented on an online car-hailing application, the method comprising:
receiving a start location and a destination entered by a client terminal;
determining a plurality of candidate public transportation travel routes based on the start location and the destination;
obtaining a real-time arrival signal of a public transportation corresponding to each of the plurality of candidate public transportation travel routes;
determining information relating to an arrival time of the public transportation arriving at a target station based on the real-time arrival signal, the target station being a nearest station to the start location for the public transportation; and
transmitting at least one target public transportation travel route to the client terminal based on the information relating to the arrival time of the public transportation corresponding to the each of the plurality of candidate public transportation travel routes.

25-54. (canceled)

55. A method for display, comprising:
receiving a start location and a destination;
obtaining at least two public transportation travel routes based on the start location and the destination;
generating a recommended page, wherein the recommended page includes a map display area and a text display area, the text display area configured to display first data relating to a first number of public transportation travel routes; and
displaying the recommended page.

56-72. (canceled)

73. A computing device for interacting with a service system, comprising:
a data exchange port of the computing device connected to the service system for providing an online-to-offline service implemented on a client terminal;
at least one storage device storing a set of instructions for route planning; and
at least one processor configured to communicate with the at least one storage device, wherein when executing the set of instructions, the at least one processor is configured to cause the computing device to:
receive, from the client terminal, via a network, information of a first travel;
generate at least one route planning record based on the information of the first travel, the at least one route planning record including at least one public transportation travel route;
receive a request of a user for obtaining one of the at least one public transportation travel route; and
transmit, via the network, one of the at least one route planning record in response to the received request to the client terminal.

74. The computing device of claim 73, wherein to generate at least one route planning record based on the information of the first travel, the at least one processor is configured to cause the computing device to:
determine, based on the information of the first travel, a first start location and a destination;
determine, based on the first start location and the destination, the at least one public transportation travel route;
determine, based on a departure time of the first travel and a road condition associated with the at least one public transportation travel route, one or more operating conditions of one or more public transportations corresponding to the at least one public transportation travel route, wherein the one or more operating conditions include:
operating periods and operating sections corresponding to a first portion of the one or more public transportations having fixed sites, and
a distribution of a second portion of the one or more public transportations having non-fixed sites; and
generate the at least one route planning record based on the one or more operating conditions of the one or more public transportations, wherein each of the at least one route planning record includes one or more identifiers of the one or more public transportations and an interface identifier configured to be displayed on the client terminal, the interface identifier corresponding to the each of the at least one route planning record.

75. The computing device of claim 74, wherein to determine, based on the information of the first travel, a first start location, the at least one processor is configured to cause the computing device to:
analyze a location of the user and a second start location corresponding to the first travel, the location of the user being a geographic location of the user when the first travel is generated, the geographic location of the user being determined by a positioning chipset of the client terminal;
determine a distance between the location of the user and the second start location;
determine whether the distance is greater than or equal to a distance threshold;
designate the second start location as the first start location based on a result of the determination that the distance is greater than or equal to a distance threshold; and
designate the location of the user as the first start location based on a result of the determination that the distance is less than the distance threshold.

76. The computing device of claim 74, wherein to determine, based on the first start location and the destination, the at least one public transportation travel route, the at least one processor is configured to cause the computing device to:
determine a plurality of candidate public transportation travel routes based on the first start location and the destination;
obtain a real-time arrival signal of a public transportation corresponding to each of the plurality of candidate public transportation travel routes;
determine information relating to an arrival time of the public transportation arriving at a target station based on the real-time arrival signal, the target station being a nearest station to the first start location for the public transportation; and
determine the at least one public transportation travel route based on the information relating to the arrival time of the public transportation corresponding to the each of the plurality of candidate public transportation travel routes.

77. (canceled)

78. The computing device of claim 76, wherein the real-time arrival signal of the public transportation includes at least one of an arrival station, a vehicle number, a license plate, a driving direction, a current location of the public transportation, or an area the public transportation located, and to determine information relating to an arrival time of the public transportation arriving at a target station based on the real-time arrival signal, the at least one processor is configured to cause the computing device to:
determine driving vehicles that match the real-time arrival signal, wherein the driving vehicles are contracted vehicles of the service system, and driving directions of the driving vehicles match the driving direction of the public transportation;
determine one or more of the driving vehicles having an overlapping driving route with the public transportation as one or more reference vehicles;
obtain one or more reference travels associated with each of the one or more reference vehicles; and
determine the information relating to the arrival time based on the one or more reference travels associated with each of the one or more reference vehicles.

79. The computing device of claim 78, wherein
each of the one or more reference travels includes a driving speed and a distance from the arrival station to the target station, or
each of the one or more reference travels includes a driving duration from the arrival station to the target station.

80. The computing device of claim 78, wherein:
the information relating to the arrival time includes an arrival time point of the public transportation arriving at the target station and a first travel duration of the public transportation from the arrival station to the target station; and to
determine at least one public transportation travel route based on the information relating to the arrival time of the public transportation, the at least one processor is configured to cause the computing device to:
determine a second travel duration of the client terminal from the first start location to the target station; and
determine at least one of the plurality of candidate public transportation travel routes as the at least one public transportation travel route, wherein the first travel duration of the determined at least one of the plurality of candidate public transportation travel routes is greater than the second travel duration of the client terminal from the first start location to the target station.

81. The computing device of claim 76, wherein to determine a plurality of candidate public transportation travel routes based on the first start location and the destination, the at least one processor is configured to cause the computing device to:
determine, from preset station locations, a nearest station to the first start location as a first station;
determine one or more first public transportation travel routes passing the first station;
determine, from the one or more first public transportation travel routes, one or more second public transportation travel routes passing the destination; and
determine, based on the one or more second public transportation travel routes, the plurality of candidate public transportation travel routes.

82. The computing device of claim 81, wherein to determine one or more first public transportation travel routes passing the first station, the at least one processor is configured to cause the computing device to:
determine, from the preset station locations, a second nearest station to the location of the user as a second station; and
determine the one or more first public transportation travel routes passing the first station or the second station.

83. The computing device of claim 81, wherein to determine, based on the one or more second public transportation travel routes, the plurality of candidate public transportation travel routes, the at least one processor is configured to cause the computing device to:
for each of the one or more second public transportation travel routes, obtain a current location of a public transportation corresponding to the each of the one or more second public transportation travel routes;
determine a distance from the current location of the public transportation to the first station;
rank the one or more second public transportation travel routes based on a first rule associated with the distance from closest to farthest; and
determine, based on the ranked one or more second public transportation travel routes, the plurality of candidate public transportation travel routes.

84. The computing device of claim 81, the at least one processor is configured to cause the computing device to:
receive an input of a keyword entered by the client terminal; and
determine whether the keyword includes a digit; and
based on a result of the determination that the keyword includes a digit, designate at least one of the one or more second public transportation travel routes as the plurality of candidate public transportation travel routes, a vehicle number of a public transportation corresponding to one of the plurality of candidate public transportation travel routes including the digit as an initial number.

85. The computing device of claim 76, wherein to obtain a real-time arrival signal of a public transportation corresponding to each of the plurality of candidate public transportation travel routes, the at least one processor is configured to cause the computing device to:
receive a prompting signal indicating that the public transportation is approaching a station; and
obtain the real-time arrival signal associated with the public transportation based on the prompting signal.

86. The computing device of claim 85, wherein
the prompting signal is generated when a door-open button of the public transportation is triggered; or
the prompting signal is generated when an arrival prompting button of the public transportation is triggered.

87. The computing device of claim 73, the at least one processor is further configured to cause the computing device to:
obtain a request for planning at least one public transportation travel route;
transmit to the client terminal at least one first interface identifier corresponding to a specific route planning record or one or more second interface identifiers corresponding to one or more unspecific route planning record of the at least one route planning record based on a predetermined strategy;
instruct the client terminal to display the specific route planning record in a form of a map interface, the map interface displaying the one or more identifiers of the one or more public transportations and a second travel associated with the at least one public transportation travel route of the specific route planning record; and
instruct the client terminal to display the one or more unspecific route planning record in a form of the one or more second interface identifiers, wherein the second travel includes at least one of travel parameters including at least one of a total travel duration of the at least one public transportation travel route, a travel trajectory of the at least one public transportation travel route, a total walking distance, or a transportation cost.

88. The computing device of claim 87, the at least one processor is further configured to cause the computing device to:
receive a request for obtaining one of the one or more second interface identifiers;
transmit, to the client terminal, one of the one or more unspecific route planning record corresponding to the one of the one or more second interface identifier; and
instruct the client terminal to display the one of the one or more unspecific route planning record corresponding to the interface identifier in the form of the map interface.

89. The computing device of claim 87, the at least one processor is further configured to cause the computing device to:
transmit, to the client terminal, instructions configured to cause the client terminal to:
generate a recommended page, wherein the recommended page includes a map display area and a text display area, the map display area being configured to display the map interface, the text display area being configured to display first data relating to a first number of the one or more second interface identifiers in a form of list; and
display, by a display of the client terminal, the recommended page, wherein the first data relates to the first number of the one or more second interface identifiers includes a vehicle number of a public transportation corresponding to an unspecific route planning records and an estimate duration associated with a public transportation travel route corresponding to an unspecific route planning record.

90-92. (canceled)

93. The computing device of claim 89, wherein the text display area shares an edge with an outline of the recommended page, and to display, by the display of the client terminal, the recommended page, the at least one processor is configured to cause the computing device to:
cause the client terminal, in response to a slide operation of the user performing on the text display area, to expand the text display area to display second data relating to a second number of the one or more second interface identifiers, wherein the slide operation is directed from the text display area to a center of the recommended page.

94. The computing device of claim 89, the at least one processor is further configured to cause the computing device to:
cause the client terminal, in response to a click operation of the user performing on the text display area, to display third data relating to a second identifier corresponding to a location of the click operation on the text display area.

95-117. (canceled)
